(19) United States
(12) Patent Application Publication
(10) Pub. No.: US 2011/0007035 A1
(43) Pub. Date: Jan. 13, 2011

(54) FINGER-WORN DEVICES AND RELATED METHODS OF USE

(76) Inventor: Saar Shai, Kochav Yair (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(21) Appl. No.: 12/673,584

(22) PCT Filed: Aug. 19, 2008
(86) PCT No.: PCT/IL08/01137

§ 371 Date: Feb. 16, 2010

Related U.S. Application Data
(60) Provisional application No. 60/956,708, filed on Aug. 19, 2007.
(60) Provisional application No. 61/016,635, filed on Dec. 26, 2007.
(60) Provisional application No. 61/028,194, filed on Feb. 13, 2008.
(60) Provisional application No. 61/041,931, filed on Apr. 3, 2008.
(60) Provisional application No. 61/042,245, filed on Apr. 3, 2008.
(60) Provisional application No. 61/044,486, filed on Apr. 13, 2008.
(60) Provisional application No. 61/052,176, filed on May 10, 2008.
(60) Provisional application No. 61/054,833, filed on May 21, 2008.
(60) Provisional application No. 61/076,673, filed on Jun. 29, 2008.

(51) Int. Cl. G06F 3/033

(52) U.S. Cl. 345/179

(57) ABSTRACT

Finger-worn user input devices and methods for operating same. In some embodiments, a device includes at least one rotatable section (112, 112′, 912) and an indication mechanism (116, 116a, 130, 516, 526, 616, 816, 826, 836, 1316, 1416, 1616, 2116, 2222, 2320, 2720, 3524) for indicating either a device use or a device state. In some embodiments, a device includes a stationary section (114), at least one rotatable section (112, 912) and an indication mechanism. In some embodiments, one or more rotatable sections are tiltable. In some embodiments, a device further includes one or more mechanisms selected from mechanisms used for sensing (118, 128, 128a, 134, 136, 1216), communication (140), power generation (616, 3342), light generation (526), vibration generation (516), reflection (816, 826, 836), illumination (3616), projection (3420), physical feedback (340) and magnetic influence (736).

### FIELD OF THE INVENTION

The invention relates to in general to finger-worn user-input devices and in particular to finger-worn ring devices used for providing inputs to other devices or systems or used to provide indications to other devices or systems.

### BACKGROUND OF THE INVENTION

Various finger-worn user-input devices are known. For example, U.S. Pat. No. 5,481,265 to Russell discloses some embodiments of an ergonomic customizable user/computer interface device. These embodiments include only ROM and EEPROM replaceable memory cartridges, for the purpose of user authentication and signals encoding. There is no mention of interface indicators of feedback mechanism. Also, the devices described do not reflect modern utilization of a vast selection of sensing mechanism types, and new engineering progress for generating and/or harvesting energy. Therefore, Russell's devices lack appropriate power sources for today's mobile markets. In addition, his devices have very limited modes of interaction.

U.S. Pat. No. 5,489,922 to Zloof discloses a remote computer mouse, embodied by an outer ring rotating on an inner ring. Zloof's device cannot register a user-input without moving parts, and is useful only for control of an external graphic interface.

U.S. Pat. No. 5,832,296 to Wang et al. discloses a self-contained, finger-wearable interface device that communicates with electronic devices. This device may include a variety of sensing mechanisms, such as pressure and force sensing mechanisms, as well as processing circuitry, a wireless transmitter and an optional receiver. The device resembles a ring and is adapted to be worn on a user's finger with sensing mechanisms placed both on the inside and outside surfaces for actuation by a wearer's finger and thumb. The ring body serves as an omni-directional loop antenna for transmitting and receiving signals. To operate the Wang device in a manner designed to emulate a computer mouse, the “clicking” or selection action of a mouse is performed by flexing or bending the finger on which the device is worn to actuate a pressure sensing mechanism. Wang's device has disadvantages when used to control many types of electronic devices and does not facilitate operation where a state of the device may be set.

Therefore, prior art finger worn user input devices have various disadvantages and lack many features that would be useful in input and other actions.

### SUMMARY OF THE INVENTION

The invention provides, in various embodiments, finger-worn user-input devices (or simply “finger-worn devices”). More specifically, the invention provides various embodiments of such devices that are operable by rotation of rotatable ring sections. Some embodiments include just one rotatable section, while others include a plurality of rotatable sections. In such embodiments, a stationary ring-like section is not required because input or indications may be obtained by sensing of the finger on which the devices are worn, or by sensing relative rotation between rotatable sections. In some embodiments having only rotatable sections, rotated positions of any rotatable section are distinguishable from other positions.

In some embodiments, rotatable sections may be tilted in addition to being rotated. The additional tilting feature expends on interaction possibilities and abilities to control interfaces.

The invention further provides various finger-worn devices operable by touch and/or touch motion and/or pressure on a designated surface (as a touch surface). In some of these embodiments, the surface may have specific “touch points” (as indication locations) for specific types of interactions. In some embodiments, the touch surface may display visuals which may correspond to specific types of interactions. In some embodiments, the designated surface may be repositioned for specific types of interactions.

The invention further provides various finger-worn devices which can serve both as touch operable finger-worn devices and as rotation operable finger-worn devices.

The invention further provides finger-worn devices which are alterable in shape, for the object of being attached and/or connected to separate parties. Some of the devices can connect to each other and may be operable collaboratively.

The invention further provides finger-worn devices in which elements may be attached or detached from a main finger-worn device, for certain beneficial features.

The invention further provides various indication mechanisms, integrated in finger-worn devices, for the object of relaying indications about their use and/or information about conditions (as states) of the finger-worn devices. In this description, “mechanism” may refer to any means for performing a function. Some of the indication mechanisms provided herein may passively achieve the function of indication relaying, thus negating the need for an internal power source, or negating the need for active sensing operations. Some of these indication mechanisms are sensing mechanisms utilized in unique ways.

The invention further provides a recognition mechanism and method for detecting rotation and rotated positions of a finger-worn device around a finger.

The invention further provides power generating mechanisms which harness use of a finger-worn device for producing power.

The invention further provides a light generating mechanism and a similar vibrations generating mechanism, both of which harness use of finger-worn devices for the object of relaying indications to a separate party. Also provided for the same object are various reflection mechanisms which modulate reflection of light according to use and/or static conditions of finger-worn devices.

The invention further provides an illumination mechanism which facilitates communication with specific systems, and which facilitates detection of output from a finger-worn device and positions and/or motions of a finger wearing the device.

The invention further provides a projection mechanism which facilitates displaying visuals separately from a finger-worn device, and which facilitates a display larger than the device. A projection mechanism may also facilitate communication by visual output.

The invention further provides an interactive display mechanism which facilitates interactions with visuals displayed by or on a finger-worn device.

The invention further provides mechanisms which may physically influence the operation of a finger-worn device, such as a physical feedback mechanism, a magnetic mechanism, a snap-back mechanism and a locking mechanism.

The invention further provides various methods in which finger-worn devices may be utilized for interactions.

In some provided methods, finger-worn devices are utilized with position detecting systems, for the objects of improving on existing position related interactions and providing new and unique ways to interact with position detecting systems. In other provided methods, a finger-worn device may be utilized to facilitate detection of positions of a finger wearing the device.

In some provided methods, interface elements may be generally assigned and copied to a finger-worn device, for certain beneficial interactions.

### BRIEF DESCRIPTION OF THE DRAWINGS

The invention is herein described, by way of example only, with reference to the accompanying drawings, wherein:

FIG. 1A shows a first embodiment of a finger-worn device of the invention;

FIG. 1B shows the first embodiment as worn on a finger; and as ready to be worn on a curve of another finger;

FIG. 1C shows a second embodiment of a finger-worn device of the invention;

FIG. 1D shows a process in which a curve of a finger is scanned to obtain a map of the curve;

FIG. 1E shows a third embodiment of a finger-worn device of the invention;

FIG. 1F shows a fourth embodiment of a finger-worn device of the invention;

FIG. 1G shows a fifth embodiment of a finger-worn device of the invention;

FIGS. 1H and 1I show a sixth embodiment of a finger-worn device of the invention;

FIGS. 2A and 2B show an seventh embodiment of a finger-worn device of the invention in a generally side view (2A) and in cross section (2B);

FIG. 2C shows a passive indication mechanism which can be implemented in the device of FIGS. 2A and 2B;

FIG. 2D shows a eighth embodiment of a finger-worn device of the invention in cross section;

FIG. 2E shows the eighth embodiment of a finger-worn device worn on an index finger;

FIGS. 3A and 3B show a ninth embodiment of a finger-worn device of the invention, in

FIGS. 3C and 3D show a physical feedback mechanism in the ninth embodiment of a finger-worn device, used for modulating physical feedback;

FIGS. 4A through 4D show a tenth embodiment of a finger-worn device of the invention, in various use states;

FIGS. 5A through 5C show an eleventh embodiment of a finger-worn device of the invention, with details of various components therein;

FIG. 5D shows a light generating mechanism that can be implemented in the twelfth embodiment of a finger-worn device;

FIGS. 6A and 6B show a twelfth embodiment of a finger-worn device of the invention;

FIG. 6C shows details of indication locations in the twelfth embodiment of a finger-worn device of the invention;

FIGS. 7A and 7B show a thirteenth embodiment of a finger-worn device of the invention in perspective (7A) and in cross section (7B);

FIGS. 8A through 8C show a fourteenth embodiment of a finger-worn device of the invention;

FIGS. 8D through 8F show a fifteenth embodiment of a finger-worn device of the invention;

FIG. 8G shows a sixteenth embodiment of a finger-worn device of the invention;

FIGS. 9A and 9B show a seventeenth embodiment of a finger-worn device of the invention;

FIG. 9C shows an eighteenth embodiment of a finger-worn device of the invention;

FIGS. 10A through 10C show a nineteenth embodiment of a finger-worn device of the invention in different use positions;

FIG. 10D shows an interface having multiple elements controllable by finger-worn devices of the invention;

FIGS. 11A and 11B show a twentieth embodiment of a finger-worn device of the invention;

FIGS. 12A and 12B show a twenty first embodiment of a finger-worn device of the invention;

FIGS. 13A through 13E show a twenty second embodiment of a finger-worn device of the invention

FIG. 13F shows a transponder mechanism as an exemplary passive indication mechanism for indicating tilt;

FIGS. 14A and 14B show a twenty third embodiment of a finger-worn device of the invention;

FIG. 14C shows a locking mechanism which may be used in any device of the invention;

FIG. 15A and FIG. 15B show a twenty fourth embodiment of a finger-worn device of the invention;

FIG. 15C and FIG. 15D show a twenty fifth embodiment of a finger-worn device of the invention;

FIG. 15E and FIG. 15F show a twenty sixth embodiment of a finger-worn device of the invention;

FIGS. 16A through 16G show a twenty seventh embodiment of a finger-worn device of the invention;

FIGS. 16C and 16D show sections of the embodiment in FIGS. 16A through 16G; in FIGS. 16F and 16G show a cross-section of the embodiment in FIGS. 16A through 16G;

FIGS. 17A and 17B show a twenty eighth embodiment of a finger-worn device of the invention;

FIGS. 17C and 17D show a twenty ninth embodiment of a finger-worn device of the invention;

FIGS. 18A through 18D show a sequence of operation steps to control an interface of a separate party using one device of the invention;

FIGS. 18E through 18H show a sequence of operation steps to control an interface of a separate party using another device of the invention;

FIG. 19A shows a thirtieth embodiment of a finger-worn device of the invention;

FIG. 19B shows a thirty first embodiment of a finger-worn device of the invention;

FIG. 19C shows an interface controllable by a device of the invention;

FIG. 19D shows another interface controllable by a device of the invention;

FIG. 20A through 20C show an exemplary utilization of a device of the invention;

FIG. 20D shows a system in which a device of the invention may facilitate remote controlling of separate parties by auto-connection;

FIG. 21A shows a thirty second embodiment of a finger-worn device of the invention;

FIGS. 21B and 21C show a thirty third embodiment of a finger-worn device of the invention;

FIG. 21D shows a sensing mechanism for sensing touch at a particular indication location in a device of the invention;

FIG. 21E shows a thirty fourth embodiment of a finger-worn device of the invention;

FIG. 22A shows a thirty fifth embodiment of a finger-worn device of the invention;

FIG. 22B shows an array of sensing mechanisms distributed inside a stationary section of the embodiment of FIG. 22A;

FIG. 22C shows a thirty sixth embodiment of a finger-worn device of the invention;

FIG. 23A shows a thirty seventh embodiment of a finger-worn device of the invention;

FIG. 23B shows a thirty eighth embodiment of a finger-worn device of the invention;

FIG. 23C shows an embodiment of an interactive display mechanism;

FIG. 24A shows a thirty ninth embodiment of a finger-worn device of the invention;

FIGS. 24B and 24C show a fortieth embodiment of a finger-worn device of the invention;

FIGS. 25A and 25B show a forty first embodiment of a finger-worn device of the invention;

FIG. 25C shows a forty second embodiment of a finger-worn device of the invention;

FIG. 26A and FIG. 26B show a forty third embodiment of a finger-worn device of the invention;

FIG. 26C shows a forty fourth embodiment of a finger-worn device of the invention;

FIG. 26D shows a forty fifth embodiment of a finger-worn device of the invention FIGS. 27A, 27B and 27C show a forty sixth embodiment of a finger-worn device of the invention;

FIGS. 28A, 28B and 28C show embodiments of a system in which a finger-worn device of the invention is connected to non-finger-worn devices;

FIGS. 29A and 29B show a forty seventh embodiment of a finger-worn device of the invention;

FIGS. 29C and 29D show a forty eighth embodiment of a finger-worn device of the invention;

FIGS. 30A and 30B show a forty ninth embodiment of a finger-worn device of the invention;

FIGS. 30C and 30D show an exemplary patch having a passive indication mechanism in the embodiment of FIGS. 30A and 30B;

FIGS. 30E and 30F show a fiftieth embodiment of a finger-worn device of the invention;

FIG. 31 shows a fifty first embodiment of a finger-worn device of the invention;

FIGS. 32A and 32B show an embodiment of a system in which multiple finger-worn devices the invention are temporarily connected side-by-side;

FIG. 32C shows an embodiment of a system in which any number of finger-worn devices are connected to an extension section that has a touch surface coupled with an indication mechanism for indicating touch and/or touch motion and/or pressure;

FIG. 32D shows an interface which may be controlled by multiple connected devices of the invention operating collaboratively;

FIGS. 33A and 33B show a fifty second embodiment of a finger-worn device of the invention;

FIG. 33C shows a fifty third embodiment of a finger-worn device of the invention;

FIG. 33D shows the embodiment of FIG. 21A having an exemplary power generating mechanism;

FIG. 33E shows the fifty fourth embodiment having an alternative tactile output mechanism;

FIG. 34A a fifty fifth embodiment of a finger-worn device of the invention;

FIG. 34B shows a simple projection mechanism implemented in a ring;

FIG. 34C shows a fifty fifth embodiment of a finger-worn device of the invention;

FIG. 34D shows the embodiment utilized for projecting an image on a hand;

FIG. 35A shows a fifty sixth embodiment of a finger-worn device of the invention;

FIG. 35B shows a fifty seventh embodiment of a finger-worn device of the invention;

FIG. 35C shows a fifty eighth embodiment of a finger-worn device of the invention;

FIGS. 35D through 35F show the use of a device as in FIGS. 35A through 35C to communicate with a detection apparatus;

FIG. 36A shows a fifty ninth embodiment of a finger-worn device of the invention;

FIG. 36B shows a sixtieth embodiment of a finger-worn device of the invention;

FIG. 36C shows a cross section of a device of FIG. 36A;

FIG. 36D shows an embodiment of a system in which a plurality of devices of FIG. 36A are worn on fingers of a hand;

FIG. 36F shows an embodiment of a system in which a plurality of devices of FIG. 34A are worn on fingers of a hand;

FIGS. 37A, 37B, 37C and 37D show an embodiment of a finger-worn device utilized for visual messaging;

FIGS. 37E and 37F show an embodiments of a finger-worn device is utilized for visual messaging;

FIGS. 38A, 38B and 38C show an embodiment of a system in which a finger-worn device is utilized for visual interaction;

FIG. 38D shows an embodiment of a system in which a finger-worn device is utilized for visual interaction with a head-up display;

FIG. 38E shows an exemplary visual from the system of FIG. 38D;

FIGS. 39A through 39C show an embodiment of a system in which a finger-worn device is utilized for interaction;

FIGS. 40A through 40L show an embodiment of system in which a finger-worn device of the invention utilized for interaction;

FIG. 40M shows a sixty first embodiment of a finger-worn device of the invention;

FIGS. 41A and 41B show an embodiment of a system in which a finger-worn device is utilized for interaction;

FIG. 41C shows a sixty second embodiment of a finger-worn device of the invention;

FIG. 41D shows an exemplary interface element;

FIGS. 41E and 41F show the system of FIGS. 41A and 41B in which a finger-worn device is utilized for interaction;

FIG. 41G shows a use of the system of FIGS. 41A and 41B;

FIG. 41H shows a sixty third embodiment of a finger-worn device of the invention;

FIG. 41I shows a sixty fourth embodiment of a finger-worn device of the invention;

FIG. 41J shows the sixty fifth embodiment of the finger-worn device of the invention;

FIG. 41K shows an embodiment of a system in which multiple finger-worn devices are utilized for interactions;

FIG. 42 shows a method for detecting rotation and rotated positions of finger-worn devices;

FIG. 43 shows a method for detecting rotation and rotated positions of finger-worn devices;

FIG. 44 shows a method for detecting rotation and rotated positions of finger-worn devices;

FIG. 45 shows a method for assigning interface elements to and from a finger-worn device;

The drawings constitute a part of this specification and include exemplary embodiments to the invention, which may be embodied in various forms. It is to be understood that in some instances various aspects of the invention may be shown exaggerated or enlarged to facilitate an understanding of the invention

### DETAILED DESCRIPTION OF THE INVENTION

In this description, “indication mechanism” refers to any means by which use and/or states of a device of the invention may be indicated. “Use” of the device refers to operations in progress (ongoing) performed on the device. A “state” of the device refers to a static condition of the device. A state may be a physical condition and/or a virtual condition, such as ON/OFF modes. A state may be indicated once, when the device is set or goes into a state, or continuously during the period when the device is in a state.

Use and/or states may be directly sensed (such as in case a “sensing mechanism” acts as an indication mechanism). Alternatively, use and/or states may cause specific conditions of the indication mechanism which may be sensed internally (by an element of the device) or externally (by a separate party).

Use and/or states of the device may result in the indication mechanism generating signals or transmissions and/or any other form of information, to another element of the device or to a separate party. Use and/or states of the device may additionally or alternatively result in the indication mechanism influencing other mechanisms and/or components and/or processes of the device or of a separate party. Specifically, use and/or states of the device may result in the indication mechanism influencing signals or transmissions originating from a separate party or from another element of the device. For example, an indication mechanism may influence reflection of light differently for different states of the device.

Examples of “use” include rotating a rotatable section, rotating a rotatable section while the section is tilted, generally touching a touch surface, specifically touching an indication location on a touch surface, touching a touch surface and sliding on the touch surface (commonly referred to as “tap and drag” or “scroll”), pressing (i.e. applying pressure) on a touch surface and the like.

Examples of “states” include rotated positions of a rotatable section, tilted positions of a rotatable section, tilted and rotated positions of a rotatable section, a rotatable section set to rotation tracks, alignments of rotatable sections, connected (and disconnected) sections, connected (and disconnected) devices and the like.

In some embodiments, a device can be in a state when a touch surface is touched and touch is held for the period of the state (i.e. when touch is removed from the surface, the state changes), or when an element is assigned to the device (as an exemplary “virtual” state of the device).

In this description, “sensing mechanism” refers to any means by which use or states of the device may be sensed, detected, viewed, collected, captured, identified, recognized, measured, tracked, acknowledged, admitted, registered, processed, computed, analyzed and/or reacted to. Note that “detection” in this description usually expands on “sensing”, such as by extracting information from the sensing, acknowledging indications in the sensing, registering input corresponding to the sensing, processing sensed signals and the like.

In this description, “connection mechanism” refers to any means by which a device of the invention may be connected to a separate party or to another device. “Connection mechanism” also refers to any means by which a section or element or component of a device of the invention may be connected to the device, or to another section, element, component, or a plurality thereof. “Connection mechanism” also refers to any means by which a device of the invention may change shape by connection of sides, ends, sections, elements or components thereof. “Connection” may also refer to an “attachment” that usually facilitates transferring or exchange of electricity and/or information.

In this description, “indication location” refers to any location on a device of the invention where use and/or a state of the device can be indicated, or from which indication of use and/or a state of the device originate. “Indication locations” may correspond to states of a device of the invention, such as to a rotated position of a rotatable section or a rotated and tilted position of a rotatable and tiltable section, and may be utilized to indicate the states. “Indication locations” may further be utilized for indicating use of a device of the invention. “Indication locations” may include, for example, sensors or switches. “Indication locations”, in other examples, may react or be influenced by other elements or components of a device of the invention, such as a plug or other indication locations, or by any other use and/or states of a device of the invention, such as touch and/or pressure. “Indication locations” are usually included in an indication mechanism or a passive indication mechanism of devices of the invention.

In this description, “rotatable section” refers to any section or element or part or component of a device which can be rotated. For some embodiments, a rotatable section can be rotated and tilted and/or repositioned, such as between rotation tracks.

In this description, “input” refers to any computable information which can be utilized in or that leads to operations, executions, procedures, functions and/or any other kind of processes. For example, the information may be parameters for variables of programmed code. Usually, detections, such as detected indications, are registered as input.

In this description, “registering input” refers to the process by which an input is obtained. An input may be registered by processing received information from any source (such as from sensing mechanisms) and of any type (such as transmissions).

In this description, when describing a section of a finger-worn device, an “internal side” refers to the side of the section that is generally directed towards a finger wearing the device or towards another section that is closer to the finger. Accordingly, “external sides” refer to the side of a section that is generally directed outwards from a finger.

In this description, “directional information” refers to any information about a direction and/or speed. Usually, “directional information” is obtained from indications from a device of the invention, such as when a rotatable section of the device is rotated, or when a finger slides on a touch surface of the device.

In this description, “interface element” refers to any part of an interface. Some examples of interface elements include software, applications, programs, commands, files, folders, tools, messages, functions, processes, visuals (e.g. visual objects, graphics, icons, etc.), occurrences (e.g. incoming call or change in mode), conditions (e.g. an interface mode), protocols (e.g. a cursor modulation protocol or finger interactions protocol), network connections (e.g. control of a device in a system of network may be assigned to the device), profiles (e.g. a user profile), attributes (e.g. audio volume) and the like.

In this description, “displayed object” (or simply “object” when referring to a display) refers to any specific instance of a visual output or plurality thereof. Usually, a “displayed object” corresponds to an interface element, such as visually representing an element of an interface.

In this description, “incoming signals” refer to any signals or transmissions received from an external source, such as a separate party.

In this description, a “virtual environment” refers to any interface. Specifically, “virtual environment” may refer to any computer generated environments, such as any operating systems or graphic user interfaces (GUIs).

In this description, “function” refers to any operation, execution, process, procedure, action or command for achieving a result, or plurality thereof. Usually, a title of a “function” refers to its result. For example, a “deletion function” is for deleting.

It is hereby noted that any mentioning or use of the term “visual” may refer, in addition to the common definition, to optical elements or properties in general that may not be visible. Specifically, “visual” may refer to any non-visible wavelengths (e.g. infrared). Accordingly, “visual” is not limited the spectrum of visible light. Further accordingly, any mentioning or use of the term “light” and related terms (e.g. “illumination”) are not limited to visible light.

It is also hereby noted that any mentioning or use of the term or phrase “optionally” refers to the common definition of the term, as defined in dictionaries. Accordingly, any mention or use of “optionally” does not limit or restrict the related cases or propositions or phrasings so that at least one is possible or allowed or may occur, otherwise cases or propositions or phrasings herein related to the phrase optionally are not mutually exclusive and are not limited to any or either.

It is also hereby noted that any mentioned or use of the phrase “and/or” refers to the common definition of the term. Accordingly any mention or use of “and/or” allows one or more of the related cases or propositions or phrasings are possible or may occur, otherwise at least one but possibly more of the related cases or propositions or phrasings are possible or allowed or may occur, NOT mutually exclusive.

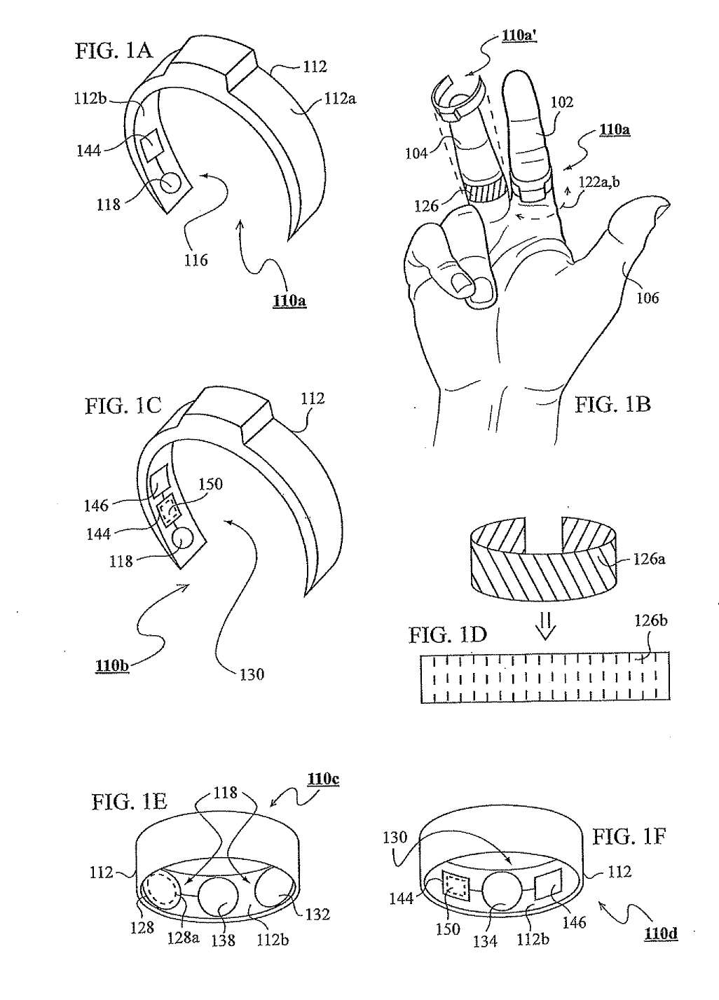

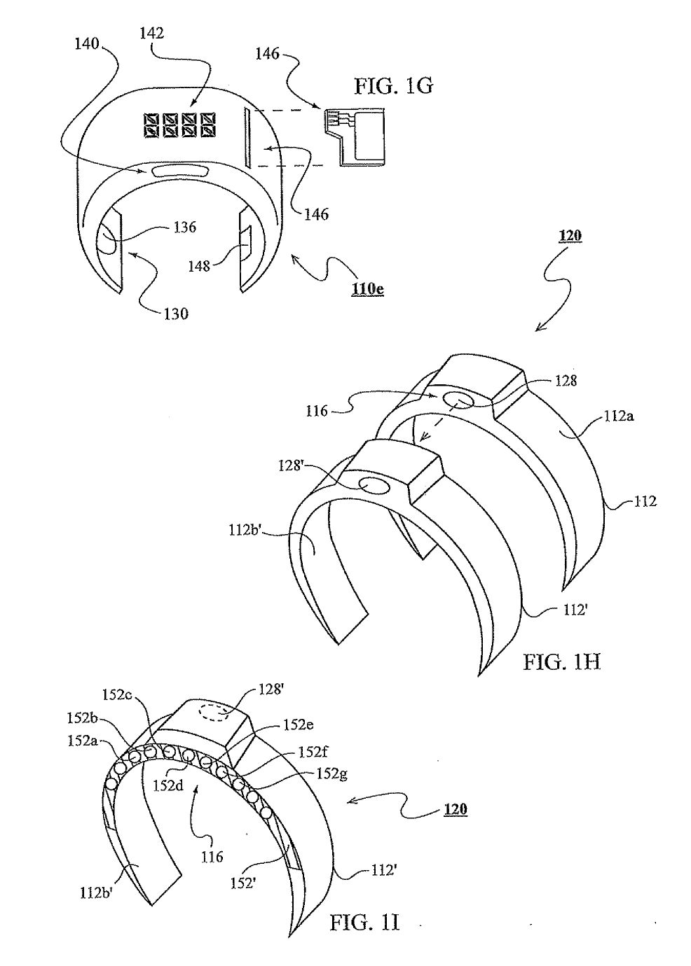

FIG. 1A shows a first embodiment of a finger-worn device of the invention as a device 110a. Device 110a includes a rotatable section 112 which can be worn on and rotated around a finger. Device 110a further includes an indication mechanism 116 for indicating rotation (or “relative motion”) of section 112 around the finger. Section 112 is shown in FIG. 1A as a partial ring, however, it should be clear that this particular embodiment is by no means limiting, and that in some embodiments, section 112 is a full ring. In FIG. 1A, indication mechanism 116 includes a sensing mechanism 118. Sensing mechanism 118 may utilize any number of sensors generally directed to or facing the finger, such as being generally located at an internal side 112b of section 112. As section 112 rotates, mechanism 118 senses a different part on the curve of the finger (e.g. a sensor of mechanism 118 is facing a different part of the finger, specifically on the curve of the finger around which section 112 rotates). Accordingly, relative motion may be indicated by sensing the finger. More specifically, sensing mechanism 118 may sense the surface (also “skin”) of the finger, or layers near the surface of the finger. The sensing may be of the epidermal layer of the skin. In other embodiments, the sensing is may be of the dermal and/or sub-dermal layers. Because skins of fingers exhibit physiological patterns and features (e.g. fingerprints, or skin crevices similar to fingerprints in other parts of fingers) along the curve of the finger, indicating rotation of section 112 relative to the finger may be facilitated by any number of mechanisms known in the art for sensing patterns and features, specifically physiological, such as fingerprints sensing mechanisms. Alternatively, indicating rotation may be facilitated by sensing other detectable changes, such as the reflection of light from sub-dermal layers of the finger or from the bone of the finger. In some embodiments, sensing mechanism 118 may be coupled with a processing unit 144 included in a finger worn device of the invention (as in device 110a). The processing unit may process signals from a sensor, or plurality thereof, utilized by the sensing mechanism. In other embodiments, the processing unit may be included in a separate device or system communicating with a finger worn device of the invention.

FIG. 1B shows device 110a exemplarily worn on an index finger 102. Rotation directions 122a,b are shown as directions in which device 110a can be rotated, such as by a thumb 106. FIG. 1B further shows a second embodiment of a finger-worn device of the invention as a device 110a′ ready to be worn on a middle finger 104, specifically on a curve 126 of finger 104. Curve 126 is generally the curved surface of the finger at the circumference of the finger. When device 110a′ is worn on curve 126, the curve overlaps inner side 112b of section 112, from which sensing of the finger is performed. Accordingly, sensing is specifically of curve 126. The curve, as referred to herein, may include the entire circumference of the finger (full circle around the finger) or only a certain part of the circumference, such as only the curve of the front of the finger (shown in FIG. 1B). As section 112 rotates, a different part along curve 126 is sensed at any given time (such as by a sensor of mechanism 118 facing a different part for different rotated positions), and so relative motion can be indicated from sensing changes along the curve. Sensing may distinguish between each direction of rotation (i.e. direction 122a and direction 122b) so that rotation is each direction is indicated differently, for obtaining directional information about the rotation. In some embodiments, the speed of rotation may be indicated, or information of which may be obtained, by processing the rate in which mechanism 118 senses changes along curve 126, as sensed changes correspond to rotation.

FIG. 1C shows a second embodiment of a finger-worn device of the invention as a device 110b, similar to device 110a. In device 110b, an indication mechanism is implemented as a recognition mechanism 130. Mechanism 130 may indicate rotated positions of device 110b around a finger (i.e. states of the device), in addition to relative motion (i.e. rotation, or use of the device). In addition to the described for device 110a, device 110b further includes a memory unit 146. In some embodiments, the memory unit may be included in a separate device or system communicating with a finger worn device of the invention. In mechanism 130, memory unit 146, processor 144 and sensing mechanism 118 are connected. In some embodiments, processor 144 has a recognition function 150 (i.e. program or software) for recognizing patterns and/or features, and/or for comparing patterns and/or features. For example, function 150 may be a fingerprint recognition algorithm programmed into processor 144. The recognition function may process sensing performed by mechanism 118. The sensing or results from the recognition function may be stored on and retrieved from memory unit 146. When device 110b is worn on a finger, specifically around a curve 126, the curve may be “mapped” by recognition mechanism 130. This may be facilitated by scanning the entire curve by mechanism 118, wherein by rotating section 112 around the finger mechanism 118 may sense all the parts of the curve. The scanning may be stored in memory unit 146. When section 112 is later at a certain rotated position, mechanism 118 senses a certain part along curve 126, which corresponds to the position. The part may be recognized by comparing it to the prior scanning which is stored in unit 146. By recognizing the part, its location along the curve may be known, which can indicate the corresponding rotated position of section 112. Accordingly, indication of relative motion of section 112 around the finger may be facilitated by sensing a sequence of parts of the curve, which indicates relative motion and may be utilized for obtaining directional information.

Recognition mechanism 130 may utilize any number of mechanisms known in the art for sensing fingerprints and/or for fingerprint recognition, see e.g. U.S. patent application Ser. Nos. 10/920,255 and 11/424,477 and U.S. Pat. Nos. 5,195,145, 6,088,585, 7,381,941 and 6,259,108.

FIG. 1D shows a representation of converting a scanning of the curve to a reference map of locations of parts on the curve. In FIG. 1D, scanning of an actual curve 126a is for registering a map 126b (shown in the figures divided by dashed lines exemplarily separating locations which correspond to different parts along the actual curve). Registering map 126b from the scanning of curve 126a may be performed by a processor 144 (FIGS. 1A and 1C). The processor may utilize a function 150 to convert signals from a mechanism 118 to map 126b. The map is a record of all the parts of the curve and their location along the curve. The record may be encoded information which is “readily comparable” to any further sensing of parts of the curve, which may undergo a similar step before being compared to the map. The map may be updated or replaced with another map when device 110b is relocated to be worn on a different curve, on the same finger or another finger.

In some embodiments, when a partial curve is scanned and sensed, such as the part of the circumference of the front of the palm (shown in FIG. 1B), sensors of sensing mechanism 118, or sensors of any sensing mechanisms utilized for indicating rotation and rotated positions (e.g. recognition mechanism 130), may be distributed (or located) opposite to each other on internal side 112b, or in any distribution in which at least one sensor is facing the curve for each rotated position of a device of the invention, so that the curve can be sensed when that device is at any position. This facilitates indicating rotation and rotated positions on fingers where the back of the fingers cannot be effectively sensed. For example, a user having hairs on the back of a finger on which the device is worn, in which case a recognition mechanism 130 which is designed to sense crevices in the surface of the skin of the finger may operate deficiently if attempting to sense the back of the hand. Accordingly, having multiple sensors in different locations on the internal side of section 112 may facilitate sensing the front of the finger when section 112 is in any rotated position.

FIG. 1E shows a third embodiment of a finger-worn device of the invention as a device 110c, similar to the previously described devices, in which a rotatable section 112 shown to have a shape of a full ring. A sensing mechanism 118 includes an optical sensing mechanism 128 (e.g. a photodiode). During rotation of section 112, indications of rotation may be obtained by sensed optical changes as sensed by mechanism 128 sensing the finger (see e.g. U.S. Pat. No. 6,259,108). Mechanism 118 may utilize a light source 132 (e.g. a light-emitting diode (LED)) to facilitate optical sensing of mechanism 128. In some embodiments, sensing mechanism 128 may utilize a passive infrared (PIR) sensor 128a for sensing the natural physiological radiation of infrared (IR) light from the finger, in which case light source 132 is not needed. In some embodiments, by utilizing a PIR sensor, mechanism 128 and accordingly mechanism 118, act as a passive indication mechanism (e.g. a passive indication mechanism 116a) where a power source is not needed. For example, a thermoelectric power generator 138 may be utilized by mechanism 118 so that infrared light sensed by sensor 128a can be converted into power, in addition to indicating relative motion. Similarly, any thermoelectric power generator 138 may be included in any device of the invention as an exemplary power source. Note that a processor and optionally a memory unit may be included in device 110c for forming a recognition mechanism 130 together with sensing mechanism 118.

FIG. 1F shows a forth embodiment of a finger-worn device of the invention as a device 110d similar to the previously described devices, in which a capacitance sensing mechanism 134 is acting as a sensing mechanism for sensing capacitance changes across a curve of a finger during rotation of section 112. As known in the art (see e.g. U.S. Pat. No. 4,353,056), crevices on a conductive surface may be detected by sensing capacitance formed between a sensor (e.g. electrodes) and the surface. Such mechanisms are known to be implemented for sensing fingerprints and accordingly may sense patterns and/or features of other surfaces of a finger. As described above, changes in capacitance as detected by mechanism 134 indicate relative motion. In FIG. 1F, device 110d is shown to further include a processing unit 144 having a recognition function 150 and a memory unit 146, acting with mechanism 134 as an exemplary recognition mechanism 130. Similarly to the described above, a capacitance “fingerprint” (i.e. map) of a curve of a finger where the device is worn may be registered from a scanning operation, and stored to be later compared with sensed capacitance of parts of the curve, for obtaining specific indications of rotated positions of section 112.

FIG. 1G shows a fifth embodiment of a finger-worn device of the invention as a device 110e, similar to the previously described devices. In device 110e, a section 112 is shown in yet another shape, specifically of a partial ring. A recognition mechanism 130, similarly to the described above, is shown to utilize an acoustic sensing mechanism 136 as known in the art to detect patterns of skin crevices (i.e. ridges and valleys of fingerprints) in a surface of a finger, by detecting acoustic feedback (see e.g. U.S. Pat. Nos. 4,977,601, 5,456,256, 7,150,716), for achieving detection of relative motion (i.e. rotation) and of rotated positions. Further shown included in device 110e is a general communication mechanism 140 (e.g. a transceiver), a general visual output mechanism 142 (e.g. a liquid crystal display), a power source 148 (e.g. a battery), and an exemplary memory unit 146 being a slot and a memory cart (e.g. Flash memory card).

In some embodiments, memory unit 146 may store information for operations of device 110e where only an output apparatus is needed to communicate with, such as in case device 110e also includes a processor (e.g. a processor 144). For example, memory unit 146 may store media files which can be extracted from the card and played by a processor having a media playing function. Alternatively, the media playing function may also be stored on memory unit 146, such as an application installed on the card in addition to an archive of media files. By communicating with a media output apparatus (e.g. sound speakers for audio output or a monitor for video output), device 110e can be operated for playing media. For another example, the device may be operated to select stored information from memory unit 146 and display it by visual output mechanism 142. Note that similarly, a device of the invention may act as a mobile computer device which can be operated autonomously (without communicating with a separate party or an external interface), or operated with only an output apparatus.

FIGS. 1H and 1I show a sixth embodiment of a finger-worn device of the invention as a device 120 which includes a first rotatable section 112, a second rotatable section 112′ and an indication mechanism 116 for indicating relative rotation and/or specific relative positions of each rotatable section. In this embodiment, mechanism 116 includes an optical sensing mechanism 128 on section 112 and a pattern 152′ on section 112′ which can be sensed by sensing mechanism 128 (e.g. by generally facing the mechanism, as shown in FIG. 1H). The pattern is specifically shown in FIG. 1I which is a view of an opposite side of section 112′ than shown in FIG. 1H. Pattern 152′ is shown having a plurality of different features 152a-g to visually indicate rotated positions of section 112′, or alternatively of relative rotated positions of section 112, to sensing mechanism 128. Pattern 152′ may be, for example, a coded black-and-white pattern (e.g. barcode or optical tag) having distinct features evenly distributed across the curve of section 112′. Sensing mechanism 128 can detect each feature for obtaining information about the corresponding relative position of the sections. Accordingly, when either section is rotated, a different feature (on pattern 152′) directly faces the sensing mechanism at any given time. During rotation, directional information may be obtained from detecting a sequence of features. As either section rotates, different features are sequentially facing the sensing mechanism, so that by analyzing the sequence of features, information about the direction of rotation may be obtained.

In some embodiments, section 112′ includes a sensing mechanism 128′ so that another rotatable section having a visual pattern may be included in device 120, wherein its pattern is facing mechanism 128′. Accordingly, any number of rotatable sections may be included in the device as part of a series of rotatable sections sensing each other's patterns, as described above.

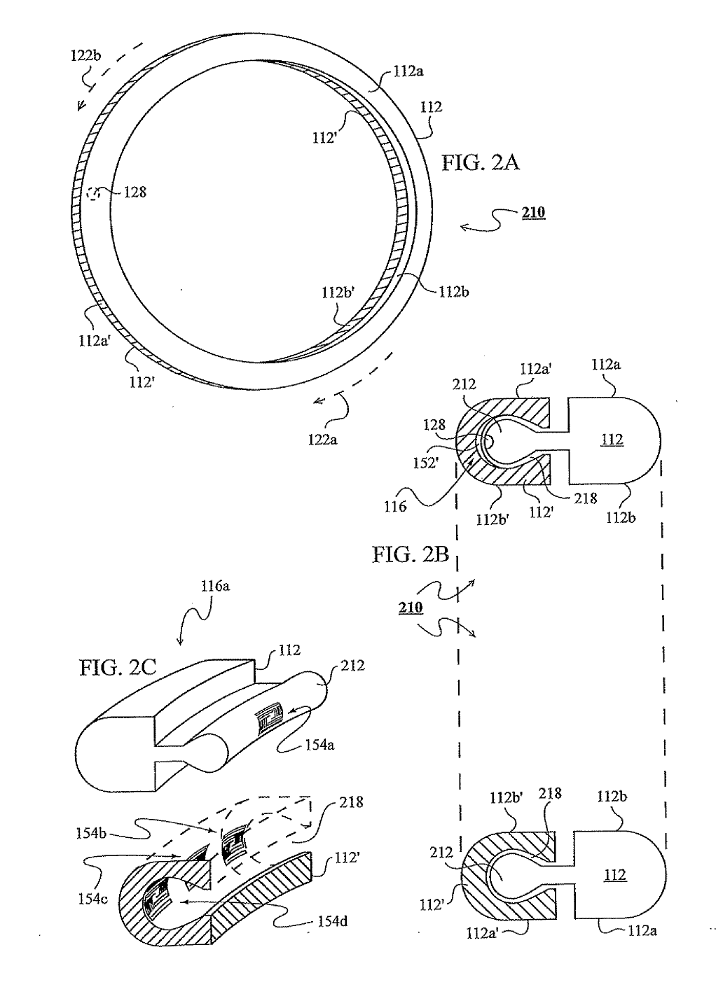

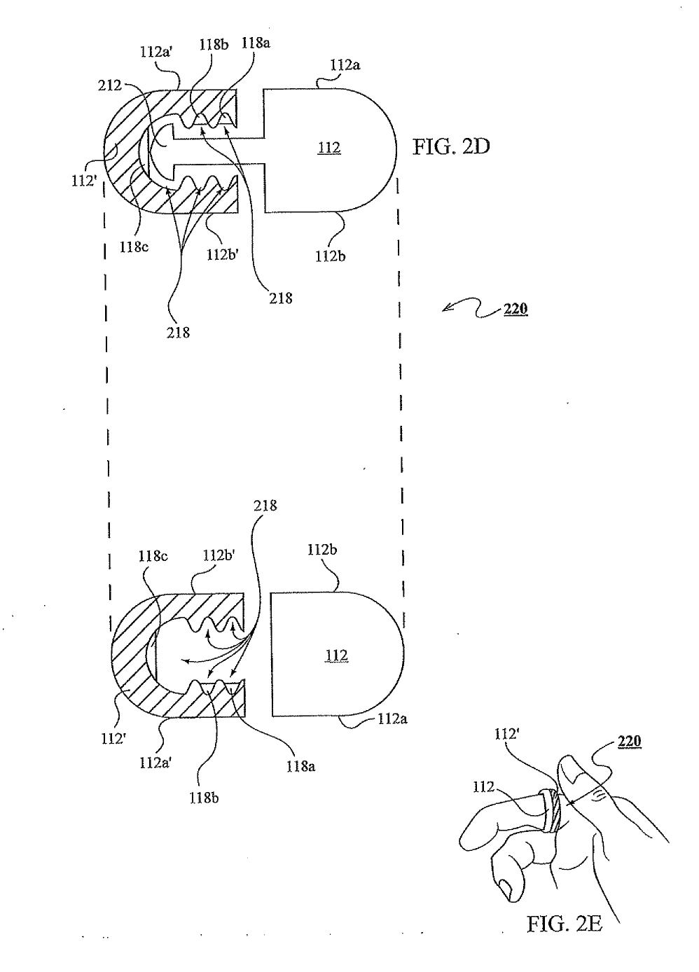

FIGS. 2A and 2B show a seventh embodiment of a finger-worn device of the invention as a device 210. Device 210 includes a first rotatable section 112 and a second rotatable section 112′, both of which can be rotated relative to each other and relative to a finger wearing the device Sections 112 and 112′ are shown to be full rings, installed side-by-side and generally of a similar size. It is noted that in this specification, any rotatable section may be either a full ring or a partial ring. The sections may be physically connected by a plug 212 of section 112 installed inside a track 218 of section 112′. A track of the invention may be straight (i.e. a closed circle) or helical. Device 210 further includes an indication mechanism 116 which facilitates indicating rotation and/or rotated positions of each section relative to the other. As specifically shown in FIG. 2B, indication mechanism 116 includes an optical sensing mechanism 128 on plug 212, and a visually detectable pattern 152′, similarly to the described for device 120 (shown in FIG. 1I on section 112′) on track 218 facing the mechanism 128. Because rotation is relative, rotating one of sections 112 and 112′ in one direction (e.g. a clockwise direction 122a) is sensed and indicated the same as rotating the other in an opposite direction (e.g. a counter-clockwise direction 122b).

FIG. 2C shows a passive indication mechanism 116a which can be implemented in a device 210. Passively indication may be facilitated by any number of mechanisms known in the art powered by an external source (see e.g. U.S. Pat. No. 6,720,866). In FIG. 2C, sections 112 and 112′ are shown separated from each other, to illustrate an indication location 154a on plug 212 of section 112 and indication locations 154b-d on track 218 of section 112′. When the sections are connected, location 154a comes in contact with any of locations 154b-d, correspondingly to a relative rotated position of the sections. Accordingly, at other relative rotated positions, location 154a comes in contact with other locations on the track. By contact of location 154a with each of locations 154b-d, a relative rotated position of the sections, which corresponds to that contact, is indicated passively, such as by the contact of the locations forming a condition that can be detected remotely. For example, location 154a may have a radio frequency identification (RFID) antenna, while each of the locations on the track (154b-d) may have a different RFID transponder for modulating incoming radio frequency signals differently. By connection (through contact) of the antenna with each of the transponder, only that transponder can modulate incoming signals captured and backscattered by the antenna. Thus, for any relative rotated position of the sections, a specific transponder is connected to the antenna so that the position may be indicated differently from other position.

FIG. 2D shows an eighth embodiment of a finger-worn device of the invention as a device 220 similar to device 210, wherein rotatable sections 112 and 112′ can be rotated relative to each other while plug 212 occupies one of a plurality of rotation tracks 218 at any given time. While being rotated, an indication mechanism can indicate to which track the rotatable sections are set at any given time (defined as “states” of the device or “device states”), in addition to indicating relative rotation (defined as a “use” of the device or “device use”). In FIG. 2D, the indication mechanism includes sensing mechanisms 118a-c which facilitate indication of device states and use. Exemplarily, sensing mechanisms 118a-c may be switches distributed to each track and activated by contact with plug 212. Indications are obtained by contact of plug 212 with each switch, similarly to the described for indication locations of a passive indication mechanism 116a in FIG. 2C. For example, the switches may be distributed among the tracks, so that contact of the plug with each switch is indicative of the track which the plug occupies. FIG. 2E shows device 220 worn on an index finger.

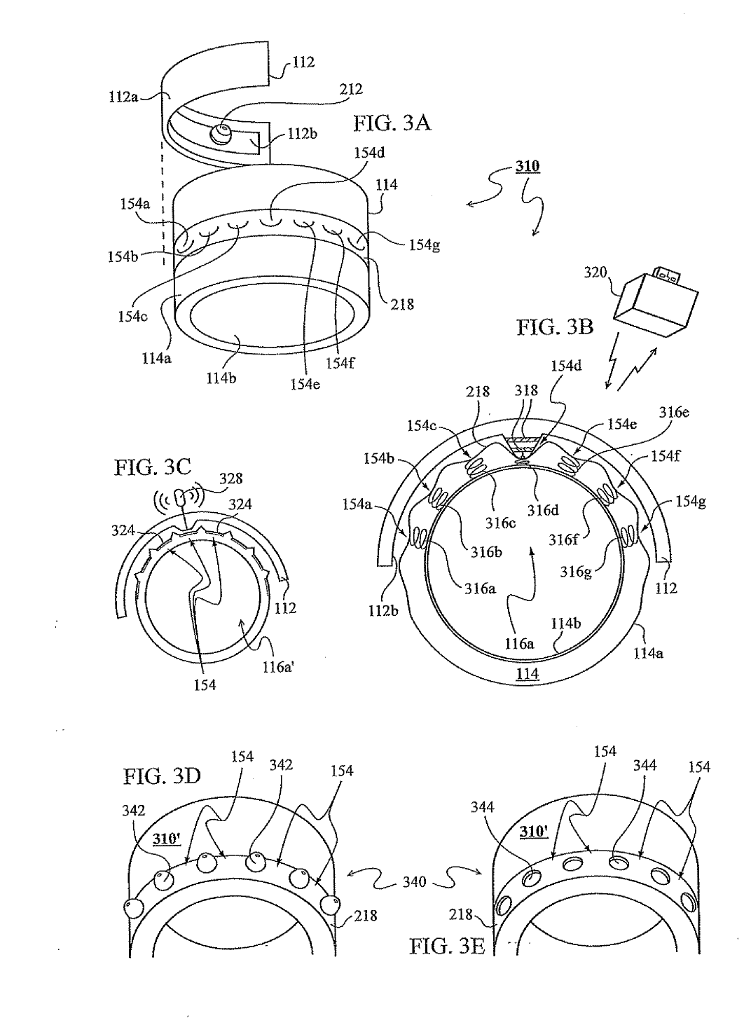

FIGS. 3A and 3B show a ninth embodiment of a finger-worn device of the invention as a device 310 which generally includes a rotatable section 112, a stationary section 114 and a passive indication mechanism 116a for passively indicating the rotation and specific rotated positions of section 112, exemplarily to a separate party 320. Passive indication may be facilitated by any number of mechanisms known in the art (see e.g. U.S. Pat. No. 7,212,123). Section 112 is shown ready to be installed to rotate on a rotation track 218 which includes evenly spread indication locations 154a-g, wherein each location corresponds to a specific rotated position of section 112. Track 218 is formed on an external side 114a of section 114. Section 112 has a plug 212 on an internal surface 112b. The plug may interact with (or “influence”) each location (see e.g. FIG. 3B, in which plug 212 influences indication location 154d). Therefore, in this embodiment, the indication mechanism includes plug 212 and locations 154a-g. Exemplarily as shown in FIGS. 3A and 3B, plug 212 may include a capacitor 318 while each location 154a-g may include a corresponding coil 316a-g. When plug 212 influences an indication location, the capacitor comes in contact with the coil at that location to form a coil-and-capacitor circuit. Each coil may be different so that each circuit may have a different resonant frequency. Separate party 320 (exemplarily shown as a transceiver device) can send signals that stimulate resonance in each coil-and-capacitor circuit fowled at device 310, and can detects the response resonant energy which is indicative of specific rotated positions of section 112. Accordingly, rotation of section 112 may be indicated by sequential changes in rotated positions of section 112.

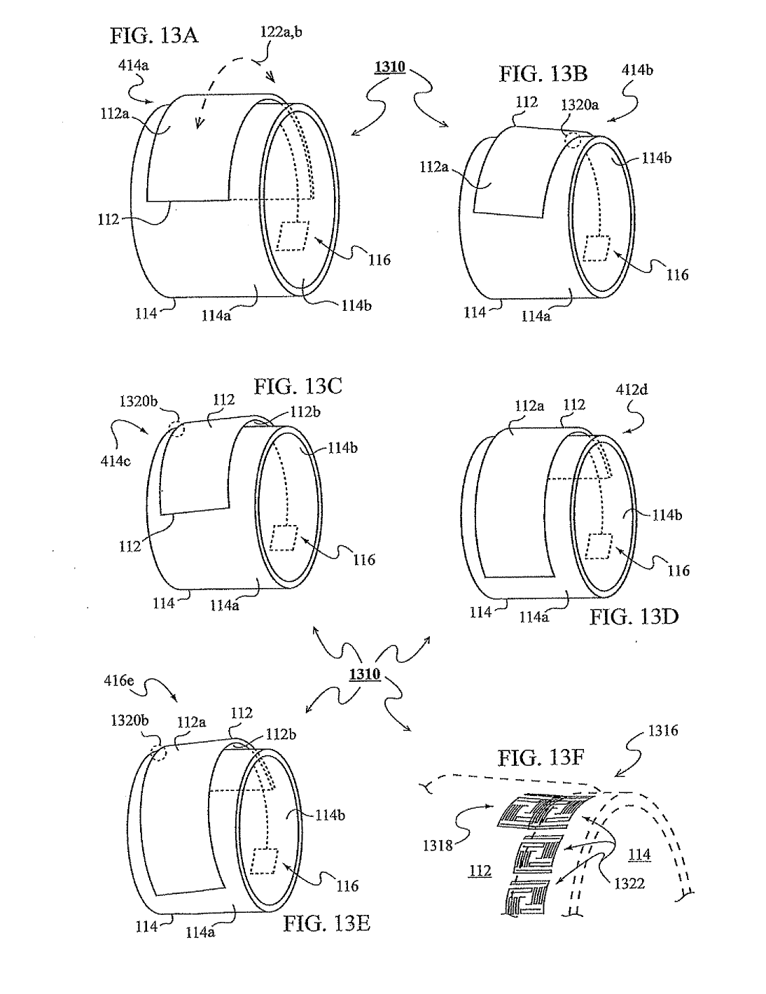

FIG. 3C shows another passive indication mechanism 116a (as passive indication mechanism 116a′), in which each indication location includes a corresponding passive transponder 324 while a plug 212 includes an antenna 326 (see e.g. U.S. Pat. No. 4,890,111). Similarly to the described for passive indication mechanism 116a in FIG. 2C, and as will be described for a transponder mechanism 1316 in FIG. 13F, by connection of the antenna with each transponder, when the plug is in an indication location corresponding to the transponder, a rotated position of a section 112 may be indicated.

In some embodiments, each indication location (e.g. indication locations 154a-g in device 310) can physically accommodate plug 212, such as to loosely hold it so that section 112 would not rotate unless enough force is applied (preferably by a user purposefully rotating the section). In embodiments where a rotatable section may be held in specific positions, these positions are referred to as “stations”.

FIGS. 3D and 3E show a physical feedback mechanism 340 for modulating physical feedback when operating any device of the invention, such as the described above for “station”. In FIG. 3C, mechanism 340 is shown in an embodiment of a device 310′, however mechanism 340 may influence any tilting operation or any other repositioning operation described herein.

For device 310′, pins 342 are specifically shown in FIG. 3D to be protruding between indication locations 154, on track 218 on which rotatable section 112 rotate. The pins are designed to slightly obstruct plug 212 during the rotation of section 112, to facilitate a physical feedback of slight obstructions during rotation. Additionally, when section 112 is not rotated (i.e. no force is applied to rotate the section) the plug is held between two pins, correspondingly to an indication location, for indicating a specific rotated position of section 112. Section 112 can be rotated further by applying enough force to “release” the plug from between the pins. The pins may be controlled to protrude or retract, such as by having actuators.

Specifically shown in FIG. 3E, pins 342 are retracted into holsters 344, for facilitating a smooth rotation of section 112 (i.e. no physical feedback of obstruction is felt while rotating the section). Accordingly, rotating section 112 (i.e. use of the device) is indicated by sequential indication from each indication location 154 that plug 212 passes through.

In some embodiments, the extent of protrusion of the pins may be modulated so that they can completely block plug 212, and accordingly prevent section 112 from further rotating. In some cases, it might be desired to temporarily deny rotation, or “lock” section 112 in a rotated position. Later, the pins may be retracted to allow section 112 to rotate further, either smoothly or with physical feedback (i.e. when the pins are partially protruding).

In some embodiments, each pin 342 may be controlled individually. For example, it might be desired in some cases to block section 112 from reaching a specific rotated position. Accordingly, a pair of pins on either side of an indication location may be protruding from their respective holsters 344, to block plug 212 from reaching that location, while the plug may reach any other location by rotating section 112 as the rest of the pins are retracted into their respective holsters.

In some embodiments, locking a rotatable section in rotated positions, and blocking access to rotated positions, may be controlled by operations of a device of the invention which includes a physical feedback mechanism 340. For example, the device may be communicating with a separate party for controlling an interface element of that party by rotation of section 112. In some cases, the interface element may not be available for being controlled. Accordingly, the separate party may send signals to the device, to trigger an operation of locking section 112 in its position (i.e. preventing it from further rotation). When the element later becomes available, locking may be deactivated.

In some embodiments, locking a rotatable section may be controlled manually by a user. For example, a device of the invention may be designed so that a user can press on a rotatable section to lock it in a position, while the user can further press on the rotatable section to release it from the locked position. Note that physical accommodation and locking as described herein may be achieved other mechanisms than the pins described above.

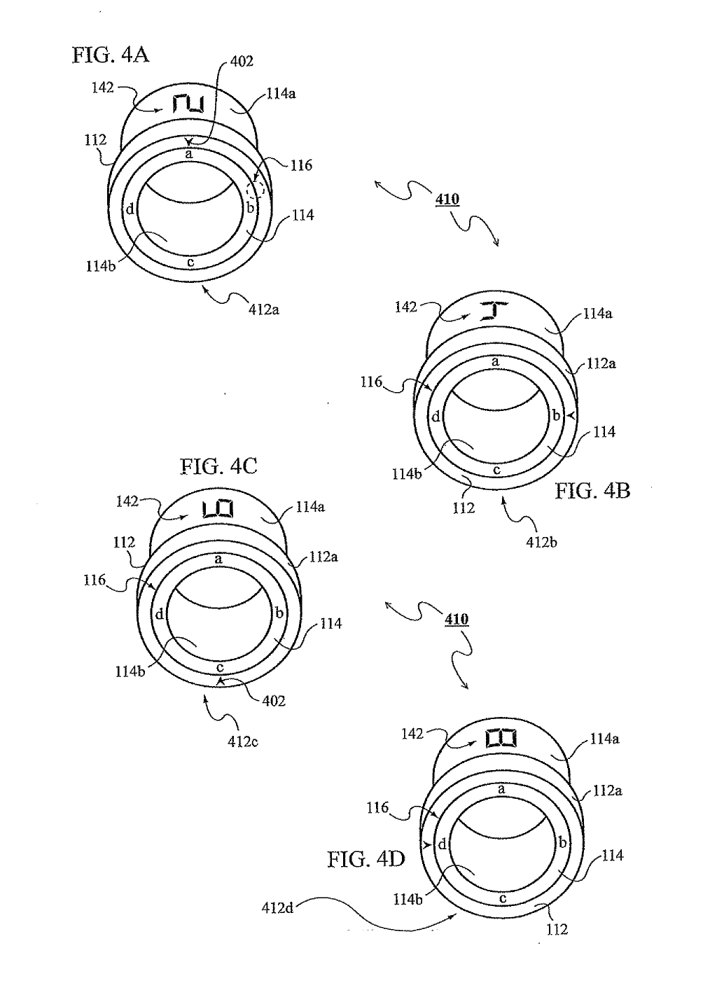

FIGS. 4A through 4D show a tenth embodiment of a finger-worn device of the invention as a device 410 which generally includes a rotatable section 112, a stationary section 114 and an indication mechanism 116 for indicating specific rotated positions 412a-d of section 112 relative to section 114. Mechanism 116 is exemplarily located between the sections. Positions 412a-d are represented by the pointing direction of an arrow-head mark 402. Each position corresponds to an indication location, to exemplify an operation corresponding to each particular rotated position. In some embodiments, device 410 may further include a visual output mechanism 142 exemplarily located on external side 114a of section 114. Indication of each position 412a-d may prompt a corresponding display by mechanism 142, as part of an interface where specific rotated positions prompt specific operations. In FIGS. 4A through 4D, mechanism 142 is shown to display a different digit for each of the positions (digit 2 for position 412a, digit 4 for position 412b, digit 6 for position 412c and digit 8 for position 412d).

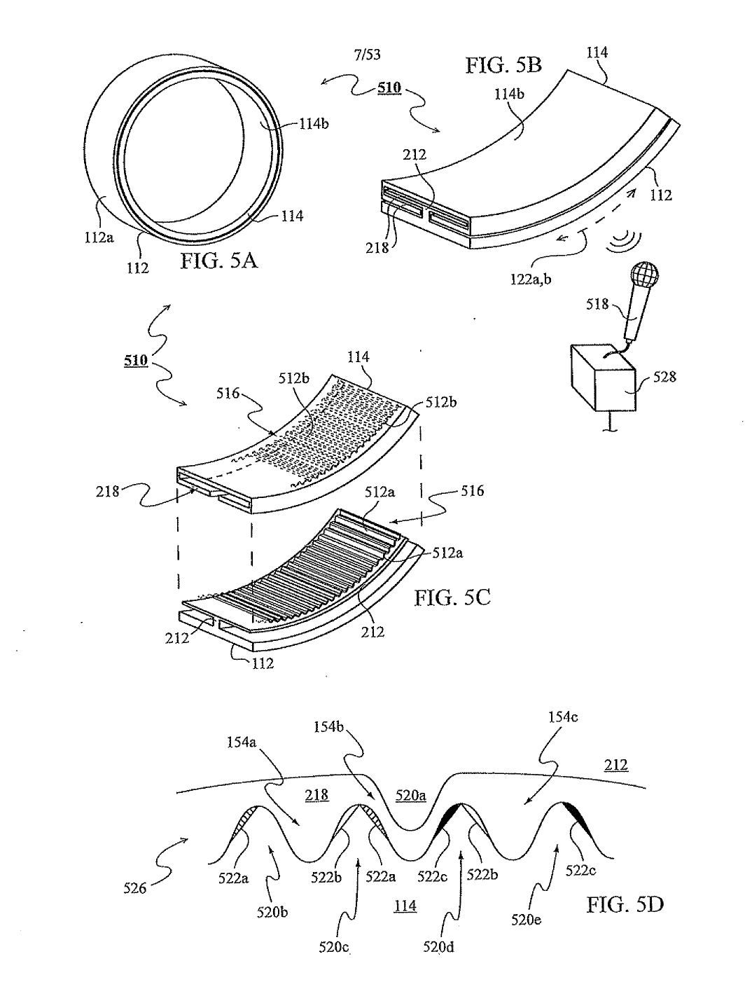

FIGS. 5A to 5C show a eleventh embodiment of a finger-worn device of the invention as a device 510 which generally includes a rotatable section 112, a stationary section 114 and a vibrations generating mechanism 516 implemented as an exemplary indication mechanism. Vibrations may be obtained by friction and/or pressure between the sections during use of device 510 utilizing means known in the art (see e.g. U.S. Pat. No. 3,097,537). In this embodiment, indication is facilitated by utilizing sound as an exemplary vibration reaction generated by the rotation. In FIGS. 5B and 5C, a T shaped plug 212 is shown to extend from section 112 and occupy a track 218 exemplarily formed by the shape of section 114. Plug 212 and a track 218 are shown to respectively have physical patterns 512a and 512b of cogs, wherein the cogs pattern of the plug fits (accommodates) the cogs pattern of the track. The fitting (or “accommodation”) of the cog patterns in various positions represents “stations” as explained above re. FIG. 3.

In use, when section 112 is rotated, the cogs of the pattern of the plug press against the cogs of the pattern of the track to generate sound. For example, each cog may include a thin metal flap which bends as the cogs press against each other, and vibrates when the pressure is released, and/or bumps against the flaps of adjacent cogs. Optionally, each direction 122a and 122b of rotation of section 112 may generate a different sound, to differentiate between the directions. This may be facilitated by having each side of each cog of at least one of the patterns react differently to pressure, and consequently generate a different sound than its opposite side. In some embodiments, the sound that is generated during rotation of section 112 can be detected by an acoustic sensor 518 (shown as a microphone in FIG. 5B), such as a piezoelectric transducer (as known for “pickups” of musical instruments). The sensor may be part of a vibrations recognition mechanism 528, which may have a recognition function which is adapted to recognize sounds from device 510, such as to register the sound as corresponding input.

FIG. 5D shows a light generating mechanism 526 that can be implemented in a device 510, alternatively to vibrations generating mechanism 516. In FIG. 5D, a section 112 has a cog 520a while a section 114 has cogs 520b-e forming exemplary indication locations 154a-c as slots between two cogs. Cog 520a interchangeably fits into each slot during rotation of section 112. The external sides of each slot are formed by a pair of opposite sides of two cogs, wherein cog 520a must press against one of these sides to fit into that slot, depending on the direction of rotation of section 112. In some embodiments, each such pair of opposite sides may include a differently reactive material or composition or mechanism which generates a different light emission reaction when reacting to pressure or the release thereof. Shown in FIG. 5D are the opposite sides of cogs 520b and 520c (forming location 154a) including a triboluminescent component 522a, opposite sides of cogs 520c and 520d (forming location 154b) including a triboluminescent component 522b and opposite sides of cogs 520d and 520e (forming location 154c) including triboluminescent component 522c.

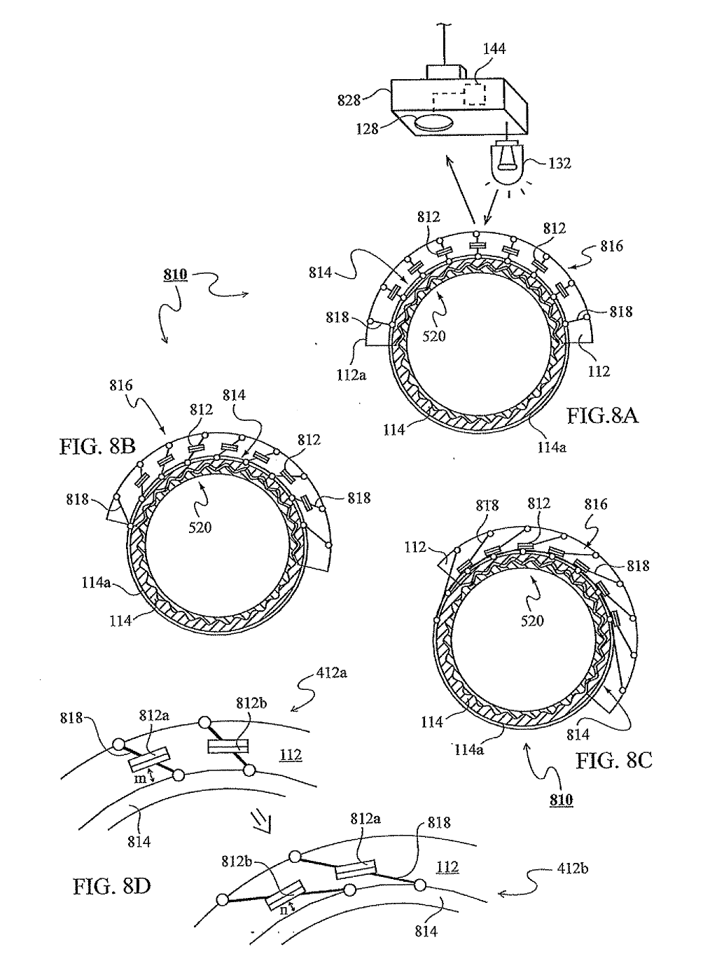

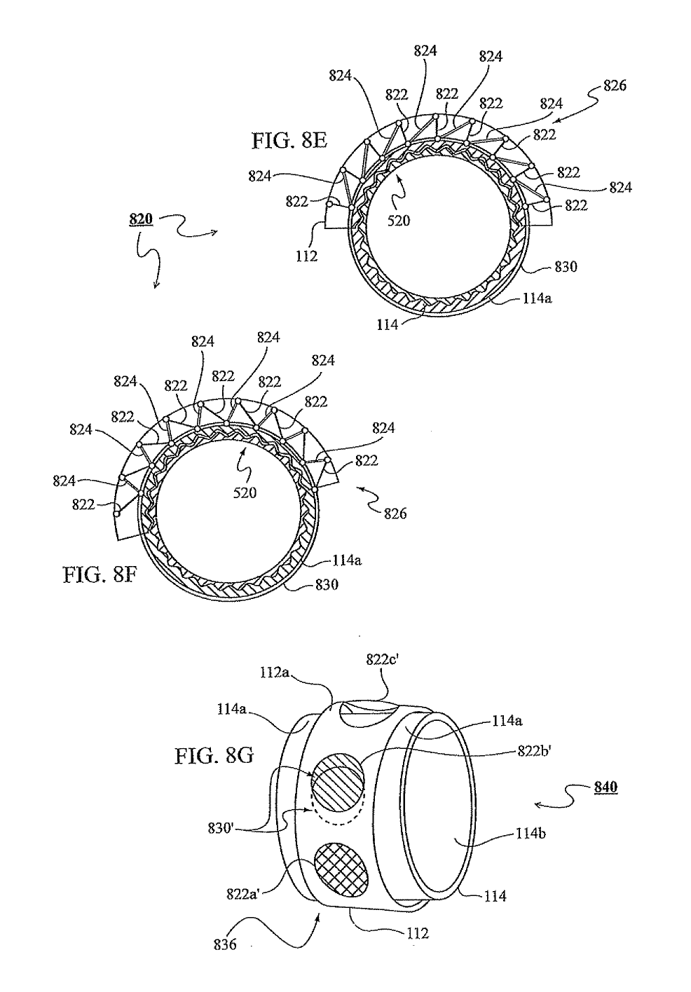

Each component may include a different triboluminescent material or a different composition of the same triboluminescent material (e.g. quartz crystal), for generating a different luminescent reaction from the friction between the cogs pressing against each other. Accordingly, the light emission (i.e. luminescent reaction) when cog 520a is moved from one slot to another is distinct for the “target” slot (the slot to which the cog is being moved to), and may be indicative of the rotated position of section 112 at which cog 520a fits into the target slot. Section 112 may generally be transparent, to facilitate the output of the light from the device. Light generated by mechanism 526 may be mild sparks that are enough to be detected as indications by a visual recognition mechanism 828 as shown in FIG. 8A.

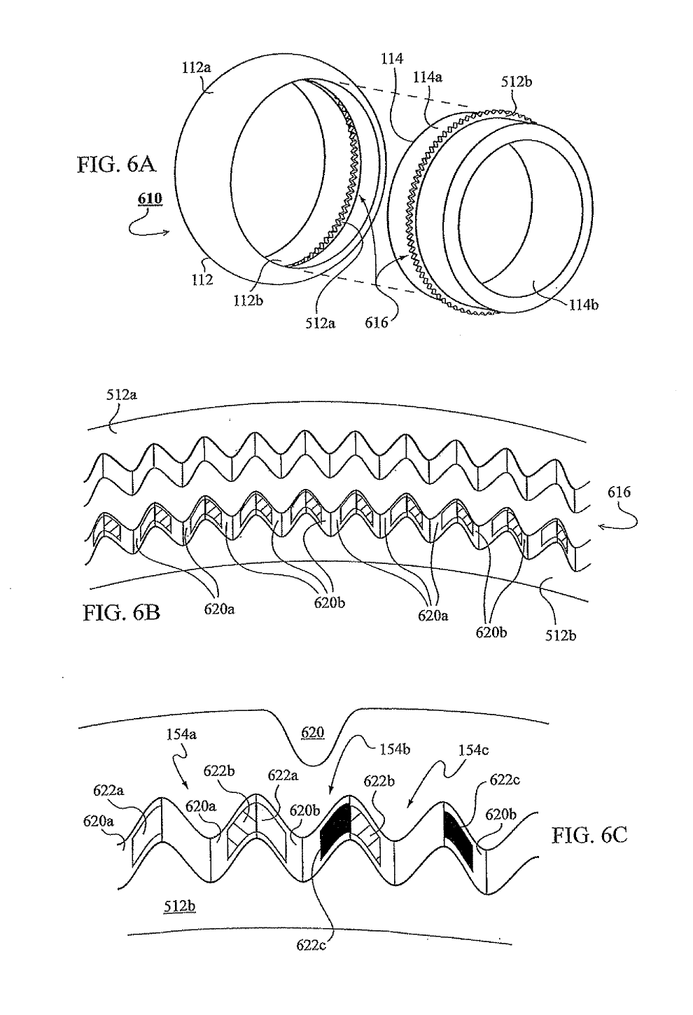

FIGS. 6A and 6B show a twelfth embodiment of a finger-worn device of the invention as a device 610 which includes a rotatable section 112, a stationary section 114 and a power generating mechanism 616 for generating power to operations of the device and for indicating rotation of section. Generating power is facilitated by converting use to electricity by any number of mechanisms known in the art. In FIGS. 6A and 6B, mechanism 616 is shown to include a pattern 512a of cogs 620 protruding from an internal side 112b of section 112, and a pattern 512b of cogs 620 protruding from an external side 114a of section 114 so that the cogs of both pattern fit together when the sections are connected. In FIG. 6B, each of the cogs of pattern 512b are shown to have one side 620a and an opposite side 620b. Similarly to the described for device 510, when section 112 is rotated, the cogs of pattern 512a press against either side 620a or side 620b of every cog of pattern 512b, depending on the direction of rotation. Generating electricity, such as electric voltage, may be facilitated by converting the force applied to rotate section 112 to electric energy. For example, each side of the cogs of pattern 512b may include a transducer which can convert pressure to an electric current (see e.g. U.S. Pat. No. 7,005,780), such as the pressure caused from the cogs of pattern 512a pressing against any of sides 620a,b when section 112 is rotated in any direction. The electricity generated by mechanism 616 may be utilized to supply energy for operations of device 610, such as by “powering-up” components and/or mechanisms of the device. The electricity may be utilized, additionally or alternatively, to recharge any rechargeable power-source of the device. Power generating mechanism 616 may be utilized, in addition to the described above, as an exemplary indication mechanism, such as by detecting different electric voltages generated by mechanism 616 correspondingly to different uses of the device.

In one example, side 620a includes a first piezoelectric material, whereas side 620b includes a second piezoelectric material. When the cogs of pattern 612 are pressed against sides 620a of the cogs of pattern 512b by rotation of section 112 in one direction, the pressure causes the first piezoelectric material to generate a certain electric voltage. When the cogs of pattern 512a are pressed against sides 620b of the cogs of pattern 512b by rotation of section 112 in an opposite direction, the pressure causes the second piezoelectric material to generate a different electric voltage. The two different voltages may then be utilized to differentiate between directions of rotation of section 112.

In another example, similarly to the described for the indication mechanism in FIG. 5D, pattern 512a may include one cog 620, while in pattern 512b, a side 620a of one cog and a side 620b of an adjacent cog include the same piezoelectric material, so that the voltage generated by the cog of pattern 512a pressing on any of these sides to fit between these cogs is the same. Alternatively, that voltage is different for any opposite sides of two adjacent cogs. FIG. 6C shows indication locations 154a-c as slots formed by four cogs 620 of pattern 512b, wherein side 620a of a first of each pair of cogs that form a slot, and side 620b of a second cog of that pair, include the same piezoelectric component, e.g. transducer 622a. This transducer is different from the transducer included in a side 620a of a first cog and in a side 620b of a second cog of every other pair (e.g. transducers 622b and 622c).

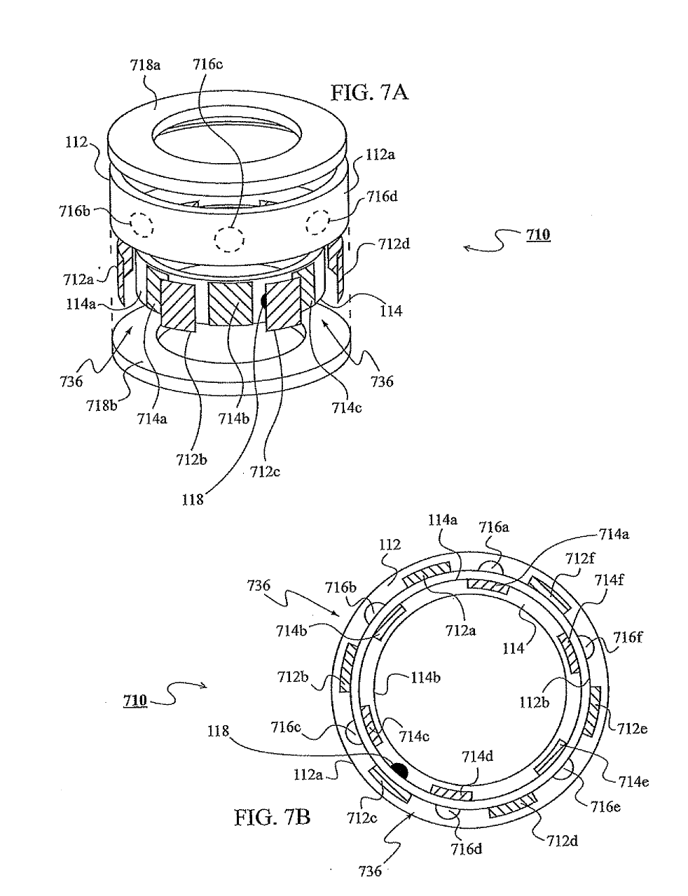

FIGS. 7A and 7B show a thirteenth embodiment of a finger-worn device of the invention as a device 710. Device 710 includes a rotatable section 112 having magnets 712a-f, in between which are circuits 716a-f, and a stationary section 114 having magnets 714a-f. The magnets and the circuits are part of a magnetic mechanism 736 of the device utilized for influencing rotation and rotated positions of section 112. In FIGS. 7A and 7B, magnets 712a-f and circuits 716a-f are exposed at an internal side 112b of section 112, with their north pole facing an external side 114a of section 114. Additionally, magnets 714a-f are exposed at external side 114a, with their north pole facing internal side 112b. Section 112 is bounded by a side section 718a and a side section 718b to prevent it from being repelled off of section 114 by the repulsion of the magnets on each section. Accordingly, sections 718a and 718b form a track 218 on which section 112 can be rotated. Each circuit 716a-f can be activated to generate a magnetic field, which can either have its north pole or its south pole directed at external side 114a, depending on the direction of the current. When each circuit 716a-f generates a magnetic field that has its north pole directed at external side 114a, section 112 is evenly repelled from section 114 and thus “hovers” on it (utilizing a magnetic levitation effect, or magnet suspension effect). When each of the circuits generates a magnetic field that has its south pole directed at external side 114a, section 112 “settles” at a rotated position where each circuit 716a-f is directly facing one of magnets 714a-f that was nearest to it when the magnetic fields where activated, as each circuit is attracted by a magnet on section 114 that was closest to it. This is caused by the pattern of magnetic attraction and repulsion formed by circuits 716a-f and magnets 712a-f. Section 112 is then loosely held at the rotated position at which it “settled” when the magnetic field were activated, because each circuit is attracted to the magnet it is facing, and because magnets 712a-f repelled from in further rotating by magnets 714a-f. If enough force is applied to “overcome” the repulsion between the magnets of on each section, section 112 can be rotated to any other position where circuits 716a-f directly face magnets 714a-f. This simulates a “feeling” of section 112 being physically accommodated at specific rotated positions, thereby implementing a stations configuration as explained above re. FIGS. 3C, D. Accordingly, mechanism 736 may be implemented as an exemplary physical feedback mechanism 340. As shown in FIGS. 7A and 7B, device 710 may further include, in addition to the described above, a sensing mechanism 118 for sensing and indicating rotation of section 112, and/or specific rotated positions of section 112. In some embodiments, mechanism 118 may be located on external side 114a facing internal side 112b and may utilize magnetic sensors for sensing changes in magnetic fields caused by relative motion of the magnets and/or circuits.

In accordance with the above, any magnetic or electromagnetic elements and effects may be utilized to influence rotation and/or rotated positions of a rotatable section. For example, diamagnetism may be utilized by including a pyrolytic-carbon material, to facilitate levitation of a rotatable section 112 on a stationary section 114.

FIGS. 8A through 8C show a fourteenth embodiment of a finger-worn device of the invention as a device 810, in which a passive indication mechanism is implemented as an interferomeric reflection mechanism 816 that modulates light reflection to facilitate indication. Device 810 includes a transparent rotatable section 112 having cogs 520 and a stationary section 114 having similar cogs that fit together with the cogs of section 112, to provide a plurality of physically accommodated rotation positions as stations. In FIGS. 8A through 8C, reflection mechanism 816 is generally shown having sheets 818 connected to both section 112 and section 114. Connected to the sheets are substrates 812, each of which, as shown in close-up in FIG. 8D, includes a transparent layer 812a and an optical thin film 812b. Also specifically shown in FIG. 8D is an absorber layer 814. The absorber layer covers an external side 114a of section 114, as shown in FIGS. 8A through 8C. For each station (i.e. rotated position where the cogs of section 112 fit together with the cogs of section 114), the distance between substrates 812 and absorber layer 814 is different, while each substrate 812 always overlaps a part of layer 814 that is parallel to it, as shown in FIG. 8D. At the top of the figure is a rotated position 412a where the distance between each substrate 812 and layer 814 is in, while at the bottom of the figure is a rotated position 412b where the distance between each substrate 812 and layer 814 is n, which is shorter than m. Shown in FIGS. 8A through 8C, are different stations in which sheets 818 have different angles with layer 814. Exemplarily, the more the angle is straight, the farther substrates 812 are from external side 114a and accordingly from absorber layer 814. Controlling the distance between layer 814 and substrates 812, while having a part of the layer that is always parallel to a substrate, facilitates modulating the color generally reflected from the device, in accordance with any interferometric modulator known in the art to control the wavelength of reflected light (see e.g. U.S. Pat. Nos. 7,113,339 and 6,952,303), so that mechanism 816 acts as a mechanical interferometric modulator and an indication mechanism indicating rotated positions of section 112 by different reflected colors. Indications may be detected by sensing light generally reflected from the device, specifically different colors, each indicative of a position. In FIG. 8A, reflected light is shown to exemplarily be detected by a visual recognition mechanism 828 which may include an optical sensing mechanism 128. Mechanism 128 may be connected to a processing unit 144 having a recognition function fox recognizing certain reflected properties as indications of rotated positions of section 112. Optionally, mechanism 828 may further include a light source 132 for illuminating the device. Alternatively, device 810 may include, in addition to the described above, its own light source 132 for illuminating the device, such as in case no external source of light is available, or such as in low lighting conditions. Note that an interferometric modulation effect may be achieved by any other mechanical apparatus implemented in a device of the invention for reflecting different colors for different rotated positions. Additionally, such apparatus may be implemented to modulate reflection correspondingly to other kinds of states of a device, such as tilted positions.

FIGS. 8E through 8F show a fifteenth embodiment of a finger-worn device of the invention as a device 820, similar to device 810, having a general reflection mechanism 826 as a passive indication mechanism, which utilizes dynamic and opaque shutters 824 and optical filters 822 which filter light with certain properties (e.g. polarization axis, wavelength, etc.) correspondingly to their angle with an external side 114a of section 114 which is shown in the figures to be covered by a reflective surface 830. Similarly to the described for sheets 818, and as shown in FIGS. 5E and 8F, the filters are at different angles with the surface for different rotated positions of section 112. Shutters 824 block light from reaching surface 830 other than through filters 822. The filters may be interference filters, for example, wherein rotation may change their position and/or location relative to the surface.

FIG. 8G shows a sixteenth embodiment of a finger-worn device as a device 840 that includes a rotatable section 112, a stationary section 114 and a reflection mechanism 836 which utilizes optical filters 822a-c′ on section 112 and acts as an exemplary indication mechanism. Each filter has distinct filtering properties, providing for examples different colors (filter 822a′ shown with crossed lines for illustrating a first color, filter 822b′ shown with lines for illustrating a second color and filter 822c′ shown with no lines to exemplarily illustrate transparency). Mechanism 816 may further utilize a fluorescent surface 830′ on an external side 114a (surface 830′ is shown as a circular surface partially covered by section 112 and partially apparent through filter 822b′). In specific rotated positions of section 112, each of filters 822a-c′ overlaps surface 830′, so that light reaching the surface and emitted from the surface must pass through that filter, which exemplarily determines the color of the light as it passes through. Accordingly, light may generally be emitted from device 840 having one of three colors which corresponds to one of the three filters. Each color may be detected for registering a different input than input registered by the detection of the other colors.

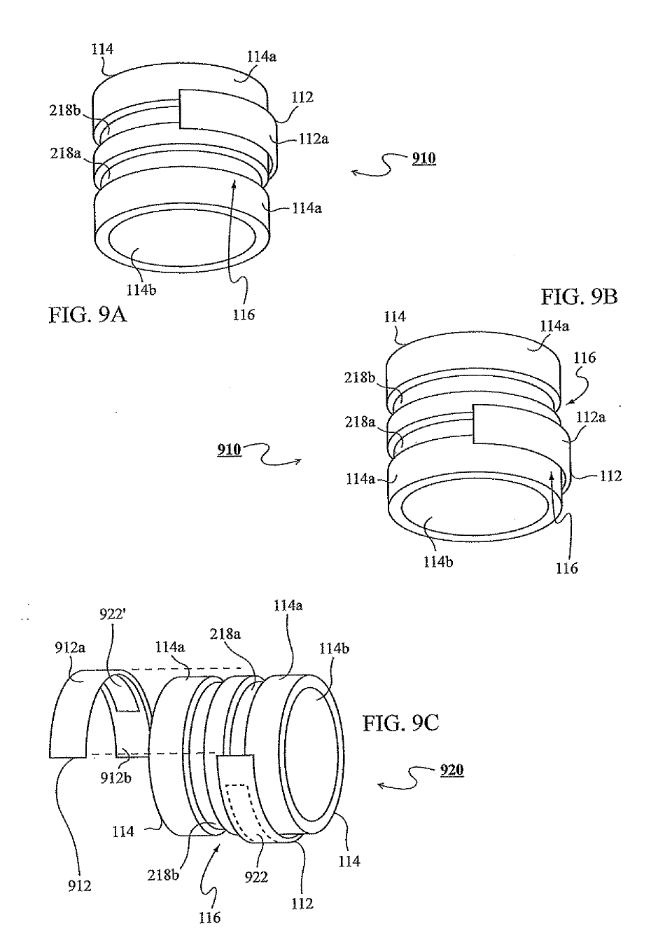

FIGS. 9A and 9B show an seventeenth embodiment of a finger-worn device of the invention as a device 910 which generally includes a rotatable section 112 and a stationary section 114 having rotation tracks 218a,b. Section 112 can be set to rotate on any track 218. Device 910 further includes an indication mechanism 116 (exemplarily implemented on each track) for indicating differently the rotation on each track (device use), and/or for indicating on which track section 112 is set to rotate at any given time (device state). Note that the rotation on each track may be indicated as being “SAME”, while different indicated states (of the rotatable section being set to any track) may correspond to registering a different input from the rotation on each track.

FIG. 9C shows an eighteenth embodiment of a finger-worn device of the invention as a device 920 similar to device 910, which includes a plurality of rotatable sections 112. In FIG. 9C, device 920 includes, additionally to the described above, a rotatable section 912 similar to rotatable section 112. Section 912 is shown to include a connection mechanism 922′ on an internal side 912b so that it may be connected to and disconnected from device 920, specifically to and from any of tracks 218a,b on which it may be rotated to indicate specific use of the device. For example, connection mechanism 922′ may utilize mechanical clips on side 912b to physically attach section 912 to each track. Section 912 may specifically be connected to any track not occupied by another rotatable section, and may be disconnected from a track it occupies. For a more specific example, track 218a may correspond to controlling audio volume, while track 218b may correspond to controlling the playback of any audio file. Additionally, section 112 may correspond to a first audio file, while section 912 may correspond to a second audio file. Each file may exemplarily be stored on a memory unit (e.g. memory unit 146) of each rotatable section, so that connection of each section to a track facilitates accessing the file. Alternatively, specific indication of rotation of each section may correspond to registering specific input for controlling each file. A user may connect any one of the rotatable sections to the device (in case section 112 also has a connection mechanism 922, and may be connected and disconnected from any of the tracks) to play the file corresponding to that section. Connection of the section may specifically be to each of the tracks, for controlling audio volume and playback of the file. The user may disconnect the rotatable section and connect the other section, to play the audio file corresponding to the other section, and for controlling audio volume and playback of that file. In some embodiments, a first section may remain connected to a track which corresponds to controlling audio volume, while a second section is connected to a track which corresponds to controlling playback, so that volume and playback may be controlled simultaneously by the two sections connected to the tracks. According to the above, each section and each track may correspond to different interface elements or different operations. Moreover, in device 920, both rotatable sections may be connected permanently (i.e. excluding any connection mechanism).

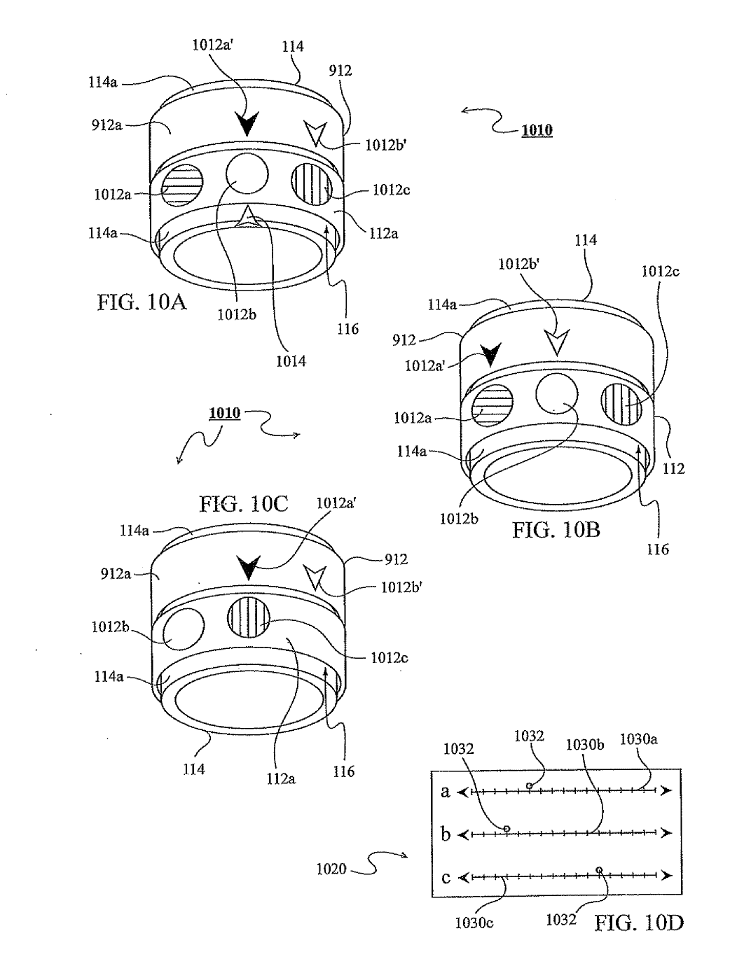

FIGS. 10A, 10B and 10C show a nineteenth embodiment of a finger-worn device of the invention as a device 1010 being utilized for different operations. Device 1010 is similar to device 920 but further includes a visual output mechanism on the external side of each rotatable section, namely on external side 112a of section 112 and on an external side 912a of section 912. Exemplarily displayed on side 112a are displayed objects 1012a, 1012b and 1012c. Exemplarily displayed on side 912a are displayed objects 1012a′ and 1012b′. In device 1010, each of the objects may be any displayed entity as part of an exemplary visual output mechanism. For example, specifically in device 1010, each object may be a letter or digit composed of activated liquid crystals in a liquid crystal display (LCD). For another example, the objects may be graphic symbols composed of pixels of light emitting diodes (LEDs). In FIGS. 10A, 10B and 10C, each of displayed objects 1012a, 1012b and 1012c exemplarily represents an interface element. For example, each of the objects may be, a graphic symbol (e.g. “icon”) representing of a different file, such as by being a number corresponding to a file in a list of numbered files. Additionally, each of displayed objects 1012a′ and 1012b′ exemplarily represents a function. For example, object 1012a′ may be a graphic symbol representing “compression” (of files) while object 1012b′ may be a graphic symbol representing “deletion”. When a particular file symbol is aligned with a function symbol, that function is performed on the file. For example, when object 1012a is aligned with object 1012a′, the file corresponding to object 1012a is compressed. Optionally, when the process is done, object 1012a is exemplarily blinking, as a visual feedback. For another example, when object 1012b is aligned with object 1012b′ (in FIGS. 10B) the file corresponding to object 1012b is deleted, while object 1012b may exemplarily cease from being displayed by the visual display mechanism. Execution of functions may be prompted indication of alignments, or by information of alignments being obtained from indication of rotated positions of the rotatable sections. FIG. 10B shows the result of rotating section 912 counter-clockwise from its position in FIG. 10A, while FIG. 10C shows the result of rotating section 112 counterclockwise from its position in FIG. 10A.

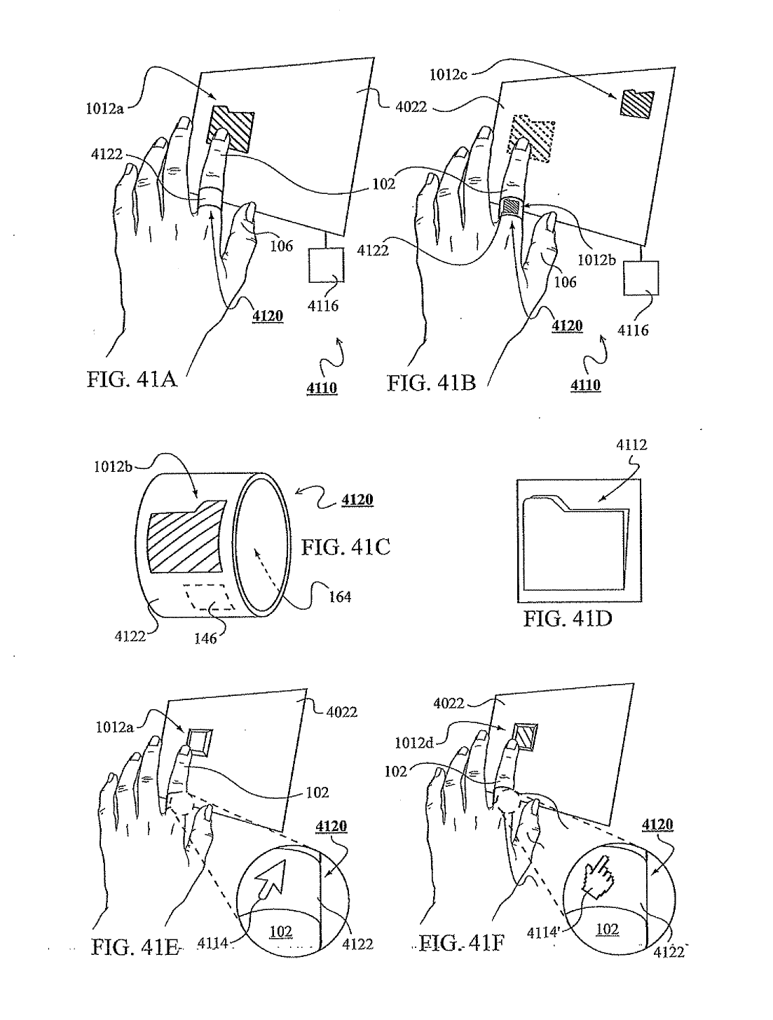

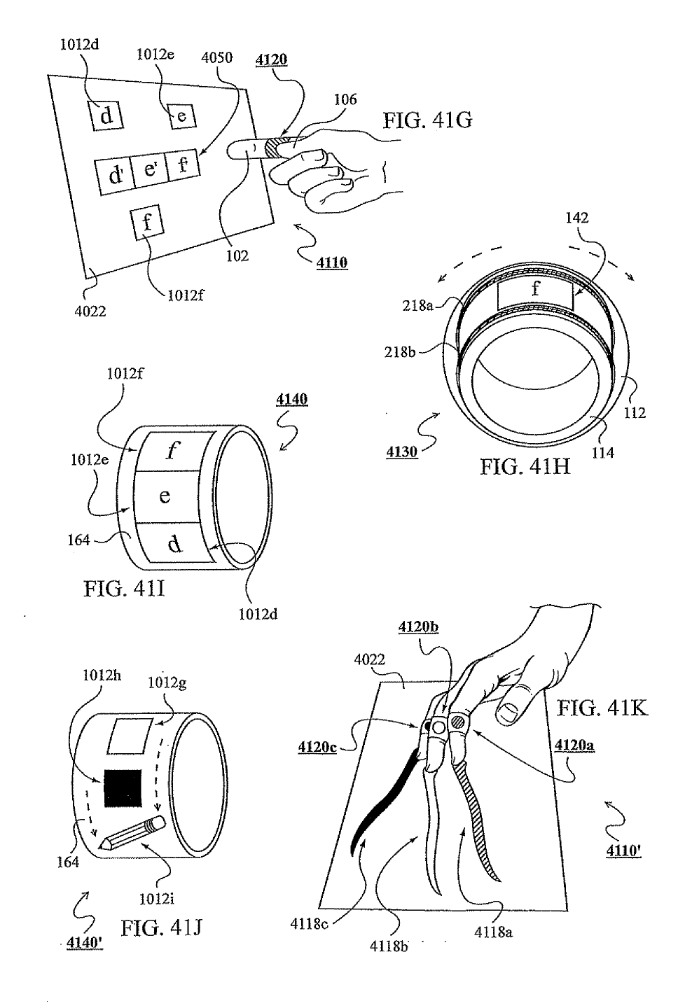

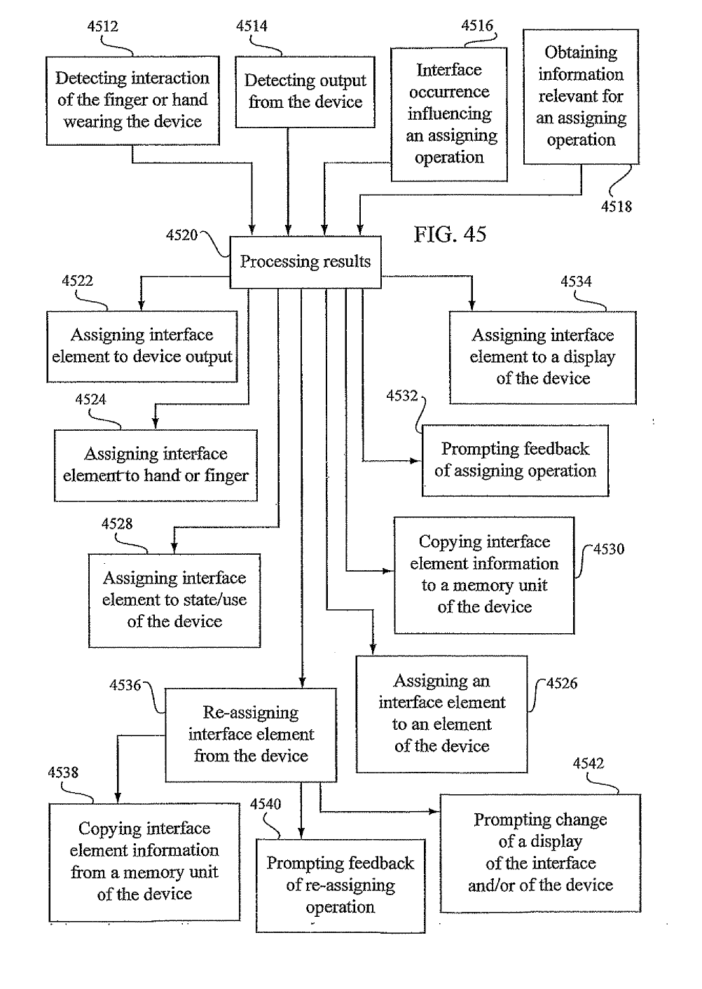

In some embodiments, the displayed objects may correspond to interface elements which were assigned to device 1010 (see FIGS. 41A-41K, and the method in FIG. 45).

Similar results may be achieved by different alignments of rotatable section 112 with rotatable section 112′ in a device 210 (see FIGS. 2A and 2B) which may include a visual output mechanism on each section.

Note that the description of FIGS. 10A-C is exemplary, to illustrate the method of alignment for controlling interfaces. This description applies equally well to devices with only rotatable sections (e.g. as in FIGS. 2) and to devices with one stationary section and one rotatable section, wherein alignment is between specific locations on the stationary section (e.g. a location 1014 shown in FIG. 10A) and specific locations on the rotatable section.

In device 920, alignments may also correspond to specific locations on section 114. For example, a function represented by any of objects 1012a′ and 1012b′ may be executed on any of the files represented by objects 1012a-c only if the function object and the “target” file object are both aligned with location 1014 shown on section 114. In FIG. 10A, alignment of each of the objects shown in FIGS. 10A-C with location 1014 necessarily corresponds to a specific rotated position of the rotatable section on which that object is displayed.

According to the above, combinations or alignment of rotated positions of rotatable sections of a device of the invention, may be specifically indicated, or registered as input from indications of each position, so that each combination or alignment may correspond to a different operation, either of the device or of a separate party receiving the indications.

FIG. 10D shows an interface 1020, having multiple elements controllable by finger-worn devices of the invention. In FIG. 10D the interface exemplarily includes elements 1030a-c. Each element may be any series of members, such as being a scale of values or list of functions. In interface 1020, each element has a controllable selection 1032 for selecting any one member at any given time. The selection is shown in FIG. 10E as a circle marking a location on each element, while specific locations correspond to members of the element. In some embodiments, the selection of each element may be moved from one member (i.e. specific location) to another by rotation of a rotatable section, while multiple rotatable sections may be for controlling multiple elements. For example, in a device 920, rotation of section 112 may be assigned to move selection 1032 of element 1030a, while rotation of section 912 may be assigned to move selection 1032 of element 1030b. Additionally, simultaneous rotation of both sections (i.e. sections 112 and 912) may be assigned to move selection 1032 of element 1030c. Accordingly, rotation of each of the sections individually and both of the sections simultaneously may facilitate selecting members of the elements in interface 1020. In some embodiments, assigning control to each and both sections, or for rotation of each and both sections, may be temporary, and may be changed by further assigning.

In another method for utilizing device 920 for controlling an interface 1020 which has multiple elements 1030, each element corresponds to a specific alignment of a section 112 with a section 912 (similarly to the described in FIGS. 10A-C), while scrolling through each element (i.e. controlling a selection 1032 of that element) is by simultaneous rotation of the two sections, during which the alignment between the two sections remain the same.

FIGS. 11A and 11B show a twentieth embodiment of a finger-worn device of the invention as a device 1110 generally including a plurality of devices connected “back-to-back”. Note that in general, any two devices of the invention may be connected this way. Device 1110 is shown in FIGS. 11A and 11B to include a device 1120 and a device 1130. Device 1120 generally includes a rotatable section 112, a stationary section 114 and an indication mechanism, whereas device 1130 generally includes a rotatable section 912, a stationary section 114 and an indication mechanism. A connection mechanism 922 of device 1110 facilitates connecting devices 1120 and 1130, and is shown here to be embodied as a socket 1122a and a socket 1122b on device 1120 and a plug 212a and a plug 212b on device 1130, whereas plug 212a can fit into socket 1122a and plug 212b can fit into socket 1122b. In some embodiments, information and/or electricity can be transferred by the connection of the two devices by mechanism 922, from one device to the other and vice versa. Devices 1120 and 1130 may further have an additional indication mechanism, or a plurality thereof (e.g. one for each device), for indicating a connected state and/or a disconnected state of the device, respectively. Alternatively, mechanism 922 may indicate connection, such as by utilizing a switch in each socket, activated by a plug being inserted into each socket.

In some embodiments, device 1110 may provide more control functions than the control features of separated devices 1120 and 1130. For example, as specifically shown in FIG. 11A, when separated from device 1130, device 1120 may control a separate party 320a, such as by indications of rotation transmitted to separate party 320a. Similarly, when separated from device 1120, device 1130 may control separate party 320b. As specifically shown in FIG. 11B, when connected together, devices 1120 and 1130 may facilitate control of a separate party 320c, in addition to separate parties 320a,b. Rotation of section 112 of device 1120 in rotation directions 122a,b may be for selecting any one of separate parties 320a-e by browsing between the separate parties in corresponding directions 1112a,b (i.e. generally clockwise and counter-clockwise in the figure) while rotation of section 912 of device 1130 may be for specifically controlling any one of separate parties 320a-b that was selected by rotation of section 112 of device 1120. Note that the connected devices may operate in the same way as a device having multiple rotatable sections (e.g. as described in FIG. 10).

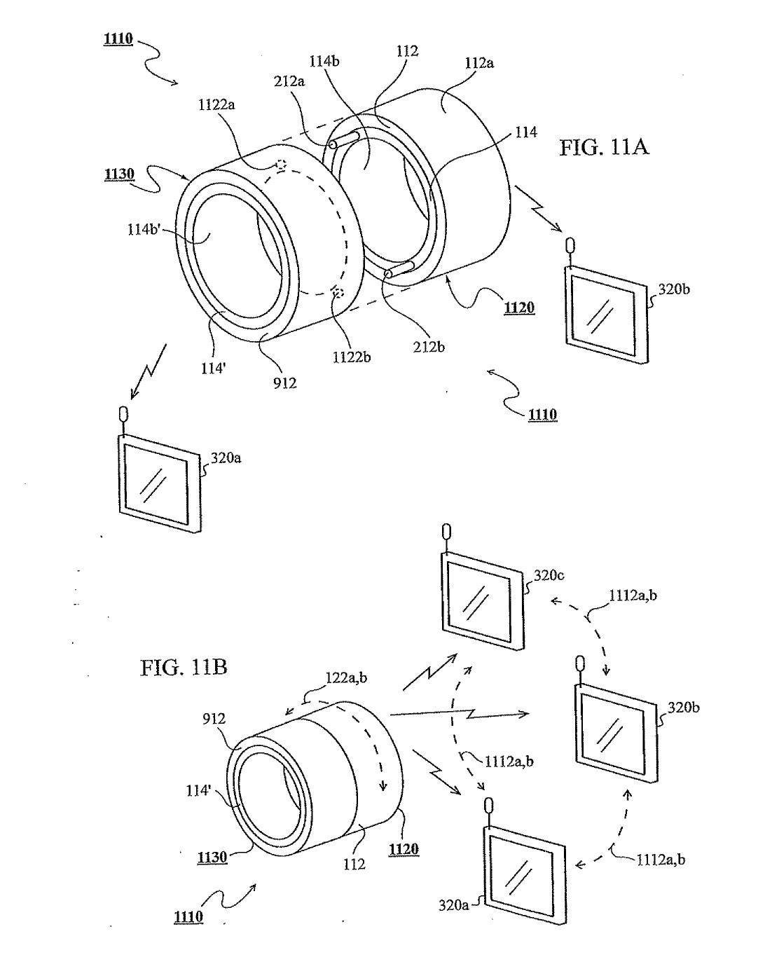

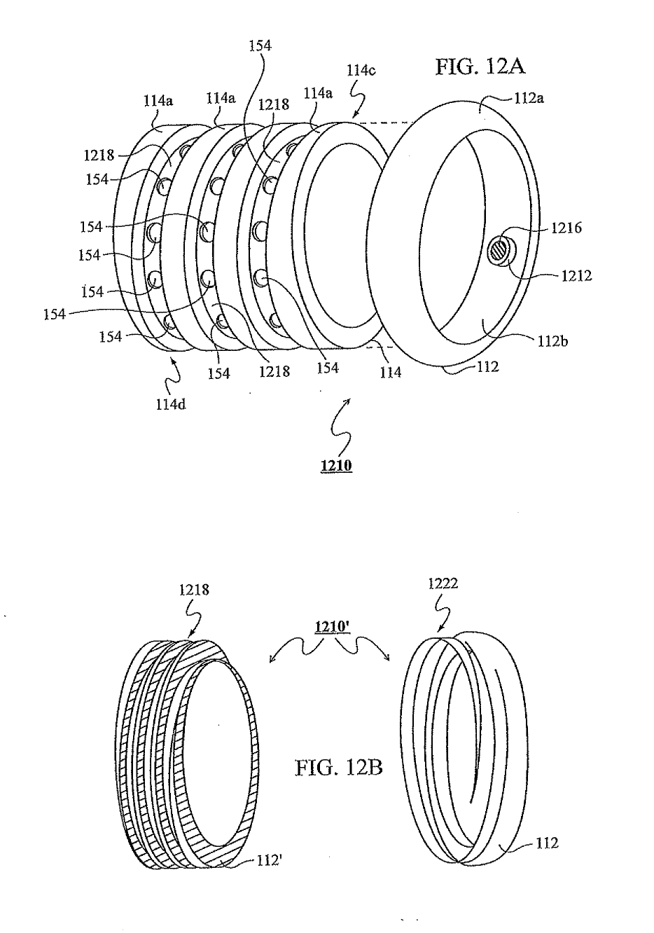

FIG. 12A shows a twenty first embodiment of a finger-worn device of the invention as a device 1210, in which a rotatable section 112 is set to rotate on a helical track (i.e. a track shaped similarly to a screw-like groove). In FIG. 12A, device 1210 is shown to generally include a rotatable section 112 and a stationary section 114 that has a helical track 1218 curved on an external side 114a. Accordingly, section 112 can be rotated along the curve of the track, towards a side 114c or 114d of section 114. Device 1210 further includes an indication mechanism exemplarily including a plurality of indication locations 154 along track 1218, each corresponding to a specific rotated position of section 112, and also utilizing a clicker 1212 on an internal side 112b which can be “clicked” to any extent and can fit into any of the indication locations. In some embodiments, the clicker can be physically accommodated in each indication location (for the stations effect). Indications may be facilitated by clicker 1212 having a pressure sensing mechanism 1216, which is utilized for the indication mechanism of the device, while each indication location may have a different depth from any other. Accordingly, when the clicker is accommodated in a certain location, it is pressed (i.e. clicked) to a different extent, wherein the extent is measured by the pressure sensing mechanism and indicated further.

Following the above, any connection mechanism 922 of a device of the invention may facilitate connection of two sections of the device, or two separate devices (ref. FIGS. 11A and 11B) by “screwing” them together, wherein a rotatable section is screwed on an open helical track 1218 of another section, while rotation on the track, and specific rotated positions, may be indicated by any indication mechanism 116. For example, in an embodiment of a finger-worn device, shown as a device 1210′ in FIG. 12B, and similar to device 210, a helical plug 1222 of a rotatable section 112 may be screwed manually in and out of an open helical track 1218 of a section 112′ (by rotating section 112 towards section 112′ or vice versa), as opposed to a plug 212 being installed inside a close straight track. Accordingly, the sections may be connected and disconnected by the screwing.

FIGS. 13A through 13E show a twenty second embodiment of a finger-worn device of the invention as a rotatable and tillable device 1310. As shown in FIG. 13A, a device 1310 generally includes a rotatable section 112 and a stationary section 114, wherein section 112 can be rotated according to rotation directions 122a,b and an indication mechanism 116. As shown in FIGS. 13B, 13C and FIG. 13E, section 112 can be tilted relative to section 114, such as to contact section 114 in either a contact location 1320a (FIG. 13B) or a contact location 1320b (FIGS. 13C and 13E). Specifically shown in FIG. 13B is a tilted position 414b of section 112, and in FIG. 13C a tilted position 414c of section 112. In some embodiments, section 112 can be rotated while not tilted, as specifically shown in FIG. 13D a rotated position 412d of section 112. Additionally or alternatively, section 122 can be rotated while tilted, as specifically shown in FIG. 13E a rotated and tilted position 416e.

FIG. 13F shows a transponder mechanism 1316 as an exemplary passive indication mechanism for indicating tilt. Mechanism 1316 utilizes a transponder circuitry having an antenna 1318 (shown to be on a section 112) and different passive transponders 1322 (shown to be on a section 114). Similarly to the described for a passive indication mechanism 116a in FIGS. 2C and 3C, each transponder may be an indication location for indicating contact of section 112 with section 114 specifically at that location, where section 112 is in a specific tilted position. Only one transponder may be connected to the antenna at each specific tilted position, thus only that transponder can respond to incoming signals when section 112 is tilted on it. Accordingly, detecting responses from a connected transponder-and-antenna facilitates obtaining an indication of the position of section 112.

Note that while the described herein is for rotatable and tiltable devices having a rotatable section and a stationary section, it is clear that devices of the invention which include only a rotatable section may be tiltable (i.e. any rotatable section can be adapted to be also tiltable relative to any other rotatable section) and may attain all the features described herein for rotatable and tiltable devices. For example, referring to the described for device 220 in FIG. 2D, the device may be adapted so that section 112 can be tilted relative to section 112′ and/or so that section 112′ can be tilted relative to section 112, while tilt of any of sections 112 and 112′ may be indicated by any mechanism described herein for indicating tilt (e.g. transponder mechanism 1316).

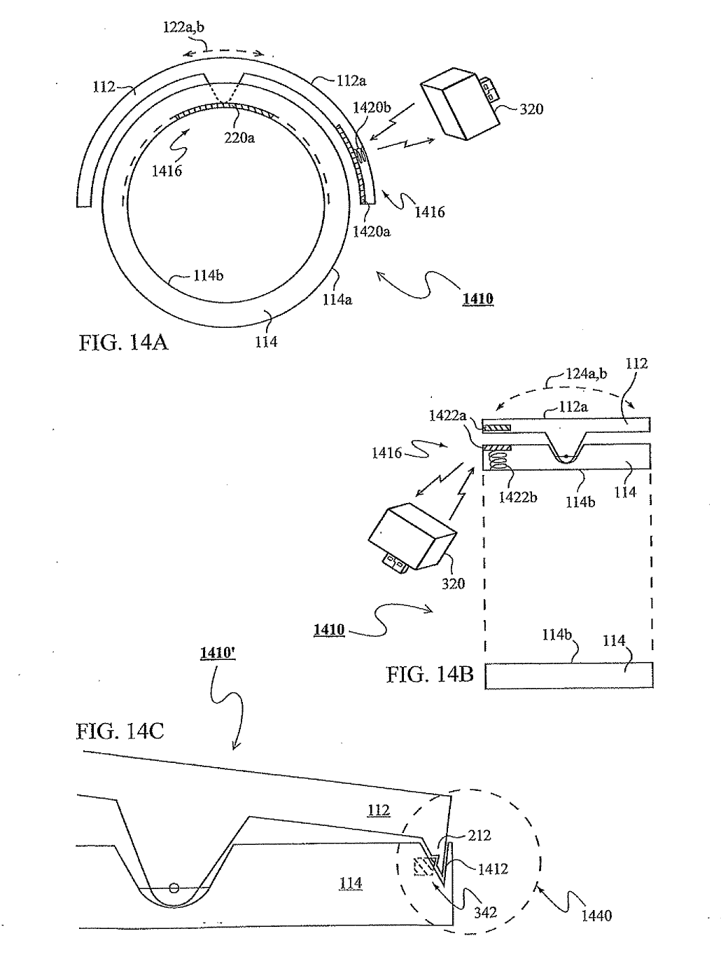

FIGS. 14A and 14B show a twenty third embodiment of a finger-worn device of the invention as a rotatable and tiltable finger-worn device 1410 similar to device 1310. Device 1410 includes a rotatable section 112; a stationary section 114 and a passive indication mechanism implemented as a resonance mechanism 1416. Section 112 may be rotated relative to section 114 in rotation directions 122ab, and may also be tilted relative to section 114 in tilt directions 124a,b. In FIGS. 14A and 14B, mechanism 1416 is shown to include a coil-and-capacitor resonant circuit 1420 and a coil-and-capacitor resonant circuit 1422, both of which can oscillate in response to stimulations from incoming signals, shown originating from a separate party 320. Circuit 1420 includes a capacitor 1420a connected to a coil 1420b, while circuit 1422 includes a capacitor 1422a connected to a coil 1422b. Capacitors 1420a and 1422a are divided between section 112 and section 114 so that relative motion in directions 122a,b and 124a,b changes the capacity of capacitors 1420a and 1422a, respectively, and with it the resonant frequency of circuits 1420 and 1422. In some embodiments, signals from party 320 cause circuits 1420 and 1422 to resonate, wherein the energy emitted by resonating circuits 1420 and 1422 has specific properties corresponding to the positions of section 112 relative to section 114. The energy is accordingly indicative of rotated and/or tilted positions of section 112, and may be detected by separate party 320, as shown in the figures. Combinations of indications of rotated and/or tilted positions may be registered as specific input. In other embodiments, other compositions of coils and capacitors may be implemented to passively indicate tilt and/or rotation.

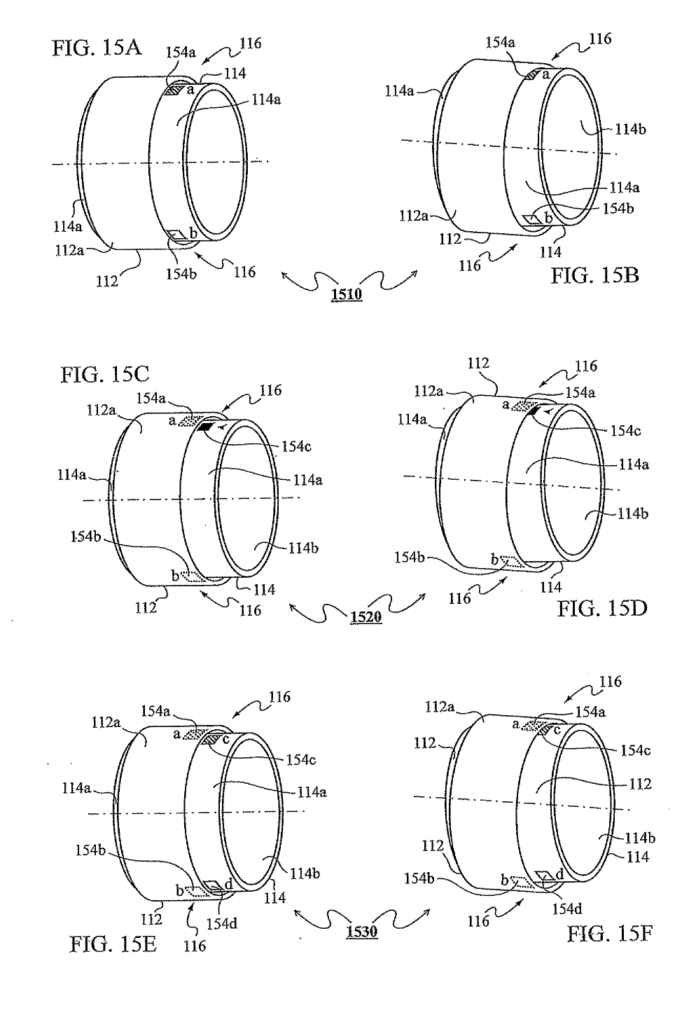

FIG. 14C shows a locking mechanism 1440, which may be implemented in any device of the invention and which is described here exemplarily for device 1410′. Similarly to the described for locking a rotatable section 112 in rotated positions and for blocking section 112 from rotated positions (see physical feedback mechanism 340 in FIGS. 3C and 3D), mechanism 1440 can lock a section 112 in tilted positions, and block section 112 from tilted positions. A mechanism 1440 is shown in FIG. 15C to be exemplarily implemented in a device 1410. In the figure, a rotatable section 112 of device 1410 is shown having a plug 212 which is inserted into a socket 1412 when the section is tilted in a direction 124b. In device 1410, mechanism 1440 includes a pin 342 which can be actuated to lock plug 212 inside socket 1412. Actuation may be deactivated, for releasing the plug and thus allowing for section 112 to tilt to a different position. The pin may be actuated when the plug is not inside the socket, thus blocking the plug from being inserted into the socket and accordingly preventing section 112 for being tilted to a corresponding tilted position.

FIG. 15A and FIG. 15B show a twenty fourth embodiment of a finger-worn device of the invention as a rotatable and tiltable device 1510 in which tilted positions of a rotatable section are indicated according to specific locations on a stationary section 114. Device 1510 includes a rotatable section 112, a stationary section 112 and an indication mechanism 116 utilizing indication locations 154a and 154b located on an external side 114a of section 114. Each indication location corresponds differently to contact with section 112, for obtaining a different indication from each location. Note that the indication locations may be implemented by any description of such locations herein, or by any sensing and/or indicating mechanisms known in the art (e.g. a pressure sensing mechanism 1216 as described for device 1210 in FIG. 12A).

FIG. 15C and FIG. 15D show a twenty fifth embodiment of a finger-worn device of the invention as a rotatable and tiltable device 1520 in which tilted positions of a tiltable section are indicated according to a specific location on a stationary section 114 and according to specific locations on a rotatable section 112. Device 1520 includes a rotatable section 112, a stationary section 114 and an indication mechanism 116 which utilized indication locations 154a, 154b and 154c. Indication locations 154a and 154b are shown to be located on an internal side 112b of section 112, while indication location 154c is shown to be located on an external side 114a of section 114. Indications are obtained by contact of indication locations 154a and 154h with indication location 154c. For example, indication locations 154a and 154h include electrodes of different circuits which can be closed by contact of each electrode with electrodes included in indication location 154c. Accordingly, contact of indication location 154a with indication location 154c (specifically shown in FIG. 15D) may close a certain circuit that provides a certain indication, while contact of indication location 154b with indication location 154c may close a different circuit that provides a different indication. Contact of either of locations 154a and 154b with any other location on external side 114a is not indicated.

FIG. 15E and FIG. 15F show a twenty sixth embodiment of a finger-worn device of the invention as a device 1530 in which tilted positions of a rotatable section are indicated according to combinations of specific locations on a stationary section and specific locations on a rotatable section. Device 1530 includes a rotatable section 112, a stationary section 114 and an indication mechanism 116 which utilizes indication locations 154a, 154b, 154c and 154d. Indication locations 154a and 154b are shown to be located on an internal side 112b of section 122, while indication locations 154c and 154d are shown to be located on an external side 114a of section 114. Indications may be obtained by contact of indication locations 154a,b with indication location 154c,b so that four different combinations of contact correspond to four different indications. For example, contact of indication location 154a with indication location 154c, such as shown in FIG. 15F, indicates a certain device state, whereas contact of indication location 154b with indication location 154c indicates a different device state. Similarly, contact of each of indication locations 154a and 154b with indication location 154d indicates additional different device states.

In some embodiments, indication mechanisms 116 of devices 1510, 1520 and 1530 (i.e. the indication locations) may be able to indicate tilted rotation (i.e. rotation while in a tilted position) of the rotatable section of each, in addition to indicating specific tilted positions as states of the device. Indications of rotation (i.e. of use) may be combined with indications of contact of indication locations (i.e. of tilted positions, which may correspond to device states) for registering input corresponding to the combinations. For example, a rotatable section 112 of a device 1510 may be rotated while tilted on (i.e. in contact with) indication location 154a, or on indication location 154b, wherein the rotation on any location is for registering a different input than rotation on the other location. For a more specific example, in a device 1510, indication of rotation of section 112 when it is in contact with a location 154a on a section 114 may be registered as input for controlling a first interface element 1030. Indication of rotation of section 112 when it is in contact with location 154b on a section 114 may be registered as input for controlling a second interface element 1030 (as described for an interface 1020 in FIG. 10E). Optionally, indication of rotation of section 112 when it is not tilted may be registered as input for controlling a third interface element 1030. Optionally, a section 112 may include indication locations, so that rotation of the section while each of these locations is in contact with each indication location on a section 114 may be indicated for registering input corresponding to control a different interface element. The input may be registered at the device, such as in case the device further includes a processing unit receiving the indications, or may be registered at a separate party detecting the indications.

In general, device embodiments having tilt capabilities may include any number of indication locations configurations described above and tilting operations may provide any number of different indications described above. Note that indication mechanism 116 as described for devices 1510, 1520 and 1530 may be a passive indication mechanism (e.g. a passive indication mechanism 116a, see FIG. 2C)

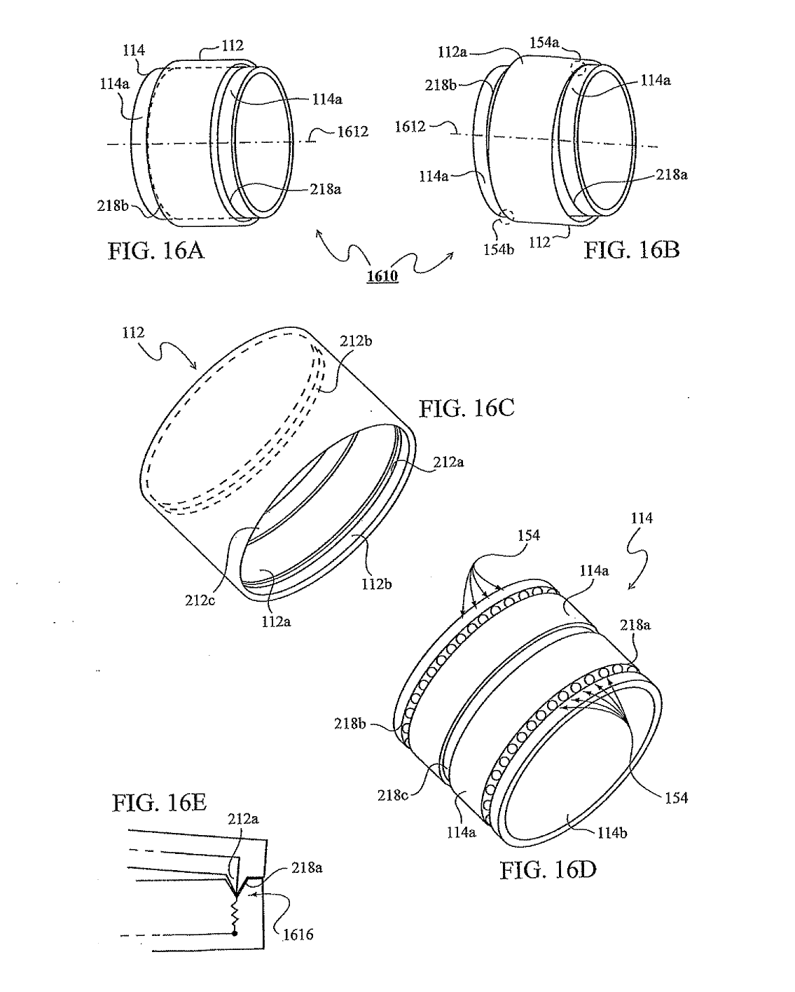

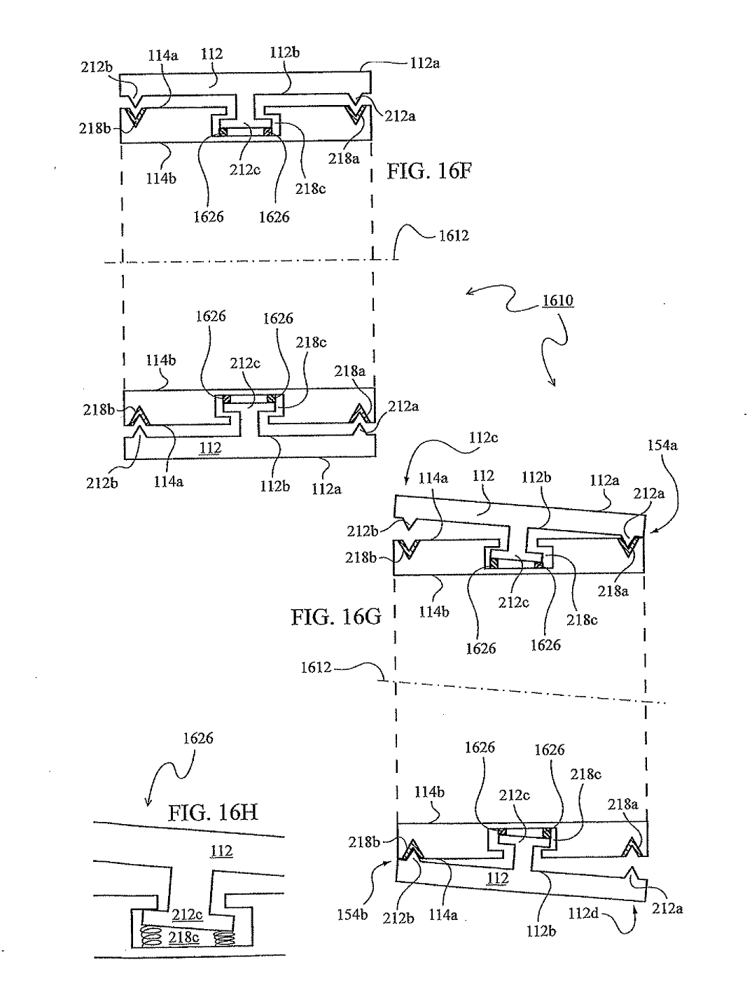

FIGS. 16A through 16G show a twenty seventh embodiment of a finger-worn device of the invention as a rotatable and tiltable finger-worn device 1610. In device 1610, a rotatable section 112 has an exemplary form of an external ring installed on a base ring shown as section 114. Section 112 can be rotated relative to section 114 around a rotation axis 1612 and can also be tilted on section 114, to reach tracks 218a and 218b on an external side 114a. When section 112 is tilted, a rotation axis 1612, around which section 112 rotates, is tilted accordingly by the same angle. Section 112 includes plugs 212a and 212b, extending from an internal side 112b, which can interlock with tracks 218a and 218b, respectively. Plugs 212a and 212b are shown in FIGS. 16B and 16G interlocked at an indication location 154a on track 218a and at an indication location 154b on track 218b, respectively. In this embodiment, an indication mechanism is implemented by the tracks having a plurality of indication locations 154, so that when the plugs of section 112 interlock at specific locations with the tracks, when section 112 is tilted on section 114, the corresponding tilted positions of section 112 are accordingly indicated. Optionally, locations 154 may also facilitate indication of rotation of section 112 around axis 1612 (i.e. use of the device) when a plug of section 112 contacts an indication location (i.e. section 112 rotates while tilted). In some embodiments, when a plug is connected to a track (i.e. interlocked at any indication location), they form temporary current dividing mechanism, such as shown in FIG. 16E plug 212a interlocked with track 218a to form a current dividing mechanism 1616. Mechanism 1616 (which may be included in the indication mechanism of device 1610) may facilitate indication of tilt by dividing a current differently for each indication location where a plug and a track interlock. Optionally, mechanism 1616 may further facilitate indication of rotation by further modulating the current as section 112 rotates while tilted on each indication location.

FIGS. 16C and 16D specifically show sections 112 and 114 of device 1610, respectively, as separated from each other to better illustrate the elements between them.

FIGS. 16F and 16G show a cross-section of device 1610. In FIG. 16F, section 112 is not in a tilted position, while in FIG. 16G, section 112 is in a tilted position 414. External side 114a of section 114 includes a track 218c, while section 112 includes a T shaped plug 212c extending from internal side 112b and installed inside the track. Also shown to be included is a snap-back mechanism 1626 for balancing the rotation of section 112 when it is not tilted. If no force is holding section 112 tilted or if the plugs 212a and 2121, are not interlocked with tracks 218a and 218b, snap-back mechanism 1626 causes section 112 to “snap-back” to its original un-tilted position (i.e. to return back to being aligned and concentric with section 114, as specifically shown in FIG. 16E). For example, as specifically shown in FIG. 16H, mechanism 1626 may utilize springs designed to balance plug 212c, and accordingly section 112, in a non-tilted position, while still allowing for enough pressure to be applied on the section to tilt it. Note that snap-back mechanism 1626 may be implemented in any device of the invention for “snapping-back” any position of a rotatable section to another position, such as a certain rotated position to an original “un-rotated” position. “Snapping-back” may be facilitated by any number of mechanisms known in the art (see e.g. U.S. Pat. Nos. 2,696,695 and 5,269,499 and 4,430,531). Similarly to a physical feedback mechanism 340, such as described for device 310′ in FIGS. 3D and 3E, snap-back mechanism may be modulated, so that a “snapping-back” effect may be activated and deactivated.

In some embodiments, interlocking of the plugs and the tracks may be facilitated by a locking mechanism similarly to the (e.g. a locking mechanism 1440 as described for a device 1410 in FIG. 14C). In device 1610, mechanism 1440 is exemplarily implemented on tracks 218a,b, specifically at each indication location 154, to sustain tilted positions of section 112 (i.e. hold section 112 tilted when no pressure is applied on the section to hold it tilted). Accordingly, plugs 212a and 212b and, respectively, tracks 218a and 218b may interlock to prevent section 112 from “snapping-back” to its un-tilted position by snap-back mechanism 1626. Optionally, plugs 212a and 212b may be unlocked from tracks 218a and 218b, respectively, by applying enough pressure on an opposite side of section 112 from where the plugs and tracks interlock (e.g. by generally pressing on a side 112c or a side 112d of section 112.

In some embodiments, certain locations on the tracks may be temporarily inaccessible for plug insertion, and accordingly corresponding tilted positions of rotatable section 112 are physically prevented. For example, a locking mechanism 1440 may lock certain locations on any of the tracks when a plug is not interlocked with it, for preventing any of the plugs from being inserted into it. Accordingly, this may facilitate “granting” or “denying” control of an operation which corresponds with specific locations, such as to physically block tilting on specific locations when their corresponding operations are not accessible. For example, a separate party may be out of range of communication with device 1610, and so a tilted position of a rotatable section 112, which in some cases correspond to controlling the separate party, may be locked to prevent a user from tilting the section to that position.

In some embodiments, indicating tilted positions may be facilitated by snap-back mechanism 1626. Pressure sensors (e.g. a plurality of pressure sensing mechanisms 1216 as described for a device 1210 in FIG. 12A) may be coupled with the mechanism (such as “beneath” springs of the mechanism, as shown in FIG. 16H) and influenced by “unbalanced” angles of section 112 (i.e. any tilted position of the section) for generating indications corresponding to the pressure applied from the springs.

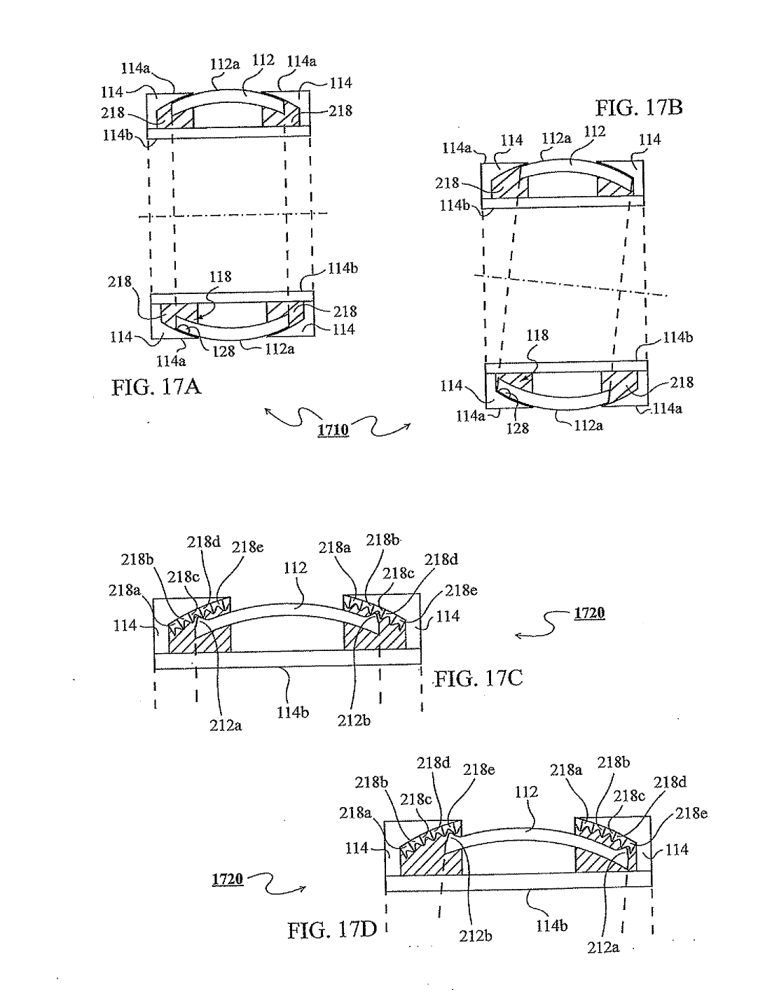

FIGS. 17A and 17B show a twenty eighth embodiment of a finger-worn device of the invention as a rotatable and tillable finger-worn device 1710. In device 1710, a stationary section 114 encapsulates a rotatable section 112 in a track 218 formed between an external side 114a and an internal side 114b of section 114. Section 112 is still exposed so that is can be rotated and/or tilted inside the track. Device 1710 further includes an indication mechanism for indicating rotation and/or tilt of section 112 relative to section 114. In FIGS. 17A and 17B, indication is facilitated by an exemplarily sensing mechanism 118 for detecting relative movement (i.e. rotation and/or tilting) of section 112, and relaying information that is indicative of the movement. In some embodiments, mechanism 118 may further indicate specific rotated and/or tilted positions. For example, mechanism 118 may including an optical sensing mechanism 128 (shown in the figures on an external surface 112a of section 112) similarly to the described for device 120, wherein track 218 of device 1710 may include a pattern (e.g. a pattern 152′ as shown in FIG. 1I) of different features (e.g. features 152a-g in FIG. 1I). The features may be distributed along the curve of rotation and on the curve of tilt, so that both relative repositioning of section 112 may be indicated.

FIGS. 17C and 17D show a twenty ninth embodiment of a finger-worn device of the invention as a rotatable and tillable finger-worn device 1720, in which specific tilt angles of a rotatable section 112 are accommodated and indicated. The specific tilt angles may also correspond to states of the device, so that when section 112 is at a specific tilt angle, the device is in a specific device state. In FIGS. 17C and 17D, device 1720 is shown to include a rotatable section 112 having plugs 212a and 212b, and a stationary section 114 having hacks 218a-e (each shown as two separate slots from two sides of the section). Each of tracks 218a-e can accommodate plug 212a and plug 212b (FIG. 17D shows plugs 212a,b accommodated in track 218c). Accordingly, section 112 can be set to any one of five tilt angles corresponding to each of the five tracks, and can further rotate while at any one of the five tilt angles. The particular accommodation of any of the plugs may be indicated by an indication mechanism similar to sensing mechanisms 118a-e as described for a device 220 in FIG. 2D (each sensing mechanism indicating accommodation in each track). An indication mechanism may additionally indicate rotation when section 112 is set to each of the angles (i.e. tracks), similarly to the described for a passive indication mechanism 116a as described in FIG. 2C.

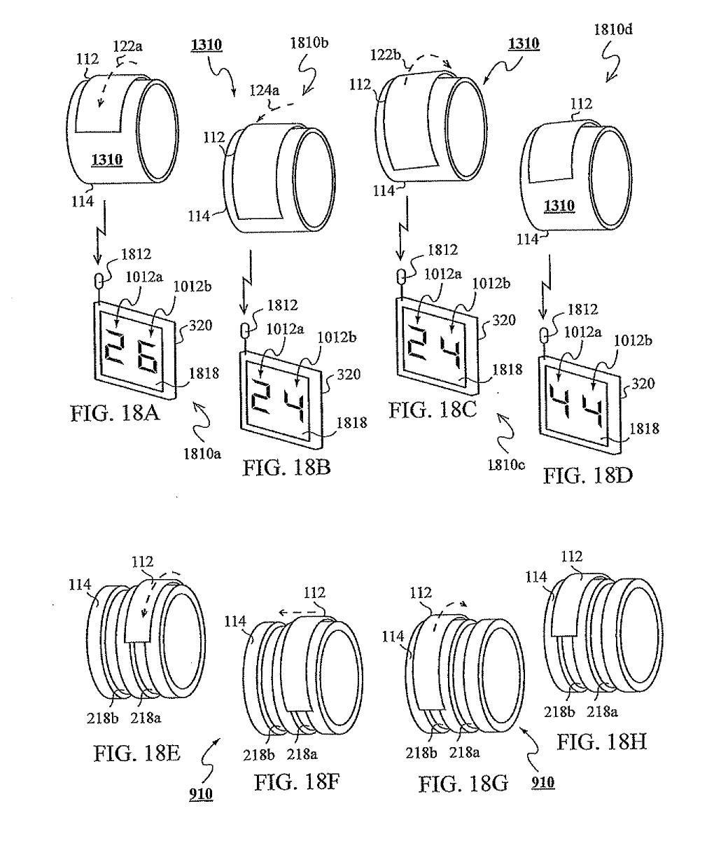

FIGS. 18A through 18D show an embodiment a sequence of operation steps 1810a-d to control an interface 1020 of a separate party 320, exemplarily shown using a finger-worn device of the invention. The operation is illustrated using device 1310 for convenience and as an example only, where it is understood that the same operations may be performed with other devices of the invention (see the description of FIGS. 18E-18H below). In FIGS. 18A through 18D, separate party 320 is shown to include a receiver 1812 and a monitor 1818 on which objects 1012a,b are displayed as two separate digits. Rotation of a section 112 of device 1310 in specific tilted positions is for controlling the display. In some embodiments, each digit may correspond to a selection of an interface element (e.g. a selection 1032 of any of interface elements 1030a-c as shown for an interface 1020 in FIG. 10D), while each element may be a series of digits from 0 to 9. Similarly to the described for controlling an interface 1020 in FIG. 10E, each selection corresponds to one digit selected at any given time from the digits of each element. Accordingly, each selected digit is displayed on monitor 1818. In FIGS. 18A through 18D, controlling the selection of each digit is by rotating section 112 at a different tilted position, so that consequently rotation at each tilted positions changes the digits in objects 1012a,b. This is exemplarily facilitated by indications from device 1310 being detected by receiver 1812.

In FIGS. 18A though 18D, each consecutive figure is the result of the operation performed in the previous figure (i.e. of the previous step in the sequence of operation steps 1810a-d). In FIG. 18A (step 1810a), section 112 is rotated according to rotation direction 122a, on its original un-tilted position, to browse through the digits of a first interface element corresponding to displayed object 1012b. The rotation changes the digit in the display of the element (i.e. the corresponding displayed object) from 6 (in FIG. 18A) to 4 (in FIG. 18B). In FIG. 18B (step 1810b), section 112 is tilted according to direction 124a, to exemplarily set it to a rotation track which corresponds to controlling a second interface element, optionally by corresponding to an indicated state of the device. In FIG. 18C (step 1810e), section 112 is rotated according to direction 122b, to browse through the digits of the second interface element. The tilt plus rotation changes the digit in display of the element (object 1012a) from 2 (in FIG. 18C) to 4 (in FIG. 18D).

FIGS. 18E through 18H show a sequence similar to that described for operation steps 1810a-d, using a device 910 to obtain identical results. FIGS. 18E through 18H respectively correspond to FIGS. 18A through 18D.

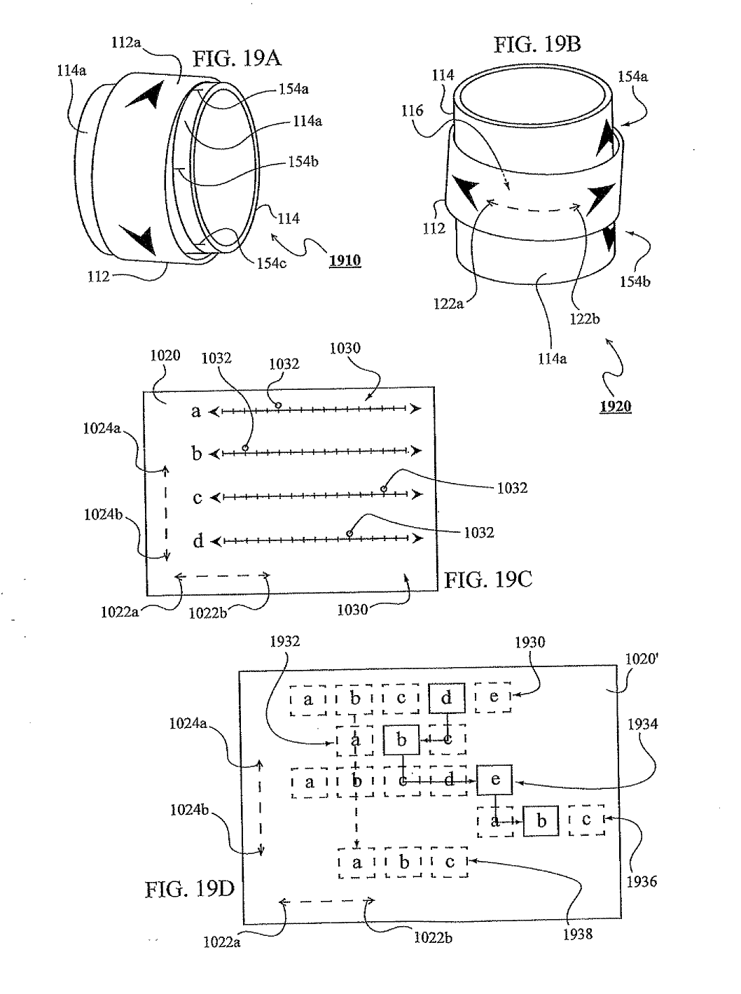

FIG. 19A shows a thirtieth embodiment of a finger-worn device of the invention as a rotatable and tillable finger-worn device 1910 which generally includes a rotatable section 112 and a stationary section 114 having indication locations 154a-c on an external side 114a for indicating specific tilted positions of section 112 by contact with each of the location. Indication locations 154 are part of an exemplary indication mechanism for indicating rotation of section 112 while tilted on each of the locations. In FIG. 19A, section 112 is shown tilted on location 154a. In some embodiments, device 1910 may be able to control an interface 1020 as shown in FIG. 10E. Each of locations 154a-c respectively corresponds to each of interface elements 1030a-e of interface 1020. Tilting section 112 on a specific indication location and rotating section 112 may control a selection (e.g. a section 1032 in FIG. 10E) of the element that corresponds to that location, wherein the two opposite rotation directions 122a,b of section 112 correspond to moving the selection along each element, while the section is tilted on each specific location. In some embodiments, device 1910 may include any number of indication locations to facilitate controlling of interfaces that have any number of elements. For example, device 1910 may control a system having a plurality of separate parties and an interface of controlling each of them, wherein each indication location on external side 114a corresponds to controlling a different separate party. In another example, device 1910 may have one additional indication location (to the indication locations shown on FIG. 19A) to facilitate control of an interface 1020 that is shown in FIG. 19C.

FIG. 19B shows a thirty first embodiment of a finger-worn device of the invention as a device 1920 which generally includes a rotatable section 112 and a stationary section 114 having indication locations 154a,b (shown as arrow-heads in FIG. 19B) on an external side 114a, specifically on either side of section 114. The locations indicate tilt of section 112 on each of them, such as by sensing contact. Device 1920 further includes an indication mechanism 116 (exemplarily located between section 112 and section 114), for indicating rotation. Device 1920 may further include a snap-back mechanism (e.g. a snap-back mechanism 1626, ref. FIG. 16H) between the sections, so that section 112 returns to its un-tilted position (relative to section 114) when any force applied on it is ceased. In some embodiments, device 1920 may control an interface 1020 as shown in FIG. 19C. In FIG. 19C, interface 1020 is similar to the interface described for FIG. 10E, while having more elements (shown interface elements 1030a-d in FIG. 19C). Rotation directions 122a,b of section 112 may correspond to directions 1022a,b of interface 1020. Accordingly, any rotation of section 112 in directions 122a,b is for moving selection 1032 of each of the elements in directions 1022a,b respectively. Additionally, browsing through the elements, such as for selecting which element to control at any given time, corresponds to directions 1024c,d of interface 1020. Accordingly, section 112 may be tilted on location 154a to select the “next” element according to direction 1024a, while the section may be tilted on location 154b to select the “next” element according to the opposite direction (direction 1024b). Optionally, tilting of section 112 is not sustained so that after a tilt has been performed, section 112 “snaps-back” to its un-tilted position, by snap-back mechanism 1626. This simulates a “feeling” of pressing or clicking a button or a switch when tilting section 112.

In accordance with the above, another example of controlling an interface 1020 as described for FIG. 19C is by device 1720 as described for FIGS. 17C and 17D, wherein rotation of section 112 is for controlling a selection 1032 of elements 1030a-d of the interface. Each of tracks 218a-e of device 1720 may respectively correspond to elements 1030a-d of interface 1020, so that when plugs 212a,b are accommodated by a track (i.e. section 112 of device 1720 is set to rotate on that track) rotation corresponds to controlling selection 1032 of the element corresponding to that track. For example, when plugs 212a,b are in track 218a, rotation of section 112 moves selection 1032 of element 1030a. Further tilting of section 112 sets it to different tracks which correspond to different elements of the interface.

FIG. 19D shows a representation of an interface 1020 (shown as 1020′) that is controllable by device 1920 and that has general directions 1022a,b and 1024a,b. In FIG. 19D, interface 1020 has a hierarchy of elements 1930, 1932, 1934 and 1936, which may exemplarily be menus or folders. In some embodiments, rotation of section 112 of device 1920 may be for scrolling through each element, and tilting of the section may be for “opening” and “closing” any element that is controlled by the rotation of section 112 at any given time. Accordingly, rotating section 112 in directions 122a,b may be for scrolling through any element in directions 1022a,b, respectively, while tilting the section on indication location 154a,b may be for switching to the “next” element (i.e. changing the element that is to be controlled by rotation), according to direction 1024a,b, respectively. Specifically shown in FIG. 19D is an exemplary sequence of utilizing device 1920 for scrolling through and between element 1930, 1932, 1934 and 1936 (as exemplary interface elements 1030). First, a user may rotate section 112 to choose a member 1930d from element 1930, wherein member 1930d may represent element 1932 (other members of element 1930 may represent other “sub-elements”). Then, the user may tilt sections 112 on location 154b to switch control to element 1932, and may rotate section 112 in direction 122a to choose a member 1932b of element 1932, wherein member 1932b may represent element 1934. Then, the user may again tilt section 112 on location 154b to switch control to element 1934, and may rotate element 112 in direction 122b to choose a member 1934e which may represent element 1936, the control of which is switched to by further tilting of section 112 on location 154b. Lastly, the user may rotate section 122 in direction 122b to choose a member 1936b. Alternatively to the last step, while control is set element 1936 (i.e. rotation of section 112 is for choosing a member of that element), the user may tilt section 112 on location 154a to switch control back to element 1934. Further tilting of section 112 on location 154a may be for switching to “previous” elements (i.e. setting control to any of the elements that are “next” according to direction 1024a). Each member not chosen in the exemplary sequence may represent a “sub-element” other than elements 1930, 1932, 1934 and 1936 shown in the figure. For example, member 1930b may represent an element 1938, so that when scrolling through element 1930 to select member 1930b (by rotation of section 112) and tilting section 112 on location 154b, control is switched to element 1938, so that further rotation of the section may be for scrolling through the members of that element. Note that the described above for elements 1930, 1932, 1934, 1936 and 1938 also applies to any interface elements.

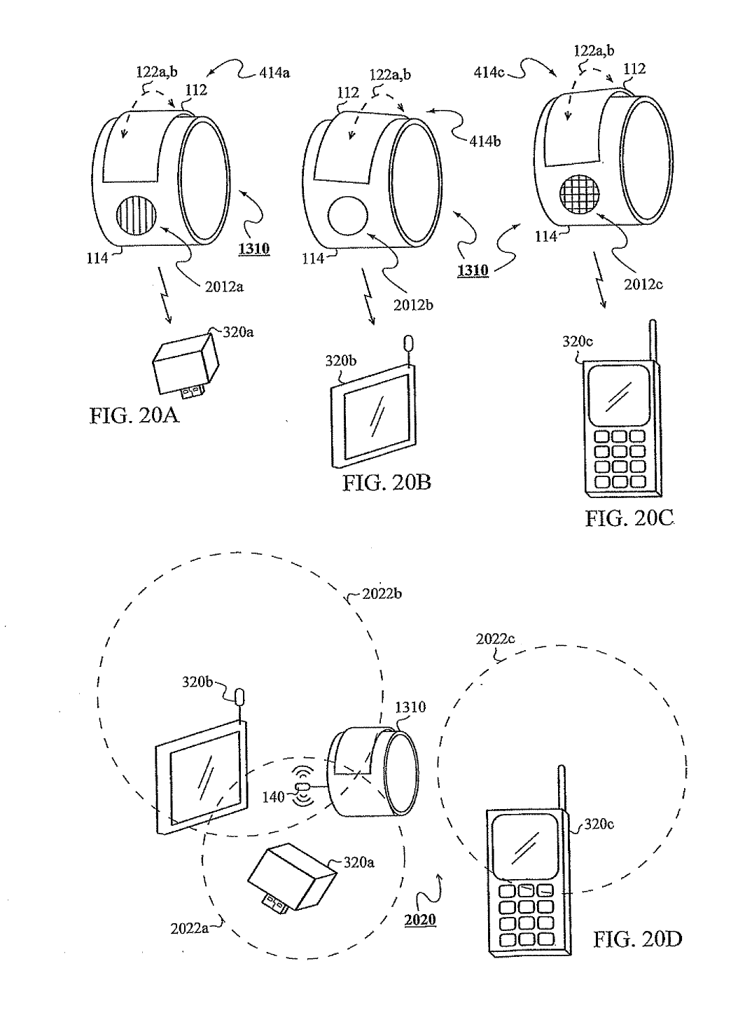

FIG. 20A through 20C show an exemplary utilization of a device of the invention, exemplarily device 1310, to control separate parties 320a-c which are exemplarily different devices which may be part of a network or joint system. In FIG. 20A through 20C, tilted positions 414a-c (position 414a shown as “untilted”) of section 112 of device 1310 is for setting a state of a device for controlling separate parties 320a-c, respectively, wherein each state correspond to each. As shown in FIG. 20A, rotation of section 112 while the section is in position 414a is for controlling party 320a. Similarly, as shown in FIGS. 20B and 20C, rotation of the section when it is in positions 414b and 414e is for controlling parties 320b and 320e, respectively. In some embodiments, rotation of section 102 in directions 122a,b in each tilted position is for controlling an interface of each party.

In some embodiments, a device of the invention, exemplarily device 1310, may further include a visual output mechanism 142, such as an LED, which may display visual feedback 2012a-c corresponding to states of the device, and accordingly and respectively to which of separate parties 320a-e control is set at any given time. For example, a multicolor LED included in device 1310 may change colors correspondingly to tilted position of section 112, such as to green (shown as a circle and vertical lines for feedback 2012a) when section 112 is in position 414a, red (shown as an empty circle for feedback 2012b) when section 112 is in position 414b and blue (shown as a circle and crossed lines for feedback 2012c) when section 112 is in position 414e. The properties of light emitted by the LED may be further modulated correspondingly to rotation of section 112 in each tilted position. In some embodiments, feedback of the states of device 1310 may be visually displayed by the separate parties. In other embodiments, feedback may be outputted in any other form, such as sound.

In some embodiments, similarly to the described for controlling separate parties, different elements of an interface (also “interface elements”) may be controlled, as each tilted position may correspond to a different interface element while rotation may be for controlling that element. Optionally, each element was assigned to a different tilted position of the rotatable section (see method 4510 in FIG. 45).

FIG. 20D shows a system 2020 in which a device of the invention, exemplarily device 1310, may facilitate remote controlling of separate parties 320a-c by auto-connection, depending on the communication range of each party and/or of device 1310. In system 2020, device 1310 may include a communication mechanism 140 (shown as an antenna in the figure) for communicating with each of separate parties 320a-c, when being in their respective communication ranges 2022a-c. In some embodiments, mechanism 140 may be utilized to auto-connect device 1310 to a separate party when entering the party's communication range. The connection may alternatively be established by a communication mechanism of the party. When device 1310 is in a range of a separate party it optionally goes into a “virtual” state, such as a wirelessly connected state, which is not a physical state. When device 1310 is in at least two of communication ranges 2022a-c, such as shown in FIG. 20D being in both ranges 2022a and 2022b, tilting of section 112 may be for switching between control of any of the parties in range (parties 320a and 320b in FIG. 20D).

In some embodiments, entering a communication range of a separate party may be visually indicated by a visual indication mechanism 142 of device 1310 or of the separate party. The visual indication may be temporary and replaced by a default display after a period of time. For example, when entering communication range 2022a, a multicolor LED exemplarily utilized by mechanism 142 blinks a blue light, which may visually represent auto-connection to party 320a, for a period of two seconds, and then may emit a steady green light, exemplarily corresponding to the tilted position of section 112 at that time.

In accordance with the above, visual feedback of communications may be obtained by any device of this invention having a visual output mechanism.

In some embodiments, a communication range as described above may not necessarily be the actual spatial range of signals reception, but a value of a distance variable determined for convenience. For example, a device of the invention may be utilized with systems of a so-called “smart-home”, to control and/or communicate with multiple appliances, wherein it might be desired to limit the auto-connection range of each appliance in small homes.

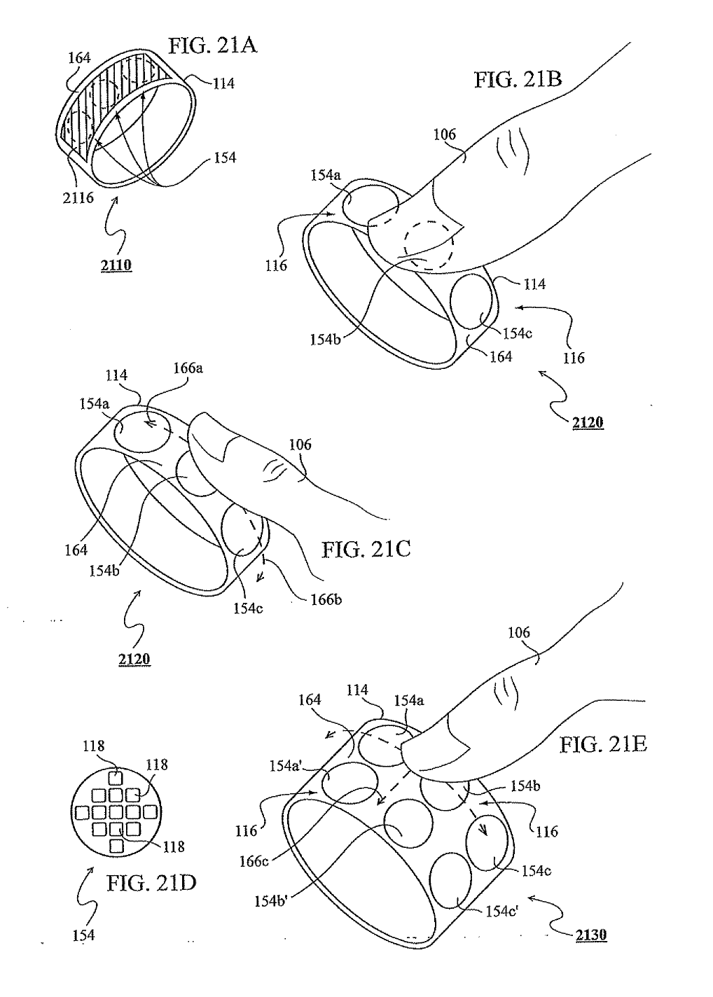

FIG. 21A shows a thirty second embodiment of a finger-worn device of the invention as a device 2110 which includes an stationary section 114 having a touch surface 164 thereon coupled with an indication mechanism for indicating touch and touch motion and pressure on surface 164. In FIG. 21A, surface 164 includes a pressure sensing surface 2116 as an exemplary indication mechanism, which is shown generally located on surface 164, or “beneath” surface 164 inside stationary section 114 (e.g. inside an enclosure). Sensing pressure may be facilitated by any number of pressure sensors or pressure sensing surfaces known in the art (see e.g. U.S. Pat. No. 5,943,044). For device 2110, pressure may be detected corresponding to any number of specific locations (shown three indication locations 154), so that both the amount of pressure and the location at which pressure is applied may be indicated.

Touch surfaces of any of the following embodiments of a device of the invention may indicate touch and/or touch motion (also “sliding” or “dragging”) and/or pressure. Preferably, touch and/or touch motion can be indicated corresponding to specific locations, as specifically described in FIGS. 21B through 21E. In some embodiment, pressure is not indicated, such as by utilizing sensing mechanisms which only sense touch and/or touch motion (see e.g. U.S. Pat. Nos. 4,221,975 and 5,943,044).

FIGS. 21B and 21C show a thirty third embodiment of a finger-worn device of the invention as a device 2120, wherein touch may be indicated according to specific indication locations 154a-c, and wherein touch motion may be indicated according to sliding a finger across the indication locations. In FIGS. 21B and 21C, device 2120 is shown to include stationary section 114, a touch surface 164 and an indication mechanism 116 which includes indication locations 154a-c on surface 164, wherein each location can individually and differently indicate touch of a finger. In some embodiments, moving a finger (i.e. sliding a finger) across indication locations 154a-c (a thumb 106 is shown in FIG. 21C sliding on surface 164, across the locations, in sliding directions 166a,b) in a certain sequence of locations, may provide directional information similarly to the described for obtaining directional information from indication of rotation. In a touch surface, directional information may be obtained by the finger sliding across at least two indication locations. Any touch motion sequence of two or more of location necessarily corresponds to one of directions 166a,b. Directional information may be utilized similarly to indicated information about rotation, as described herein for devices including a rotatable section.

In some embodiments, each of the indication locations may have a plurality of sensing mechanisms 118 for sensing touch. FIG. 21D specifically shows mechanisms 118 for a particular location 154, as an example. Because a finger operating device 2120 may be wider than each indication location (shown in FIG. 21B a thumb 106 wider than each location), obtaining indications from each location individually may be facilitated by a high resolution of mechanisms 118, as shown in the figure. Each indication location 154a-c may be designed to indicate only direct and complete touch of all the sensing mechanisms included in it. For example, partial touch of a thumb on each location (shown in FIG. 21B thumb 106 partially touching location 154a) is not indicated, while complete touch of a thumb on each location (shown in FIG. 21B thumb 106 completely touching and covering location 154b) is indicated. Accordingly, if a finger is completely touching a first indication location, while the touch slightly overlaps a second indication location, touch of the first location is indicated while touch of the second location is not.

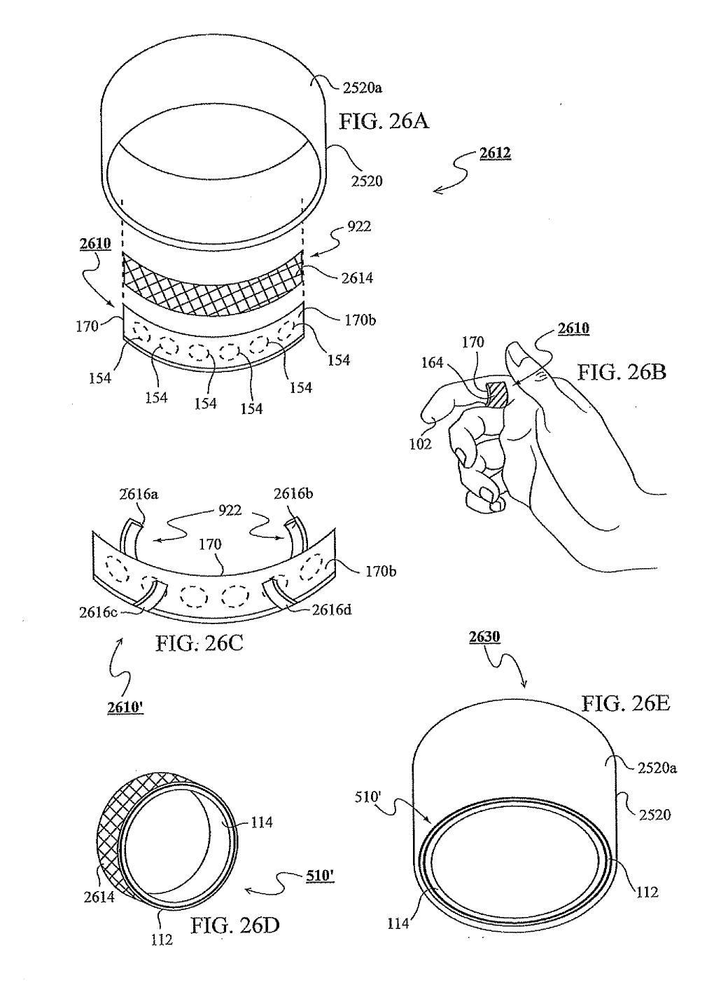

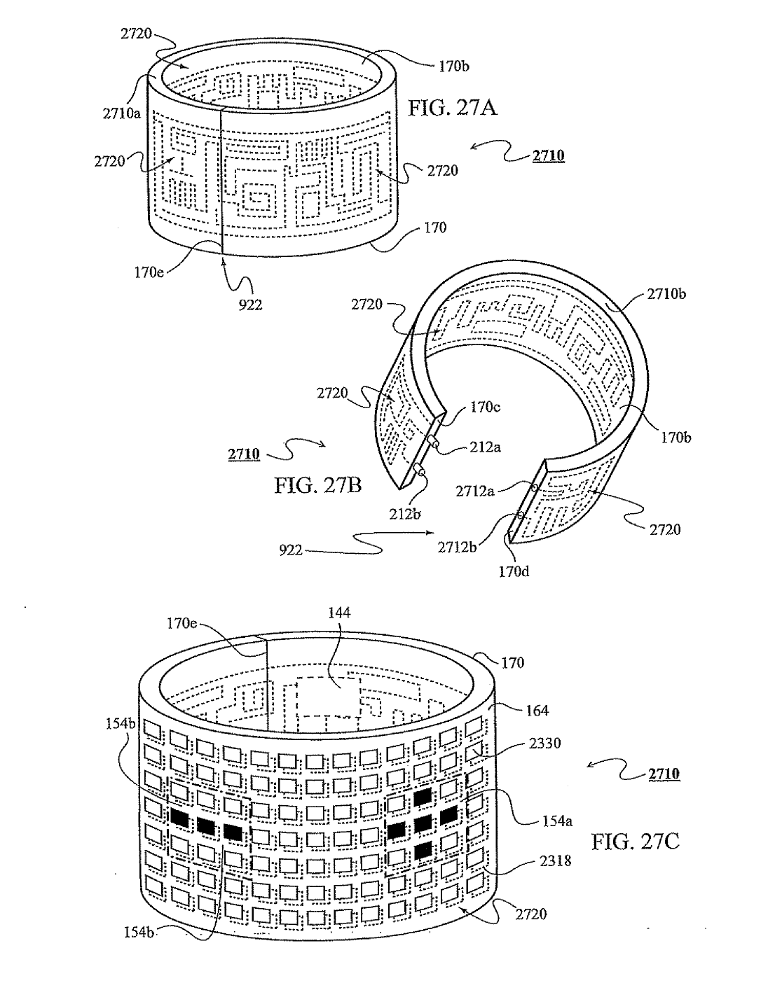

In some embodiments, sensing touch is facilitated by an array of sensing mechanisms 118 throughout touch surface 164, while indication locations may be temporarily set (such as by a processing unit) to include any number and/or arrangement of mechanisms 118. For example, an indication mechanism of device 2120 for indicating touch on surface 164 may includes six sensing mechanisms 118 in a sequence (such as shown for a device 2610 in FIG. 26A), while a processing unit may set a “virtual” state for device 2120, in which every pair of in mechanisms 118 form an indication location (i.e. individually indicating touch), thus the device 2120 consequently has three active indication locations (e.g. location 154a-c). The processing unit may later set a different “virtual” state for the device, in which every three mechanisms 118 form an indication location, thus the device consequently has two active indication locations (at that time).

FIG. 21E shows a thirty fourth embodiment of a finger-worn device of the invention as a device 2130 similar to device 2120 having another set of indication locations. In FIG. 21E, device 2130 is shown to include a stationary section 114 and a touch surface 164 that is approximately and exemplarily twice the width of surface 164 of device 2120. In device 2130, surface 164 has thereon a first set of indication locations 154a-c and a second set of indication locations 154a-c′. Similarly to the described for device 2120, thumb 106 may slide across either or both sets of locations, wherein each of the location may indicate touch when the thumb is touching it. In some embodiments, registration of specific input may correspond to sliding of thumb 106 from one set of locations to another set, such as in sliding direction 166c. Similarly to the described above for an indication location 154 in FIG. 21D, indications may be obtains only for direct and complete touch of each location and not for any partial touch. For example, even if thumb 106 performs a slide across the first set of location, and while doing so it is partially touching locations of the second set, only the sliding across the first set is indicated. In some embodiments, sliding a finger across each set individually may correspond to different input registration, while sliding a finger across both sets may correspond to registration of additional and further different input.

In some embodiments, indications of touch and touch motion which includes directional information may be utilized similarly to indications of rotation. Accordingly, indications from any set of indication locations may be utilized similarly to indications from any rotatable section, so that indications from multiple sets of locations may correspond and indications from multiple rotatable sections may correspond to similar input.

According to the above, a device of the invention may have any number of indication locations that can sense touch and/or pressure, and any number of sets of indication locations, wherein indications of touch and/or pressure may also include, or may also be processed for, directional information.

In alternative embodiments, operations of a device of the invention may be temporarily suspended (e.g. indications may be prevented temporarily from being generated) by deactivation the indication mechanism or the sensing mechanism (any mechanism 116 and 116a and/or mechanism 118) of the device. In one example, when a device of the invention is not operated for a certain period of time, a sensing mechanism of the device enters a “stand-by” mode, wherein only specific further use reactivates the mechanism for further sensing (the mechanism may still sense use but does not indicate it, or the device does not respond to it). In case of a sensing surface, a rapid sliding of a finger back and forth in two directions may “restart” the sensing. The rapid sliding in two directions is distinguishable from incidental touch, such as by an adjacent finger to the finger wearing the device, or by objects accidently touching the surface while it is not desired for the device to be operated. Optionally, the rapid sliding may also be for stopping or pausing the sensing, or for prompting a “stand-by” mode of the sensing mechanism. In another example, a designated switch may activate and deactivate sensing. Any other elements or procedures of use of the device may be utilized for temporarily preventing and allowing operations or reactions of the device, or for deactivating and activating indication mechanisms or sensing mechanisms.

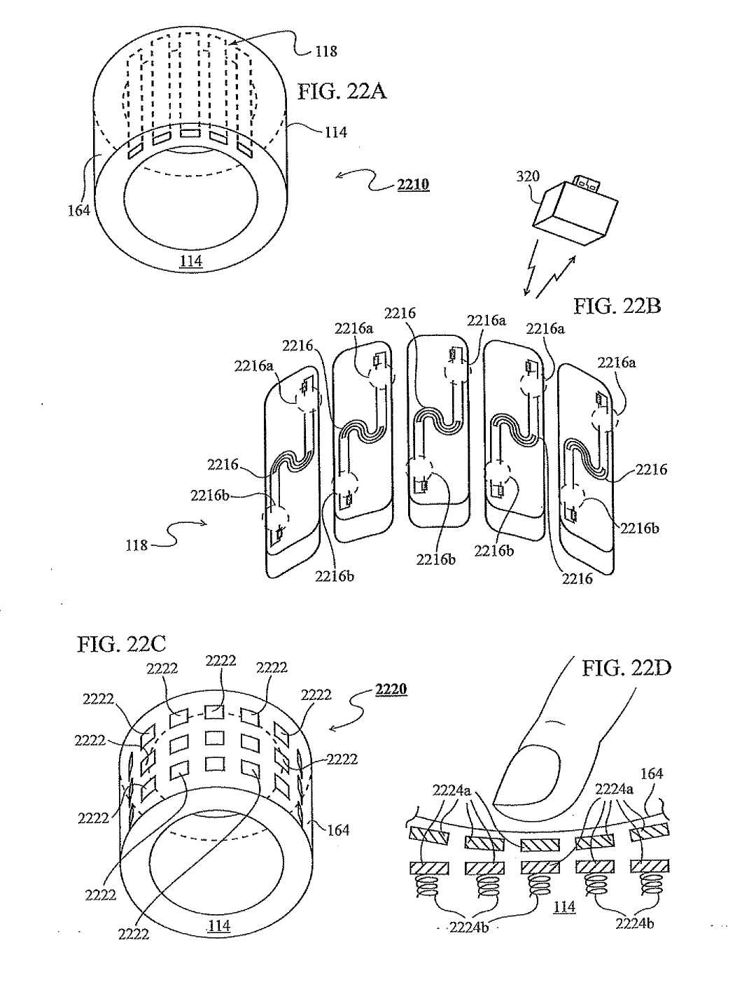

FIG. 22A shows a thirty fifth embodiment of a finger-worn device of the invention as a device 2210 which includes an stationary section 114 and a touch surface 164 and a sensing mechanism 118 included in and utilized by any indication mechanism of device 2210. Mechanism 118 is shown in FIG. 22A as an array of sensing mechanisms distributed inside stationary section 114 and facing surface 164. The array is specifically shown in FIG. 22B, wherein each sensing mechanism has a touch activated circuit 2216 which may be closed at a gap 2216a and a gap 2216b by a finger touching on surface 164, approximately where the gaps are located. Multiple gaps in each circuit may be utilized as for indicating only complete and direct touch corresponding to each circuit, so that for example partial touch of a circuit which closes only one gap is not indicated. Device 2210 may optionally include a power source 2212 and a processing unit 2214, shown inside stationary section 114 in FIG. 22A. In some embodiments, circuits 2216 may be transponder circuits (e.g. RFID circuits) which when closed can modulate incoming signals from a separate party 320, while modulated signals can be detected back at separate party 320 as indications of touch. In such embodiments, mechanism 118 of device 2210 may be included in a passive indication mechanism.

FIG. 22C shows a thirty sixth embodiment of a finger worn device of the invention as a device 2220 which includes an stationary section 114 and a touch surface 164 and a resonance mechanism 2222 (see FIG. 14) as an exemplary passive indication mechanism, for indicating touch and pressure of touch. Similarly to the described for a resonance mechanism 1416 implemented in device 1410 in FIGS. 14A and 14B, circuits 2224 (shown having capacitors 2224a and coils 2224b) may be distributed inside stationary section 114. As specifically shown in FIG. 22D, a finger pressing on surface 164 can influence capacitors 2224a. A resonance detector (shown as separate party 320 in FIGS. 14A-B) may differentiate between each circuit, for locating the finger in addition to measuring the amount of pressure correspondingly to the influence on the capacitors, and accordingly to the resonant frequency of each circuit.

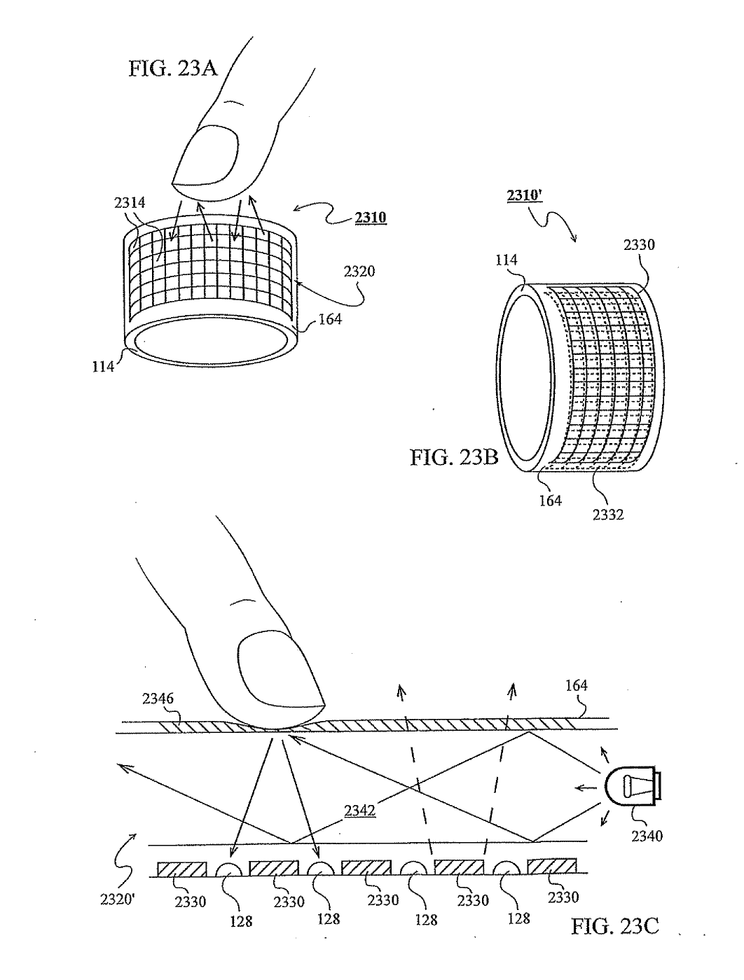

FIG. 23A shows a thirty seventh embodiment of a finger-worn device of the invention as a device 2310 which includes a transparent stationary section 114, a touch surface 164 and a combination of a visual output mechanism and an indication mechanism, both implemented as an interactive display mechanism 2320. In device 2310, touch indication is facilitated by an array of bidirectional LEDs 2314 (also “multi-way LEDs.”) exemplarily distributed inside stationary section 114 facing surface 164. The LEDs are bidirectional or multi-way as known in the art for being a light source and optical sensing mechanisms (see e.g. U.S. Pat. Nos. 5,149,962 and 7,170,606). Accordingly, the LEDs can be utilized for displaying visual output (such as for a visual output mechanism) and for sensing light reflected back at them (such as for an indication mechanism). In FIG. 23A, LEDs 2314 are shown to shine light on a finger almost touching surface 164 or coming in very close proximity to it, while the light is generally reflected back to the LEDs from the finger. The finger may also be touching surface 164 for the same effect.

FIG. 23B shows a thirty eighth embodiment of a finger-worn device of the invention as a device 2310′, in which visual output and touch indication generally correspond to the same touch surface (for an interactive display mechanism) Device 2310′ includes array of display pixels 2330 as an exemplary visual output mechanism, and transparent electrodes 2332 (see e.g. U.S. Pat. Nos. 5,986,391 and 7,071,615) on surface 164 overlapping the pixels, as an indication mechanism. The electrodes are shown in the figure as dashed rectangles. The electrodes facilitate sensing touch without blocking the display.

FIG. 23C shows another embodiment of an interactive display mechanism 2320 (shown as mechanism 2320′) (see e.g. U.S. Pat. No. 4,484,179). In FIG. 23B, there is shown an infrared (IR) LED 2340 as an exemplary light source 132 that emits light inside a waveguide 2342 which may be an exemplary enclosure of a stationary section. Waveguide 2342 has total internal reflection, as known in the art, being for example an acrylic waveguide. In some embodiments, waveguide 2342 is covered by a pressure reactive polymer 2346 that can flex in reaction to different amounts of pressure. The external side of the polymer may be an exemplary touch surface 164. Flexing of the polymer disturbs the internal reflection of light inside waveguide 2342 correspondingly to the amount and location of the pressure applied on it. Additionally shown in the figure are optical sensing mechanisms 128 which may exemplarily be photodiodes arranged in a sensing array. When a finger presses on polymer 2346, as specifically shown in FIG. 23B, the light from LED 2340 reflected inside waveguide 2342 scatters off the finger toward the sensing mechanisms. The sensing mechanisms sense the amount and direction of scattered light to indicate the location of the finger and the pressure applied by it. In alternative embodiments, an optic sensing mechanism is located on the other end of the waveguide, to detect changes in light passing through the waveguide due to disturbances to reflection caused by pressure to the polymer. Shown in FIG. 23B, additionally to the above, are display pixels 2330 as an exemplary visual output mechanism, for displaying a visual output on the surface of the polymer or through it.

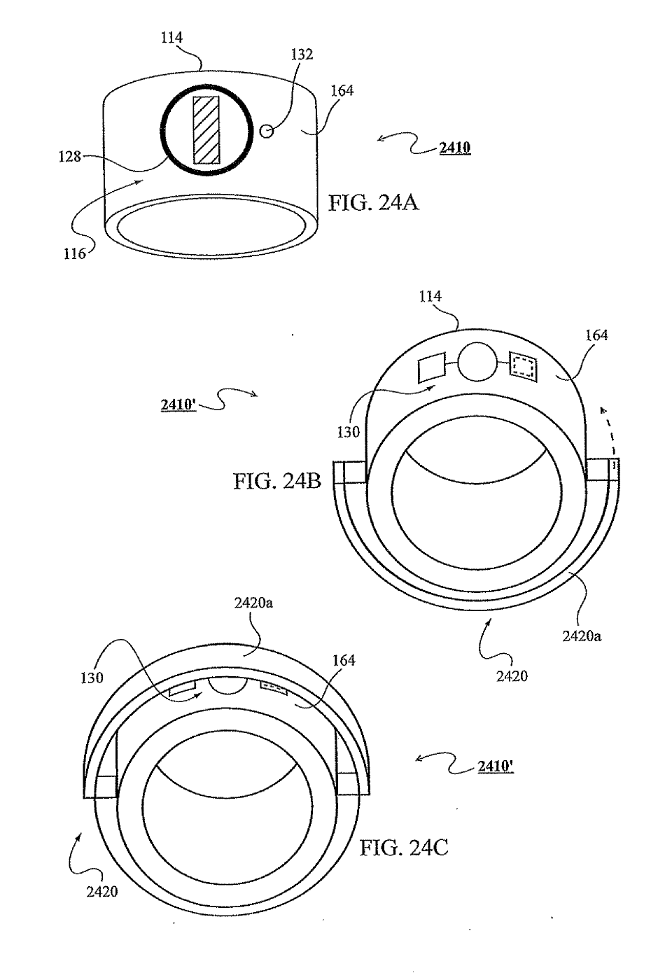

FIG. 24A shows a thirty ninth embodiment of a finger-worn device of the invention as a device 2410 which generally includes a stationary section 114 and a touch surface 164 having an optical sensing mechanism 128 included in an indication mechanism 116. Sensing of touch motion is facilitated by sensing the change in the area of a finger overlapping location 154 during sliding of the finger across surface 164. This sensing is similar to that described for device 110c in FIG. 1E. In Device 2410, mechanism 128 is sensing a finger operating the device (i.e. touching surface 164) while in device 110c, mechanism 128 is sensing a finger wearing device 110c. Surface 164 is shown in FIG. 24A to further include a light source 132 for illuminating the surface of the finger touching surface 164 of the device.

In other embodiments, an indication mechanism of device 2410 may include any number of optical sensing mechanisms for sensing touch and/or touch motion on surface 164.

FIGS. 24B and 24C show a fortieth embodiment of a finger-worn device of the invention as a device 2410′ similar to device 2410, wherein indicating touch and touch motion is facilitates by a recognition mechanism 130. Similarly to that described for devices 110b, 110d and 110e in FIGS. 1C, 1F and 1G, respectively, mechanism 130 can sense patterns and/or features in the surface of a finger, and may be adapted to sense a finger operating device 2410′, as opposed to sensing fingers wearing devices 110b, 110d and 110e. As referred to in the description of FIG. 1C, fingerprint sensing mechanisms known in the art can obtain information of motion and direction of a finger from a specific single location, such as an narrow opening on which the finger is moving for complete sensing.

In FIGS. 24B and 24C, device 2410′ is shown generally including a cover mechanism 2420 for preventing access to touch surface 164. In FIGS. 24B and 24C, cover mechanism 2420 is shown for device 2410′ yet can be implemented for any device of the invention. For device 2410′, mechanism 2420 exemplarily includes a rotatable cover 2420a for physically covering mechanism 130. Cover 2420a can block touch on surface 164 and make surface 164 accessible for touch. In alternative embodiments, this “temporary” covering of a touch surface of a device of the invention may be facilitated by any number of mechanisms known in the art, such as by an electronic lid that can be switched on and off. A cover mechanism such as 2420 may also be utilized to prevent access to any element of the device, such as to cover a rotatable section 112.

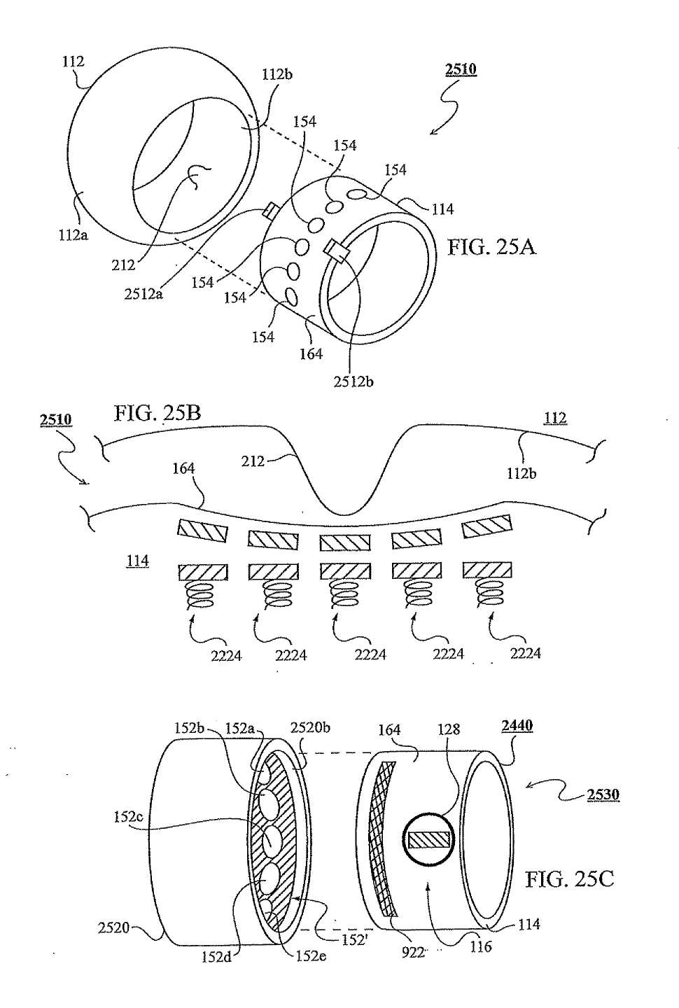

FIGS. 25A and 25B show a forty first embodiment of a finger-worn device of the invention as a device 2510 in which a touch surface and an indication mechanism is utilized for indicating touch and touch motions, as well as for indicating rotation and rotated positions of a rotatable section. In FIG. 25A, device 2510 is shown to include a stationary section 114 and a touch surface 164 having a series of indication locations 154. Specifically shown in FIG. 25B, is a resonance mechanism of device 2510 similar to a resonance mechanism 2222 as described for device 2220 in FIG. 22C, facilitates indication of pressure, wherein exemplarily each location 154 includes a coil-and-capacitor resonant circuit 2224. The pressure may be applied by a finger. Device 2510 further includes a rotatable section 112 which can be mounted on surface 164, and connected to section 114 by, for example, a connection mechanism 922 (exemplarily shown as clips 2512a,b on the sides of stationary section 114). The connection mechanism may be located on the stationary section or on the rotatable section. In some embodiments, section 112 may have a plug 212 protruding from an internal side 112b. When section 112 is mounted on surface 164, as specifically shown in FIG. 25B, the plug may influence the indication locations (shown are circuits 1420, each included in an indication location 154), similarly pressure from touch influencing the locations. Because the indication locations are distributed as a series on the curve of section 114, when section 112 is rotated on surface 164, the rotation may be indicated the same as sliding a finger along the surface. Specific rotated positions of section 112 may similarly be indicated when the section is not rotating. Accordingly, device 2510 may be operated by touch, when section 112 is disconnected from the device, and by rotation of a rotatable section, when section 112 is mounted on the touch surface.

FIG. 25C shows a forty second embodiment of a finger-worn device of the invention as a device 2530 having a ring 2520 which can be mounted on a touch surface 164 of a device 2440 (similar to device 2410 in FIG. 24). Ring 2520 is exemplarily shown in FIG. 25C having a visual pattern 152′ as described for device 120 (see FIG. 1I) on an internal side 2520b, so that the pattern may be detected by an optical sensing mechanism 128 on surface 164, to indicate rotated positions of the ring. The pattern is shown having features 152a-e, wherein each feature, when detected, is visually indicative of a specific location on the pattern which corresponds to a specific rotated position of the ring. The ring may be any ring to which a pattern may be attached, wherein the pattern may have any number of distinct visual features at any number of locations. Accordingly, ring 2520 may be mounted on surface 164 of device 2410 and rotated, wherein rotation of the ring corresponds to touch motion on the surface, while specific rotated positions of the ring may be indicated as states of device 2530. Also shown in the figure is a connection mechanism 922 for facilitating attachment of ring 2520 to device 2440.

Following the above, any ring may act as a rotatable section 112 in a device 2510 by attaching a plug 212 to the internal side of the ring. If the ring fits on the device, specifically on a touch surface 164, it may be rotated to obtain indications similar to indications from touch of the surface.

FIG. 26A and FIG. 26B show a forty third embodiment of a finger-worn device of the invention as a device 2610 which includes a flexible enclosure 170 having a touch surface 164 (opposite to a back side 170b shown in FIG. 26A) and a connection mechanism 922 for being attached to a separate party, such as a ring 2520 (FIG. 26A) and a finger (FIG. 26B). Together with the ring, device 2610 (shown ready to connect to external side 2520a of ring 2520) is forming a device 2612. Enclosure 170 is shown in the figures being a slim band. Alternatively, the enclosure may be of any shape which has a surface, for being operated by touch. In FIG. 26A, mechanism 922 is shown including an adhesive 2614 for being located on back side 170b. The adhesive can be any attachment mechanism known in the art, preferably for facilitating attachment to human skin (see e.g. U.S. Pat. Nos. 6,572,636, 4,890,608, 5,462,743, 5,846,559, 5,350,581 and 4,856,504). Indication of touch on surface 164 is facilitated by a plurality of indication locations 154, each can exemplarily sense touch and/or pressure. When the device is attached to a finger or a ring, surface 164 is exposed for being operated while the device is attached. Locations 154 may include passive sensors, such as RFID touch sensors, indicating touch to a separate party which initiates communication.

FIG. 26C shows a forty fourth embodiment of a finger-worn device of the invention as a device 2610′ similar to device 2610, in which connection mechanism 922 is implemented as clips 2616a-d, so that enclosure 170 can mechanically be attached to a finger, a ring, a separate party or another finger-worn device.

FIG. 26D shows a forty fifth embodiment of a finger-worn device of the invention as a device 510′ similar to device 510 as described for FIGS. 5A through 5C, which has an adhesive 2614 covering the external side of rotatable section 112, as an exemplary connection mechanism. In FIG. 26E, device 510′ is shown attached to the inside of an exemplary ring 2520, forming a device 2630. Attachment is exemplarily facilitated by adhesive 2614 taping section 112 directly to the inside of the ring. Accordingly, rotatable section 112 of the device is shown to be specifically attached to the ring. Stationary section 114 contacts a finger when the ring and the attached device are worn on the finger. When the ring is being rotated relative to the finger, section 112 rotates together with the ring and relative to section 114, while section 114 remains stationary by its contact to the finger.

Following the above, a ring may be attached to any rotatable section of a device of the invention, which may further be tiltable in accordance with rotatable and tiltable devices of the invention as described herein. Accordingly, a ring attached to a rotatable section in a tiltable and rotatable device may be tilted for operating the device (e.g. for generating indications of tilt).

FIGS. 27A, 27B and 27C show a forty sixth embodiment of a finger-worn device of the invention as a device 2710 having either a ring shape 2710a (FIGS. 27A and 27C) or a strip shape 2710b (FIG. 27B). The device is shown having an enclosure 170 and a connection mechanism 922. Connection mechanism 922 is shown to include plugs 212a and 212b on an end 170c of enclosure 170, and sockets 2712a and 2712b on another end 170d of enclosure 170. Plug 212a can connect to socket 2712a, while plug 212b can connect to socket 2712b. Accordingly, end 170c can contact end 170d to form a seam 170e. In FIGS. 27A, 27B and 27C, the device is shown to further include circuitry 2720 inside enclosure 170. Circuitry 2720 may serve as both an exemplary indication mechanism and as an exemplary visual output mechanism (i.e. circuitry 2720 being an interactive display mechanism) for indicating touch and for displaying visual output on surface 164 (shown in FIG. 27C opposite to seam 170e when the device is in a ring shape). The circuitry may utilize any electronic sensing components and/or mechanisms that can sense touch through enclosure 170 (e.g. through a material of which the enclosure is made). The circuitry may further have electroluminescent areas, or light emitting components such as specific types of diodes or capacitors, while enclosure 170 may be transparent, so that light can be emitted through the enclosure.

FIG. 27C specifically shows device 2710 with circuitry 2720 having an array of display pixels 2330 (shown as evenly distributed rectangles in the figure) as an exemplary visual output mechanism, and an array of sensing pixels 2318 (shown as dashed rectangles in the figure) as an exemplary indication mechanism. The combination of pixels 2318 and pixels 2330 form an exemplary interactive display mechanism, similarly to the described for mechanism 2320 in FIGS. 23A-C. The display pixels may be electronic light emitting components as part of the circuitry, while the sensing pixels may be electronic sensors, also as part of the circuitry. Also shown in FIG. 27C is a processing unit 144 which may be a microprocessor or microcontroller or an arrangement of electronic transistors, as part of the circuitry. Display pixels 2330 form a + symbol and a − symbol, respectively “inside” indication locations 154a and 154b (shown as dash-dot rectangles surrounding an array of pixels 2718 and pixels 2330). The indication location may be temporarily formed corresponding to the displayed symbols. In one example, touch indication locations 154a may be touched for increasing audio volume, while touch indication location 154b may be touched for decreasing audio volume. The volume may be of a separate party, for example of a media playing device communicating with device 2710 and receiving indications of touch from circuitry 2720. In another example, sliding a finger on surface 164 from location 154a to location 154b (from the plus symbol to the minus symbol) may induce scrolling down an interface, while sliding a finger in an opposite direction (from the minus symbol to the plus symbol) may induce scrolling up an interface. The display of the symbols, as well as the formation of the indication locations, may change correspondingly to other operations of the device.

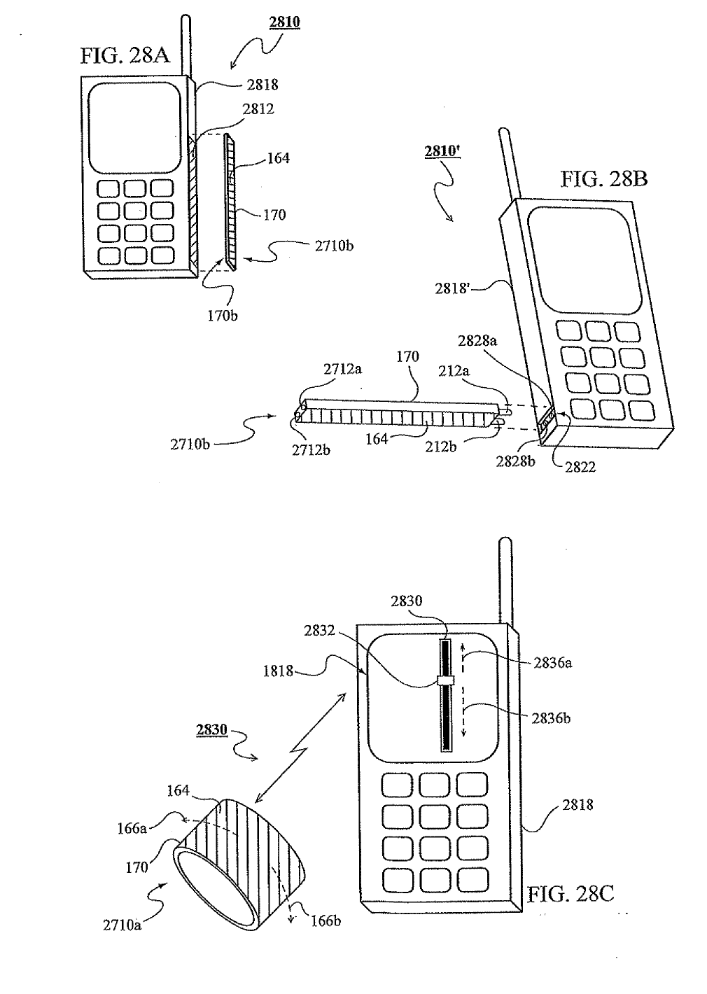

FIG. 28A shows an embodiment of a system 2810 in which a device 2710 (in a strip shape 2710b) similar to the described for FIGS. 27A through 27C, is physically connected to a device 2818 (shown as a mobile phone). Device 2818 has a connection unit 2812 which facilitates connection to device 2710. In some embodiments, device 2710 may be connected to device 2818 by attaching inner surface 142b of enclosure 170 to unit 2812 when device 2710 is in strip shape 2710b, so that touch surface 164 is exposed (i.e. facing outwards from the connection). In some embodiments, while device 2710 is connected to device 2818, device 2710 may still be operated by touch and touch motion on surface 164. Information and/or electricity may be transferred from one device to another through the connection unit if the connection includes electrical leads. For example, device 2710 may be connected to device 2818 for recharging a power source of device 2710.

FIG. 28B shows another embodiment of a system 2810′ wherein device 2710 (also shown in a strip shape 2710b) is connected to a device 2818′ having sockets 2828a,b similar to sockets 2712a,b, into which plugs 212a,b of device 2710b can be inserted. Also shown in the figure is a compartment 2822 (inside which are sockets 2828a,b). In some embodiments, device 2710 may be inserted into compartment 2822, such as for being stored inside device 2818′.

FIG. 28C shows another embodiment of a system 2830 in which a device 2710 (being in a ring shape 2710a) communicates remotely with a device 2818. Device 2818 has a scrolling bar 2830 and a scrolling handle 2832 (as an exemplary element and selection, respectively) shown in the figure exemplarily displayed a monitor 1818 (see monitor 1818 of a separate party 320 in FIGS. 18A-D). The operation of controlling handle 2832 may be executed by sliding a finger on surface 164 of device 2710 in sliding directions 166a,b, which correspond to scrolling directions 2836a,b, as shown in FIG. 28C. Similar control of bar 2830 may be performed by sliding a finger on surface 164 of device 2710 when the device is in strip shape 2710b, such as connected to device 2818.

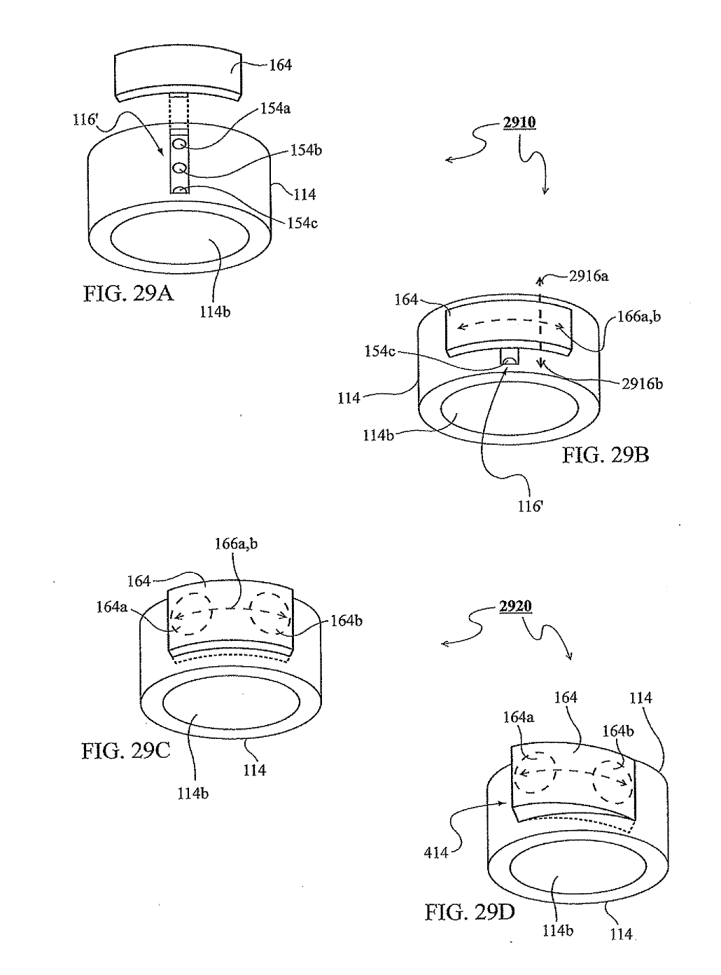

FIGS. 29A and 29B show a forty seventh embodiment of a finger-wom device of the invention as a device 2910 in which a touch surface may be repositioned for different states of the device. In FIGS. 29A and 29B, device 2910 is shown to generally include a stationary section 114 and a touch surface 164 coupled to an indication mechanism for indicating touch on the surface. Surface 164 may be set to any indication location 154a-c and may be repositioned to any other indication location 154a-c. Surface 164 may be physically accommodated by each location. Each location may indicate a device state as part of a second indication mechanism (shown as mechanism 116′ in the figure). Touch and touch motion may be indicated when surface 164 is set to any location, wherein the indication of touch and touch motion may also correspond to indication of a device state. In some embodiments, repositioning may be in repositioning directions 2916a,b, which are generally perpendicular to sliding directions 166a,b (the latter indicating touch motion).

FIGS. 29C and 29D show a forty eighth embodiment of a finger-worn device of the invention as a device 2920 similar to device 2910, in which repositioning of surface 164 may be performed by tilting the surface. In device 2920, surface 164 can be pressed (i.e. tilted) into stationary section 114 on each one of sides 164a,b of surface 164. For example, as specifically shown in FIG. 29D, surface 164 may be tilted on side 164b into stationary section 114 in a tilted position 414, exemplarily as a result of a finger pressing on side 164b. Specific tilted positions or angles may be physically accommodated by a locking mechanism and may correspond to indication of different device states. Touch and touch motion may be indicated for each of the positions. In some embodiments, device 2920 may further include a snap-back mechanism such as mechanism 1626 (FIG. 16), which allows surface 164 to snap-back to its un-tilted position when released from pressure.

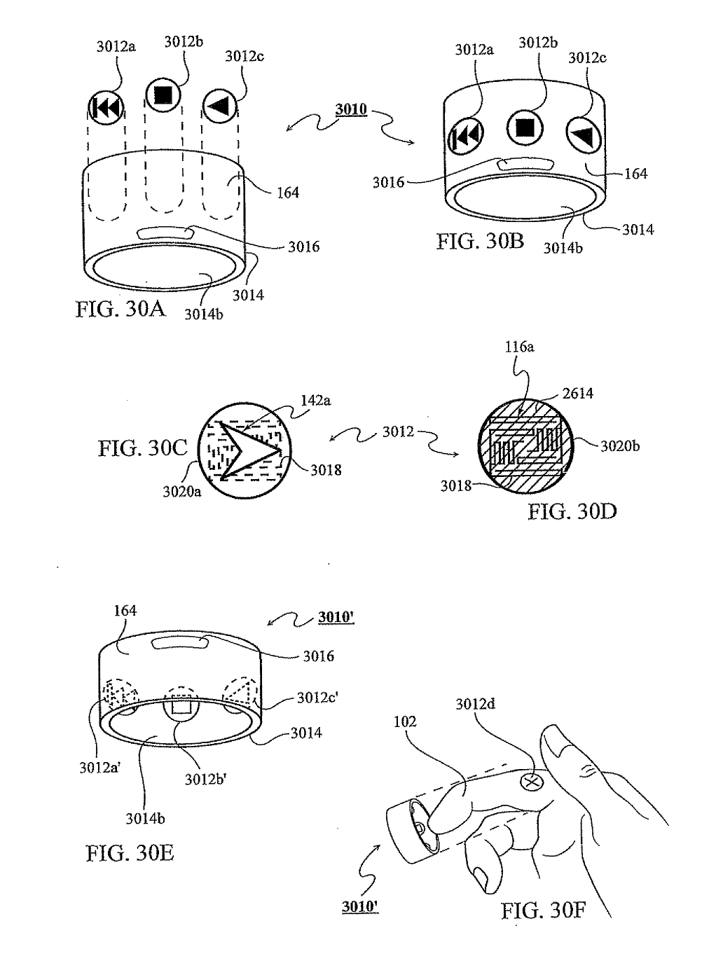

FIGS. 30A and 30B show a forty ninth embodiment of a finger-worn device of the invention as a device 3010 which includes an enclosure 3014, a touch surface 164 and patches 3012a-c, wherein each of the patches may be an indication location as described herein for indicating touch and/or pressure at specific locations. Accordingly, directional information may be obtained from an indicated touching sequence (i.e. touching any combination and/or order of patches). The patches can be attached to surface 164 (FIG. 30B) and detached from surface 164 (FIG. 30A) and can communicate with a transceiver 3016 (as an exemplary communication mechanism) located on enclosure 3014, specifically for indicating touch and/or pressure to other elements of the device. In some embodiments, indication is facilitated by the patches passively indicating touch and/or pressure by modulating signals initiated by the transceiver. The transceiver can generate a continuous stream of interrogating signals which are modulated by each patch that is touched, or on which pressure is applied, and returned to the transceiver for detecting the modulations as touch and/or pressure indications.

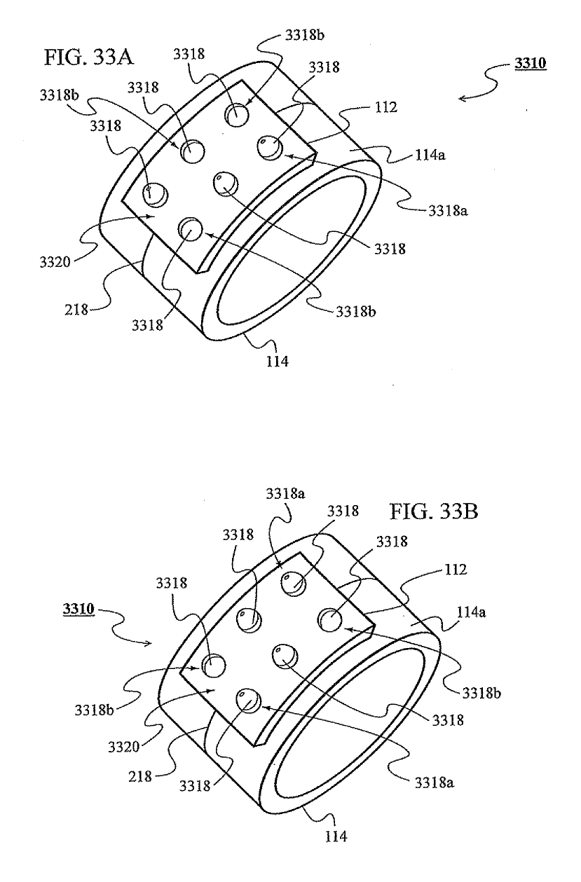

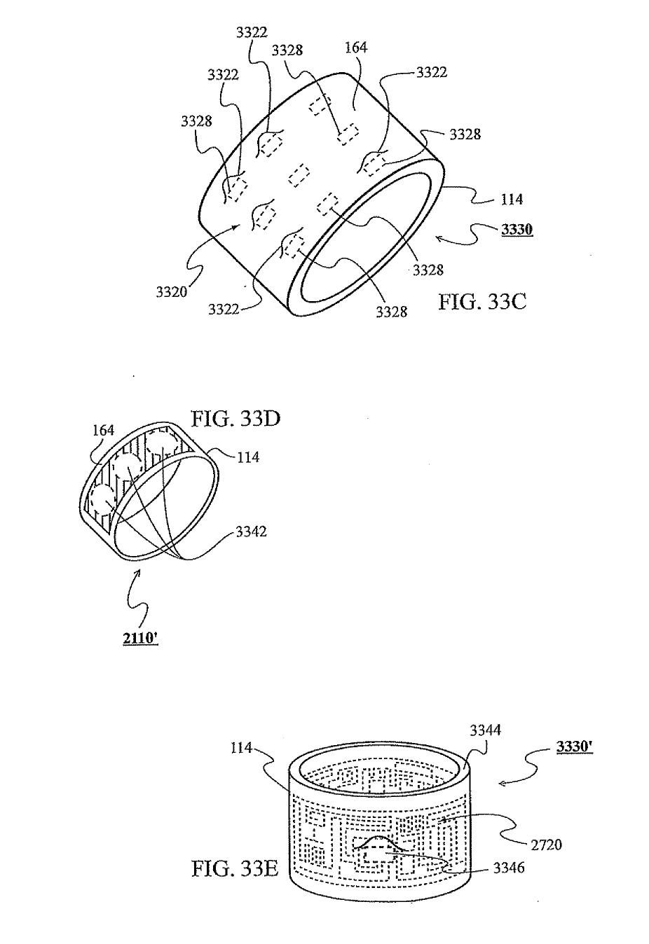

FIGS. 30C and 30D show an exemplary patch 3012 having a passive indication mechanism 116a which can indicate touch and/or pressure on a front side 3020a (FIG. 30C) of patch 3012 by passive sensing. Passive sensing may be facilitated by any number of mechanisms known in the art (see e.g. U.S. Pat. No. 6,622,567). Touch is indicated when front side 3020a is touched. In some embodiments, as shown in the figures, mechanism 116a may include a circuitry 3018 which facilitates sensing and indicating touch, such as by including self-powering switches (see self-powering switches 3342 in FIG. 33D). In FIG. 30D there is shown a back side 3020b of patch 3012 where exemplarily circuitry 3018 is, and also an adhesive 2614 facilitating attachment to surfaces (as an exemplary connection mechanism). Further shown in FIG. 30C is a passive visual output mechanism 142a (shown exemplarily displaying an arrow-head symbol) on front side 3020a. Passively outputting visuals may be facilitated by any number of mechanisms known in the art which require energy only to change a display, and which does not require energy to sustain a display. For example, mechanism 142a may be a bi-stable visual configuration (e.g. a pixels array) known in the art to facilitate maintaining an image without energy (see e.g. U.S. Pat. Nos. 6,201,633, 6,034,807 and 6,404,339). For another example, mechanism 142a may be an electronic-ink remotely controlled display (see e.g. U.S. Pat. No. 6,753,830). Energy required to change the display (such as to alter the state of the materials in the display) may be obtained by circuit 3018 converting incoming signals to electricity. Alternatively, front side 3020a of patch 3012 may be any printed image (e.g. a graphic symbol) which may visually represent an operation corresponding to indications of touch on the patch, such as an operation executed according to input registered from such indications. The combination of mechanism 142a and the sensing features of circuit 3018 may facilitate an interactive display mechanism (see FIGS. 23A-C and FIG. 27C).

FIGS. 30E and 30F show a fiftieth embodiment of a finger-worn device of the invention as a device 3010′ similar to device 3010, in which patches 3012a-c′ are attached on an internal side 3014b of enclosure 3014, which can be rotated (such as being an exemplary rotatable section 112). In device 3010′, each of patches 3012a-c′ can indicate contact with another patch, specifically with a patch 3012d which is shown in FIG. 30F to exemplarily be attached on an index finger 102. Device 3010′ can be worn on finger 102 specifically “on” patch 3012d so that when the device is rotated on the finger, each of patches 3012a-c′ contact patch 3012d. Accordingly, similarly to the described for touch indication from patches 3012a-c, rotation of device 3010′ is indicated by sequential contact of each of patches 3012a-c′ with patch 3012d. In some embodiments, patches 3012a-d′ may be able to indicate touch in addition to indicating contact with another patch, and may be detached from and attached to any surface, other than the described herein.

Following the above, any mechanism for indicating touch and/or touch motion and/or pressure on a touch surface 164 may be implemented on an internal side of a section of a finger-worn device, as opposed to the described for an external side (surface 164), and to indicate influences from an element attached to a curve of a finger (such as shown in FIG. 30F patch 3012d attached to finger 102). For example, referring to a device 2510 as shown in FIGS. 25A and 25B, plug 212, which is shown to be located on internal side 112b of rotatable section 112 may be attached (e.g. by an adhesive) to a finger facing outwards. Additionally, surface 164 of stationary section 114 of device 2510 which can indicate pressure, may be implemented on internal side 112b of section 112 (circuits 1420 may be included in section 112 facing side 112b so that indication location 154 are generally located on side 112b). Accordingly, section 112 can be mounted on a finger, specifically on plug 212 attached to the finger, so that the plug influences internal side 112b as opposed to surface 164. In such embodiments, similarly to the described for device 2510, rotation and rotated positions of section 112 may be indicated when the section is directly worn on a finger. For another example, a pattern 152′, as described for a device 2530 in FIG. 25C for being attached to a ring 2520, may be attached around a curve of a finger (facing outwards), while an optical sensing mechanism 128 as described for device 2440 (in the same figure) may be located on the internal side of section 114 (facing inwards), thus by wearing section 114 “on” the pattern and rotating the section, as opposed to rotating the ring, can facilitate sensing rotation.

According to the above, any number of patches may be utilized as indication locations for device 3010. The patches may be attached and/or operated in any order (e.g. sequence or array), position and location. In some embodiments, a touch surface 164 may include a connection unit (such as a connection unit 2812 as described for device 2818 in FIG. 28A) for facilitating physical attachment of patches on the surface. In some embodiments, physical attachment with a connection unit may facilitate obtaining indication from the patches without the need to transceiver 3016.

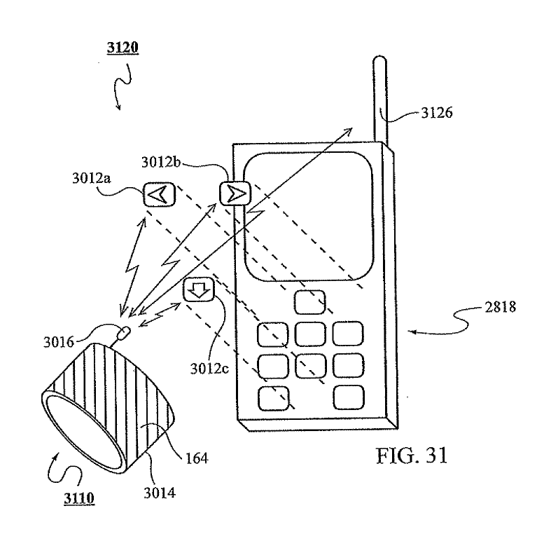

FIG. 31 shows a fifty first embodiment of a finger-worn device of the invention as a device 3110 similar to device 3010, which includes an enclosure 3014, a touch surface 164 and a transceiver 3016. The device is similar to that in system 2830 (FIG. 28C), while transceiver 3016 can communicate with a device 2818 (shown as a mobile phone) having a transceiver 3126 and patches 3012a-c (shown detached from party 3120). The patches may be detached from separate party 3120 and attached to device 3110, specifically to surface 164. In some embodiments, transceiver 3016 of device 3110 may be able communicate with the patches to obtain touch indications. Additionally, transceiver 3016 may be able to communicate with device 2818, specifically with transceiver 3126, for relaying information of touch indications. In such cases, device 3110 acts as a mediator of communication between the patches and device 2818 to facilitate operating the patches (i.e. touching the patches for prompting an operation in device 2818) on surface 164. In one example, device 3110 augments the communication by enhancing modulated response signals from the patches, in case device 2818 is too far for them to directly send signals to it.

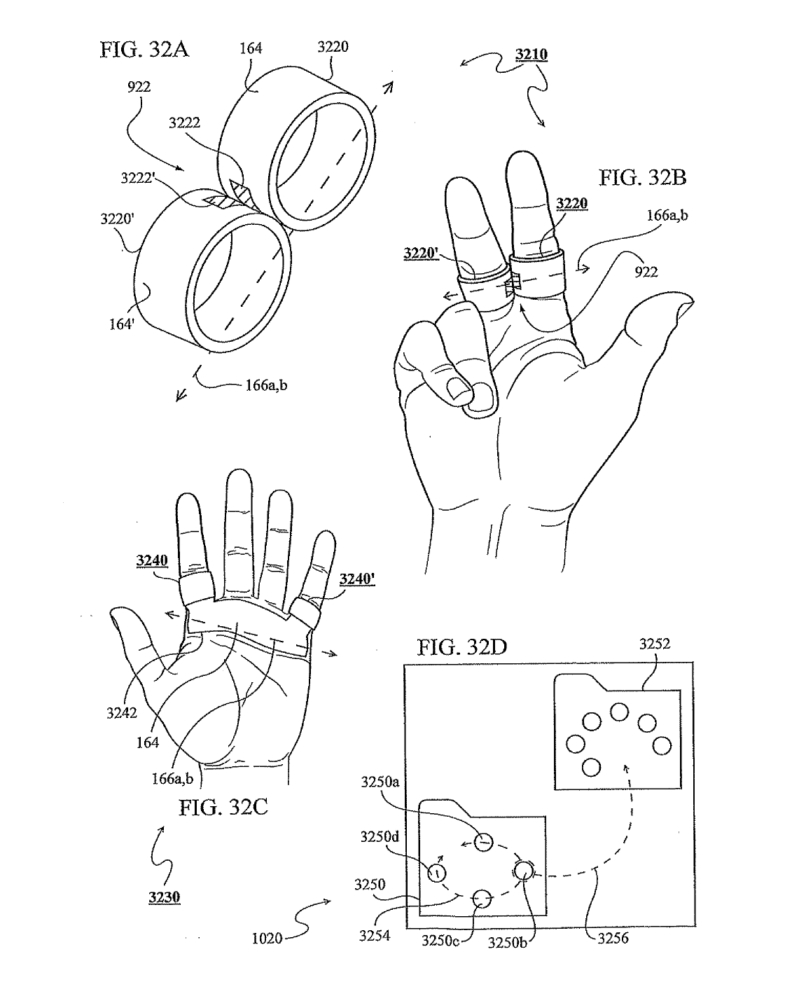

FIGS. 32A and 32B show an embodiment of a system 3210 in which multiple finger-worn devices of the invention are connected temporarily (i.e. they can be disconnected and operated separately) “side-by-side”. In FIGS. 32A and 32B, system 3210 is shown to exemplarily include a device 3220, a device 3220′ and a connection mechanism 922 including a connection unit 3222 of device 3220 and a connection unit 3222′ of device 3220′. Contact of the connection units may be indicated by an indication mechanism, such as by having sensing mechanisms in each of the units, or such as by each unit including electrodes for closing a joint circuit. Connection may be indicated corresponding to a state of each device, different from an “unconnected” state. As specifically shown in FIG. 32B, devices 3220 and 3220′ may be “pressed together” for contact of unit 3222 with unit 3222′, e.g. by pressing together two adjacent fingers wearing the devices. Information and/or electricity may be transmitted from one device to another by mechanism 922. In some embodiments, when connected, the devices may operate collaboratively, or may be operated simultaneously, such as by sliding a finger across bath touch surfaces 164 and 164′ of the devices in sliding directions 166a,b.

In some embodiments, a connection unit 3222 may be utilized to respectively connect a device of the invention to a separate party. For example, a unit 3222 may be an exposed surface (such as shown in FIGS. 32A and 32B) located on a finger-worn device facing the same direction as the open palm of a hand. The hand may be placed on a surface so that the exposed surface of the connection unit faces a separate party, such as an ATM or a “public information terminal”, to exemplarily download information (e.g. electronic credit) from the separate party to the device. In another example, contact of a connection unit of a finger-worn device with a unit of a separate party may for recharging a power source (such as source 148 in FIG. 1G).

FIG. 32C shows an embodiment of a system 3230 in which any number of finger-worn devices (two such devices 3240 and 3240′ shown here) are connected to an extension section 3242 that has a touch surface 164 coupled with an indication mechanism for indicating touch and/or touch motion and/or pressure. In some embodiments, extension 3242 may be a sheet which may extend the touch surface of any device, so that touch and/or touch motion and/or pressure may be performed on a larger surface which may have more indication locations or more widely spread indication locations. As shown in FIG. 32C, a finger may slide on touch surface 164 of extension section 3242 in sliding directions 166a,b. In some embodiments, the sliding of a finger on the touch surface of the extension may be for collaborative operations of the devices connected to the extension (e.g. devices 3240 and 3240′ in FIG. 32C). Note that an extension section of the invention may extend on any other operable element, such as an extension section for connecting to a rotatable section, to expend the external side of the rotatable section, or such as an extension section for connecting to two rotatable sections, for conveniently rotating both sections simultaneously.

FIG. 32D shows an interface 1020, which may be controlled by multiple connected devices of the invention operating collaboratively. In some embodiments, a system 3210, as described for FIGS. 32A and 32B, may facilitate controlling members in folders 3250 and 3252 which are exemplary interface elements. When devices 3220 and 3220′ are not connected, they may be operated for browsing inside folders 3250 and 3252, respectively. Specifically, sliding a finger on surface 164 of device 3220 may browse between exemplary members 3250a-d in browsing directions 3254 (e.g. sliding a finger on surface 164 in direction 166a may be for browsing in one direction while sliding in direction 166b for browsing in an opposite direction) while sliding a finger on surface 164′ of device 3220′ may browse between any number of exemplary members of folder 3252. When one of members 3250a-d (e.g. member 3250b in FIG. 32D) is selected by browsing, the selected member may be copied to folder 3252 in a copying direction 3256 by connecting devices 3220 and 3220′ as described above, and sliding a finger from surface 164 to surface 164′. Similarly, when devices 3220 and 3220′ are connected, a selected member from folder 3252 may be copied from folder 3252 to folder 3250 (in an opposite copying direction), by sliding a finger from surface 164′ to surface 164.

In some embodiments, system 3210 may be utilized to control an interface 1020 as described in FIG. 10B. Similarly to the described for multiple rotatable sections that can be rotated individually and simultaneously for different operations, sliding a finger on the touch surface of one of devices 3220 and 3220′ may control selection 1032 of element 1030a, while sliding a finger on the touch surface of the other device may control selection 1032 of element 1030b. Additionally, connecting devices 3220 and 3220′ and sliding a finger across both surfaces may control selection 1032 of element 1030c. Note that the described above for folders 3250 and 3252 also applies to any interface elements.

FIGS. 33A and 33B show a fifty second embodiment of a finger-worn device of the invention as a device 3310 having a tactile output mechanism 3320 for outputting tangible information. “Tangible” information may be feedback from operations of the device, or information received by the device from incoming signals. In FIGS. 33A and 33B, device 3310 is shown to generally include a stationary section 114, a rotatable section 112 and a rotation track 218 on an external side 114a, coupled with an indication mechanism for indicating rotation of section 112 on track 218. Mechanism 3320 includes a plurality of tangible indicators 3318 located on a surface 112a of section 112. In some embodiments, each of the indicators may have any number of possible states, such as states 3318a and 3318b. These states are respectively embodied by a “popped-out” (i.e. protruding) pin (state 3318a) and a retracted pin (state 3318b). Combinations of different states of indicators in an array may form distinct tangible information. For example, Braille characters may be formed on surface 112a by mechanism 3320, for outputting meaningful messages in Braille language. FIG. 33A specifically shows indicators 3318 forming a first combination of states, while FIG. 33B specifically shows indicators 3318 forming a second combination of states. In some embodiments, a user may receive a tangible output during rotation of section 112, for receiving tangible output while operating the device.

FIG. 33C show a fifty third embodiment of a finger-worn device of the invention as a device 3330 having a stationary section 114, a touch surface 164 and a tactile output mechanism 3320 inside the enclosure and affecting the enclosure. In FIG. 33C, mechanism 3320 is shown to utilize tactile pixels 3328 as exemplary tangible indicators, which can influence the enclosure to exemplarily form bumps 3322. Affecting the enclosure may be facilitated by any number of mechanisms known in the art, such as electromechanical (e.g. piezoelectric, see e.g. U.S. Pat. Nos. 5,440,194 and 5,982,304) actuators. In some embodiments, tactile output mechanism 3320 may be adapted to indicate touch, specifically pressure, in addition to generating tactile output, by implementing any number of mechanisms known in the art (see e.g. U.S. Pat. No. 6,060,811). For example, mechanism 116 may utilize piezoelectric transducers that may convert pressure to electric signals (for indication of pressure) and which may be activated by electrical signals to press on enclosure 170 from inside.

Following the above, pressure applied on a touch surface of a device of the invention may be converted to energy, similarly to the described for a power generating mechanism 616 implemented in device 610 shown in FIGS. 6A and 6B, as a mechanism which can convert pressure to electricity. Accordingly, a device 2110′, similar to device 2110 (see FIG. 21A), is shown in FIG. 33D having an exemplary power generating mechanism implemented as self-powering switches 3342 (see e.g. U.S. Pat. No. 6,700,310) on a touch surface 164, wherein each switch may be an indication location of a passive indication mechanism of device 2110′.

In some embodiments, as shown in FIG. 33E, which shows the fifty fourth embodiment of a finger-worn device as a device 3330′, the device may have an electroactive polymer 3344 (see e.g. U.S. Pat. No. 5,977,685) as an exemplary tactile output mechanism and as an enclosure of section 114, wherein reactions of the polymer may be facilitated by a circuitry 2720, similarly to the described in FIGS. 27A-C. Similarly to the described in FIG. 27C for display pixels and sensing pixels as electric components of the circuitry, the circuitry may include electrodes (shown an electrode 3346 in the figure) which can induce a reaction in the enclosing polymer, as known in the art (see e.g. U.S. Pat. Nos. 6,583,533 and 6,376,971).

In some embodiments, a tactile output mechanism 3320 may influence an internal side of a section a device of the invention that comes in contact with the finger wearing the device, such as an internal side 114b of a stationary section 114. This facilitates feeling the tangible information (i.e. tactile output) by a finger wearing a device, as opposed to feeling it by a finger operating the device.

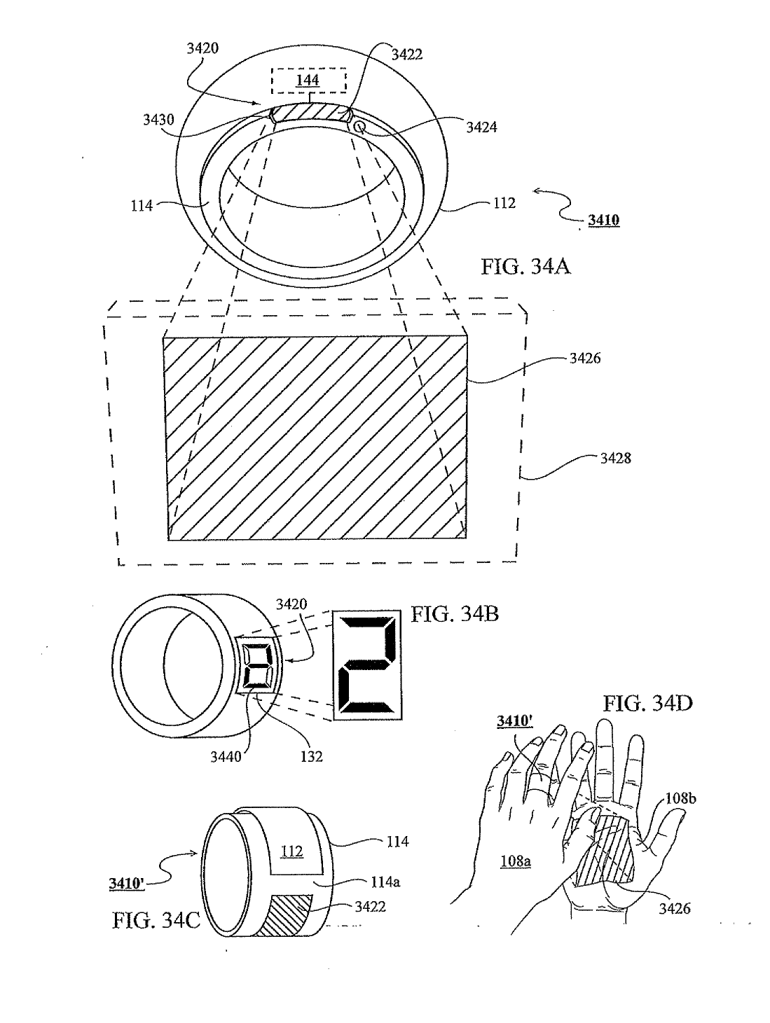

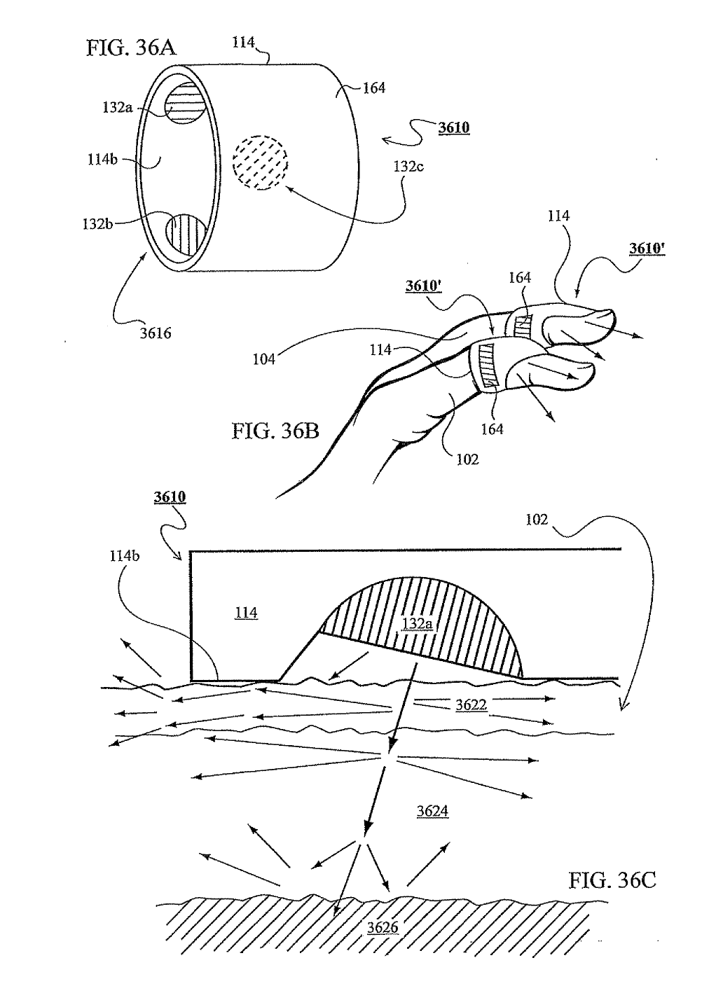

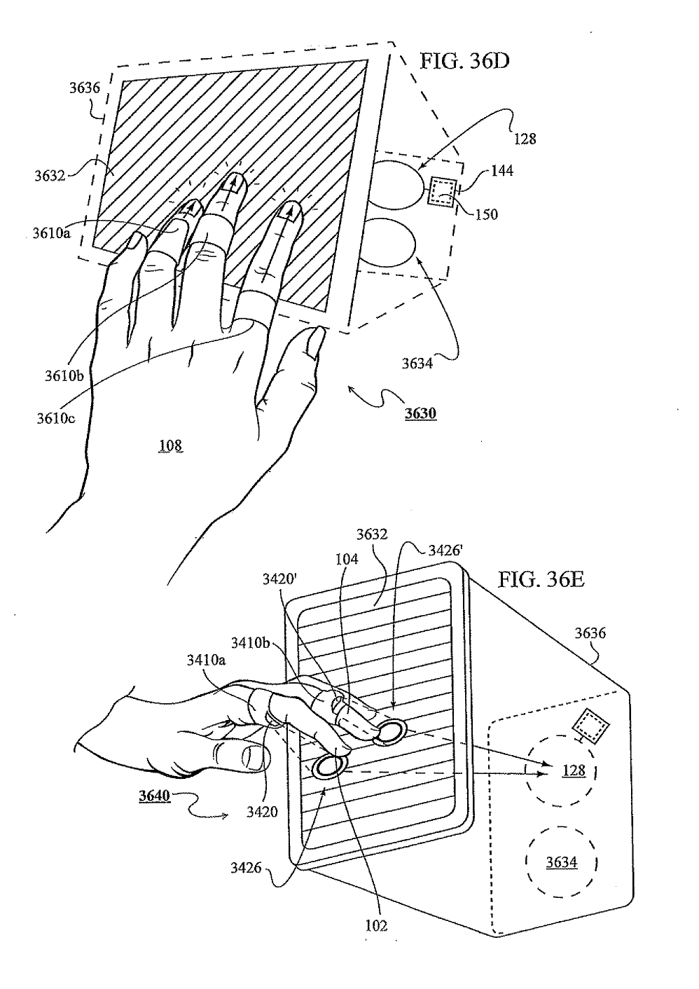

FIG. 34A shows a fifty fourth embodiment of a finger-worn device of the invention as a device 3410 which includes a projection mechanism 3420 which can act as an indication mechanism for indicating use and/or states to a separate party (see system 3640 in FIG. 36E) In FIG. 34A, device 3410 is shown to further include a rotatable section 112 installed on a stationary section 114, and an indication mechanism.

In device 3410, mechanism 3420 is shown to utilize a projector 3422, a detection mechanism 3424 and a projection adjusting mechanism 3430. Projector 3422 may be a type of so-called handheld projector or “pico-projector” as known in the art (see e.g. US Patent Application 2003/0038927) to be implemented in portable devices. Alternatively, the projector may be any element which can project visual output on a surface, such as an array of small LEDs and a lens which focuses the emitted light. The output may be simple imagery, such as digits formed by a small LCD 3440, through which light may be projected from a single light source 132, as shown in FIG. 34B. In FIG. 34A, projector 3422 is shown to project a visual output 3426 on a surface 3428. Detection mechanism 3424 can detect properties of a surface (e.g. surface 3428) on which visual output (e.g. output 3426) is being projected, such as distance from projector 3422 and/or angle relative to the projector. Alternatively or additionally, detection mechanism 3424 can detect properties of the projected visual output. Projection adjusting mechanism 3430 can adjust visual output 3426 during projection, such as by modulating the angle of projector 3422 and/or the focal length. By utilizing detection mechanism 3424 and projection adjusting mechanism 3430, projection mechanism 3420 can auto-calibrate the projection operation in real-time. This may be facilitated by any number of mechanisms or means known in the art (see e.g. U.S. Pat. No. 5,742,698). In some embodiments, mechanism 3424 is utilizing a processing unit 144 for auto-calibrating, such as by processing detections from mechanism 3424 and correspondingly controlling mechanism 3430.

FIG. 34C shows a fifty fifth embodiment of a finger-worn device as a device 3410′, generally similar to device 3410, in which a projection mechanism 3420 is generally located on an external side 114a of a stationary section 144. A projector of mechanism 3420 preferably faces the same direction as the front of a palm on a finger of which the device is worn. In some embodiments, projecting mechanism 3420 is designed to facilitate projecting visual output on a hand, specifically on a hand of a user wearing device 3410 on a finger of the other hand. In FIG. 34D there is shown device 34W worn on a hand 108a while a visual output 3426 is projected on a hand 108b, specifically on the front of the palm of thereof. This facilitates displaying visual output that is larger than the device (i.e. cannot be displayed on the device) and where there is no available surface on which to project the output. Displaying visual output on a hand is preferably intended for simple visual output and not for prolonged viewing. For example, a map may be projected on a hand when a user wishes to glance at it.

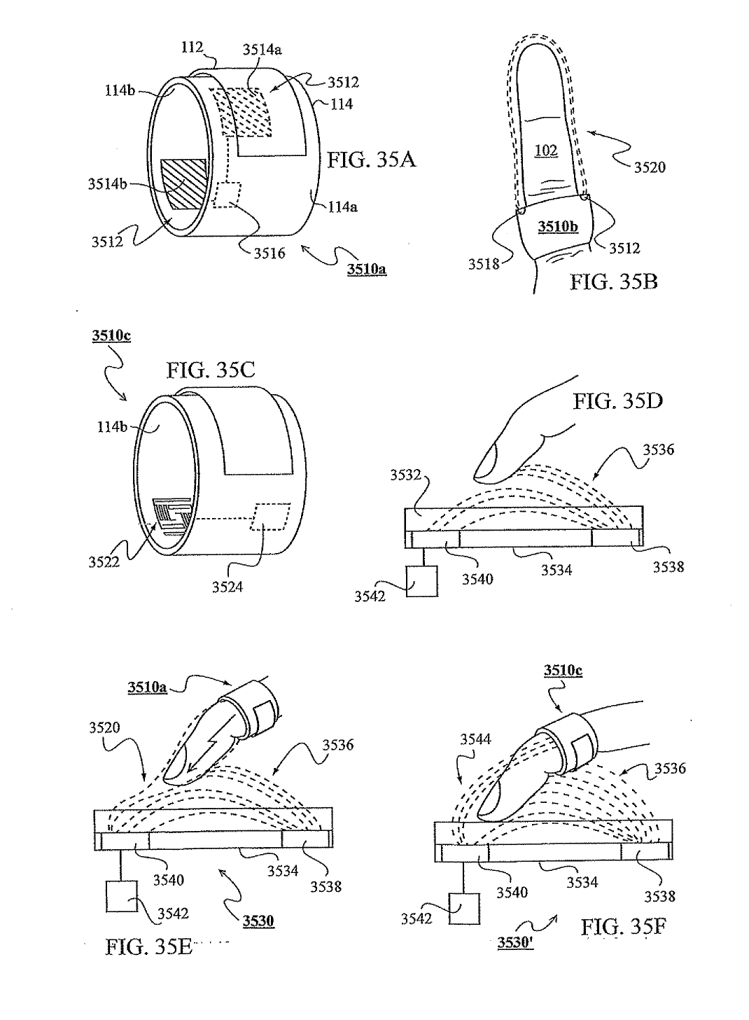

FIG. 35A shows a fifty fifth embodiment of a finger-worn device of the invention as a device 3510a having a transmitter 3512. Transmitter 3512 may be any transmitter known in the art to utilize the human body as a transmission medium (or conductor) or capacitive area (see e.g. U.S. Pat. Nos. 5,796,827, 6,211,799, 6,864,780, 6,771,161 and 6,754,472). Accordingly, transmitter 3512 may be an exemplary communication mechanism of any device of the invention. As known in the art, specifically in the field of near-field communication (NFC) and personal area networks (PAN), the transmitter may generate very low currents or change the capacitive body field. Preferably, the transmitter generates an electric field coupled to the body of a user wearing device 3510a, specifically generating the field “on” the finger wearing the device, or generating the field so that it is “carried” to the tip of the finger wearing the device, as known in the art. For device 3510a, transmitter 3512 includes electrodes 3514a,b (see e.g. U.S. Pat. Nos. 4,653,503 and 4,067,342) on an internal side 114a of a stationary section 114, for coupling the field to the body, and a field modulator 3516 which can modulate the field generated by the transmitter, for communicating information through modulation. The modulator may be a processing unit which can process indications of use and/or states of the device and correspondingly modulate generated fields. In FIG. 35A, device 3510a is shown to further include a rotatable section 112, a stationary section 114, wherein rotation of section 112 may be indicated by an indication mechanism. Alternatively, device 3510a may include and be operated by any other elements.

FIG. 35B shows a fifty seventh embodiment of a finger-worn device of the invention as a device 3510b, generally similar to device 3510 but also having a transmitter 3512 and a receiver 3518, and exemplarily worn on an index finger. Electric field 3520 is shown generated “on” or “through” the finger by transmitter 3512 and received by receiver 3518. Similarly to the following description for a system 3530, receiver 3518 of device 3510b may facilitate receiving information from a separate party by field modulations and influences

FIG. 35C shows a fifty eight embodiment of a finger-worn device of the invention as a device 3510c, generally similar to device 3510, but also having an antenna 3522 connected to a transponder mechanism 3524. The antenna is located on the internal side of section 114 for contact with the finger.

FIGS. 35D through 35F show the utilization of a finger-worn device, as in FIGS. 35A through 35C, to communicate with a detection apparatus 3534 in a system 3530. In FIGS. 35D and 35E there is shown a finger in proximity to a touch surface 3532. Alternatively, the finger may be touching the touch surface. Surface 3532 is a touch surface of apparatus 3534 which is an exemplary embodiment of touch and/or proximity and/or position detecting apparatus, as known in the art to utilize electric fields (see e.g. U.S. Pat. Nos. 5,861,875, 4,071,691, 6,998,856 and 6,025,726). In apparatus 3534, an electric field 3536 is generated by a transmitter 3538 to a receiver 3540. The field is measured by the receiver, such as by being converted to digital information, and processed at a processing unit 3542. In some embodiments, when a finger approaches surface 3532, as specifically shown in FIG. 35D, the field is disturbed as some of the field lines are shunted to ground and do not reach the receiver. Accordingly, the total capacitance measured at the receiver decreases. By measuring and processing changes in capacitance, touch and/or proximity can be sensed. As specifically shown in FIG. 35E (for system 3530), device 3510a may be worn on the finger approaching surface 3532. The device may be operated to generate an electric field (e.g. field 3520) that is carried by the body, thus reaching the tip of the finger and consequently to the receiver of apparatus 3534. The electric field from device 3510a is generated by transmitter 3512 of the device, while by modulating the field with modulator 3516 information may be transmitted to the receiver of the apparatus, which is already designed to measure electric fields. Processing unit 3542 may be adapted, such as reprogrammed, to register specific measurements of the receiver as input, in addition to registering measurements of touch influence, which has a certain threshold, as known in the art. Note that alternatively to the described for transmitter 3512 generating an electric field, the transmitter may generate transmissions or signals which may be transmitted or “carried” through or on the finger wearing device 3510a.

FIG. 35F shows an embodiment of system 3530′ in which a device 3510c can be utilized as an input-device. Similarly to the described for system 3530, transmitter 3538 is generating an electric field (shown field 3536 in the figure). In FIG. 35F, device 3510c is shown worn on a finger while the finger exemplarily touches surface 3532 of apparatus 3534. Field 3536 generated by transmitter 3538 reaches antenna 3522, such as by the device specifically being in the “near-field” region of the field, or by the field being “carried” through or on the finger wearing device 3510c. Transponder mechanism 3524 is consequently powered-up for transmitting transmissions 3544 to receiver 3540 of apparatus 3534. Alternatively, transponder mechanism 3524 may modulate disturbances (also “influence”) to field 3538, in addition to the disturbance of the finger, thus facilitating communicating information to the apparatus. Transmitting transmissions to receiver 3540 and/or influencing field 3536 by mechanism 3524 may utilize the physiological electric properties of the finger to maximize the effectiveness of such operations.

In some embodiments, similarly to the described for system 3530′ and device 3510c, a passive indication mechanism (e.g. passive indication mechanism 116a as shown in FIG. 3C) may be implemented in any finger-worn device of the invention as a transponder mechanism 3524, to passively indicate use and/or states of the device

Note that any apparatus which utilizes electric properties sensing, specifically capacitance sensing, for obtaining touch input and/or fingers positions, may be influenced by a finger-worn device of the invention as described for devices 3510a-c. Further note that the described herein for electric fields may similarly refer to electromagnetic signals or transmissions.

FIG. 36A shows a fifty ninth embodiment of a finger-worn device of the invention as a device 3610 which includes an illumination mechanism 3616 which facilitates generally illuminating a finger wearing the device, preferably by scattering and diffusion of light through epidermal, dermal and sub-dermal layers of the skin of the finger. The mechanism preferably facilitates illumination by light sources directed at the finger, such as light sources facing the skin of the finger. In FIG. 36A, device 3610 is shown to further include, exemplarily, a stationary section 114 and a touch surface 164 coupled with an indication mechanism. In device 3610, mechanism 3616 exemplarily includes light sources 132a-c on an internal side 114b of stationary section 114, the light sources generally facing the skin of a finger when the device is worn. In some embodiments, device 3610 may be worn on the intermediate phalanx (middle) section of a finger, for optimal transmittance of light to the tip of the finger (i.e. the distal phalanx). Sources 132a-c may exemplarily be high intensity, super-luminous diodes or laser diodes, similar to diodes used for Low Intensity Laser Therapy (LILT), which are known in the art to facilitate light passing through dermal and sub-dermal layers. The light sources may emit any kind of light, the properties of which may be modulated by mechanism 3616, such as for changes in wavelengths, intensities or detectable and measurable blinking rates. Light generated by mechanism 3616 and emitted from the tip of a finger wearing device 3610, or from any section of the skin surface of the finger, may be modulated for optical communications, specifically for relaying information of operations of the device, such as indications of use and/or states, to be detected by any optical sensing mechanism. Diffuse glow from the finger may facilitate easy detection of visual output, such as of different colors. Additionally, detecting the location and/or tracking the motion of the finger in low lighting conditions may also be facilitated. In some embodiments, mechanism 3616 may illuminate a finger with non-visible wavelengths, such as IR light.

FIG. 36B shows a sixtieth embodiment of a finger-worn device of the invention as a device 3610′. Two such devices are worn on fingers of a hand, wherein a first device is worn on index finger 102, while a second device is worn on middle finger 104. Light from the devices is generally emitted towards the tip of each finger, while the specific shape of stationary section 114 of each device is designed to minimally obscure light scattering out of the distal phalanx section, and to maximize light propagation through the skin. Optionally, the stationary section may extend to the distal phalanx section, to facilitate light scattering out of the tip. Touch surface 164 of each of the devices is shown in FIG. 36B as generally being a rectangular area on the side the stationary section, to facilitate sliding of a thumb in two opposite directions.

FIG. 36C shows a cross section of device 3610 worn on finger 102, wherein light from source 132a is generally propagating through the layers of skin in the general direction of the tip (towards the left in the figure). In FIG. 36C, finger 102 is shown having an epidermis layer 3622, a dermis layer 3624 and a subcutis layer 3626. Most of the scattered light is propagated through layers 3622 and 3624. A small amount is scattered from layer 3626 and the rest is absorbed. In some embodiments, internal side 114b of stationary section 114 is generally a highly reflective surface, for reflecting most of the light scattered back to towards the device, to increase the effectiveness of illumination.

FIG. 36D shows an embodiment of a system 3630 in which devices 3610a-c (as a plurality of device 3610) are worn on fingers of a hand 108. Each of the devices is utilized for interacting with an optical sensing apparatus 3636, where for each, mechanism 3616 acts as a communication mechanism for exemplarily communicating with apparatus 3636. In system 3630, apparatus 3636 is designed to detect touch on a screen 3632 by utilizing an optical sensing mechanism 128, located behind the screen and facing it. Mechanism 128 may be able to measure different light properties (e.g. wavelength, intensity, etc.). In some embodiments, the sensing mechanism may be a camera for capturing images of anything touching the screen and thus creating shadows on the screen. In some embodiments, mechanism 128 may be coupled with a processing unit 144 and a recognition function 150, for recognizing certain optical features-sensed by mechanism 128. Apparatus 3636 may be adapted to detect and recognize specific light properties, in addition to detecting touch optically. Accordingly, a mechanism 3616 of each device 3610 may illuminate the finger on which the device is worn, so that light emitted from the tip of the finger is detected by mechanism 128 and recognized, such as for registering a specific input corresponding to the recognition. For example, mechanism 128 may detect touch by sensing shadows formed when tips of fingers touch screen 3632. When a mechanism 3616 of a device 3610 is illuminating the finger on which the device is worn with a certain color, that color may be detected and recognized. In some embodiments, different colors may correspond to different inputs registered in system 3630, so that a device 3610 may be operated to optically relay information in the system, in addition to just touch being a source of input.

In alternative embodiments, optical sensing mechanism 128 of apparatus 3636 may be a near infrared (NIR) sensing mechanism, while screen 3632 may be a waveguide illuminated with NIR light which is totally reflected inside the waveguide. The total reflection may be disturbed by touch on the screen so that some of the light is scattered towards the sensing mechanism to detect touch on the screen. In such case, sensing mechanism 128 may be adapted to further be able to detect NIR light originating from the tip of a finger touching the screen, specifically different properties of that light. Such light may be generated by an illumination mechanism 3616 of a device 3610 worn on that finger. Mechanism 3616 may modulate NIR light emissions as informative signals which may exemplarily correspond to indications of touch from a touch surface 164, or any other operable element of the device. Furthermore, by utilizing mechanisms 3616, apparatus 3636 may distinguish between touch of a touch finger wearing a device 3610, such as by assigning a different illumination color to each finger.

In some embodiments, apparatus 3636 may include, in addition to the described above, a projector 3634 for projecting visuals on screen 3632.

FIG. 36E shows an embodiment of a system 3640 similar to system 3630, in which devices 3410a,b (as a plurality of device 3410) having projection mechanisms 3420 and 3420′, respectively, are utilized for the same results as in system 3630. In FIG. 36E there is shown a hand 108 interacting with an apparatus 3636 as previously described. An embodiment of a device 3410a is worn on an index finger 102, while an embodiment of a device 3410b is worn on a middle finger 104. A projection mechanism 3420 of device 3410a is projecting visual output 3426 on screen 3632, approximately where finger 102 is touching the screen, specifically “below” the tip of the finger. A projection mechanism 3420′ of device 3410b projects visual output 3426′ on screen 3632, generally where finger 104 is touching the screen, specifically above the tip of the finger. Device 3410b is shown to be worn on the intermediate phalanx section of finger 104. Accordingly, calibrating the visual output projected from mechanism 3420′ is not needed because the general distance between where finger 104 touches a screen and the location of the device is always the same, except for minor variations when the distal phalanx section of the finger folds during touch. Similarly to the described for system 3630, apparatus 3636 may detect each visual output, and by recognition, corresponding input may be registered in system 3640. Accordingly, projecting mechanisms 3420 and 3420′ may act as exemplary communication mechanisms. In some embodiments, similarly to illumination of a mechanism 3616, visual output from a projection mechanism may be just light having specific detectable properties.

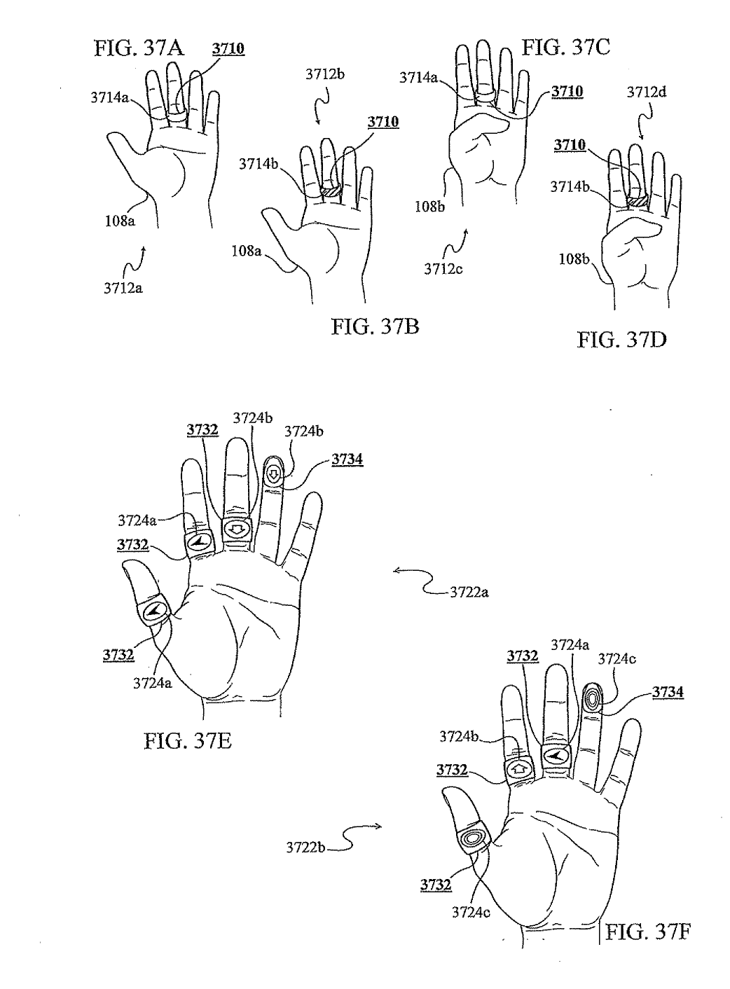

FIGS. 37A through 37D respectively show visual messages 3712a-d, each including a visual output of an exemplary finger-worn device 3710, and a hand gesture. Any visual output mechanism in device 3710 can generate visual outputs 3714a (FIGS. 37A and 37C) and 3714b (FIGS. 37B and 37D). Device 3710 is worn on a finger of a hand 108, which can perform gestures 108a (FIGS. 37A and 37B) and 108b (FIGS. 37C and 37D). In some embodiments, the gestures may be meaningful visual messages, such as being recognizable in visual recognition mechanisms where interactions are facilitated by visually recognizing hand gestures. In some embodiments, the visual outputs of device 3710, which may be indicative of states of the device, may be meaningful in visual interactions systems adapted to specifically detect output from the device, such as a system programmed to identify distinctly glowing colors approximately at detected hand gestures. Accordingly, different hand gestures and different visual outputs from the device worn on a finger of the hand performing the gestures may be combined for specific visual messages. Visual interactions systems may include a camera connected to a computer having a visual recognition application, wherein the application may be programmed to influence operations of the computer according to images captures by the camera.

FIGS. 37E and 37F show visual messages 3722a,b, each including at least one of or a combination of visual outputs 3724a-e, shown in the figures as graphic symbols. Each of the outputs can be displayed on a finger-worn device 3732 and by a device 3734 (shown to be displayed at the front of a palm, yet may be displayed at the back of a palm, in some embodiments). Device 3734 may be worn on a tip of a finger, as shown in FIGS. 37E and 37F. Setting device 3732 and device 3734 to display a specific output is by manually operating the devices, such as by setting a rotatable section of each device to a specific rotated position, or by other operations of the devices, such as responding to incoming signals. In some embodiments, each of visual outputs 3724a-c may be detected and registered as specific inputs. Additionally, combinations of the outputs (e.g. message 3722a shown in FIG. 37E and message 3722b shown in FIG. 37F), may be detected and registered as further specific visual inputs. For example, output 3724a may visually represent an element of an interface, wherein upon detection of the output, it is registered as input corresponding to that element of the interface. Similarly, each of outputs 3724b-c visually represent elements of the interface, and so upon detection are registered as input that correspond to their respective interface elements. The outputs of the interface may exemplarily be applications that “open” according to corresponding input. The outputs may similarly be tool-bars or options-menus that “pop-up” as their corresponding input is registered. The outputs may alternatively be assigned folders that are “called-upon” by corresponding input as it is detected and registered.

In some embodiments, visual output from a device of the invention may facilitate detecting the direction the finger is positioned in (such as when the finger is performing a “pointing” gesture). For example, as shown for an output 3724b (FIG. 37F), a device 3732 (shown in FIG. 37F to display output 3724b) may display the output, which is generally shown as an mow, pointing generally towards the tip of a finger wearing the device, while detecting the direction of the arrow (output 3724b) may be faster for a visual recognition mechanism than detecting the direction of the finger (which might require a more complicated recognition algorithm).

In some embodiments, visual output may be utilized as responses. For example, a system having a visual sensing mechanism that can capture and recognize outputs 3724a-c may further include an interface and a monitor for displaying visual output of the interface. Additionally, the system may display certain queries to a user wearing devices 3732 and 3734, that can be answered or replied to by any of outputs 3724a-c, and so the user may use any of devices 3732 and 3734 for displaying the element or the combination of outputs that correspond to the desired answer or reply. This procedure may be facilitated by the user sliding a thumb on any of the devices to browse through the outputs, and then presenting the display of the devices to the visual sensing mechanism of the system. Alternatively, the user may perform specific action for prompting a display of each of the outputs, such as a “double-tap” (pressing twice rapidly) to display outputs 3724a, or touch on a specific area of a sensing surface for displaying output 3724b, a touch on another specific area of the sensing surface for displaying outputs 3724e. Amounts of pressure on the sensing surface of each of the devices may also correspond to each of the outputs.

Combinations of outputs displayed on a device of the invention may be for more interaction features, such as for assigning values to a function of an interface. For example, displaying output 3724a on one device and output 3724b on another device may be for creating a random displayed object, while additionally displaying output 3724b on yet another device may be for creating a displayed object having properties that correspond to that output. Alternatively, displaying output 3724a in combination with output 3724c may be for creating a displayed object having different properties.

Outputs displayed on a device of the invention may have multiple distinctive properties, such as colors or brightness. Additionally, the elements may be a static image or a sequence of images, such as an animation or video clip. Further additionally, the outputs may have a common semantic meaning, such as letters or digits, or preprogrammed semantic meaning, such as a combination of dots that may be recognized according to a protocol or syntax of dots combinations.

In some embodiments, outputs displayed by a device of the invention may be for communicating specific information to a separate party or to a visual recognition mechanism. For example, a device of the invention may display, according to use, personal information of the user of the device that uses the device to display the information if it is desired for the information to be detected by another device or as part of interactions in a system. The information may be an optical tag for retrieving certain information from a detecting device. In another example, the information may be an ID number whereas each digit of the number may be flashed for a brief moment, one after the other, enough to be detected and registered. The information may alternatively be a security code, a bar code, a visual encryption of values, a classification symbol, etc.

In some embodiments, a device of the invention may display output in response to signals received from another device, such as interrogation or query signals for extracting information stored on the device of the invention and displaying it on the device to be visually detected. The outputs may correspond or represent the information relevant to the signals.

In some embodiments, visual output displayed on finger-worn devices may be utilized by systems similarly to the above, for interactions that correspond to each finger wearing each device, so procedures or operations may be performed by each finger, separately or collaboratively. For example, displaying different outputs on each device worn on a different finger may be for distinguishing between the fingers so that each finger may control a separate cursor on a visual interface, or for tracking the motion of each finger separately, wherein each finger's motion may control a different interface element. In similar embodiments, the outputs are utilized by a system of multiple users wearing finger-worry devices, wherein the outputs may facilitate distinguishing between each user's interaction procedures or operations, such as in case each user is assigned a certain symbol to be displayed respectively on the devices of each user.

In some embodiments, any of devices 3732 and 3734 may be utilized in a system 3630 (ref. FIG. 36D). In one example, a device 3734 may display an optic tag as a visual output, so that the tip of a finger wearing the device may be pressed on a screen 3632 of an apparatus 3636, wherein the tag may be detected by a sensing mechanism 128 and recognized by a processing unit 144 and a recognition function 150. In a similar example, a device 3632 may display an output and may be worn on the proximal phalanx section of a finger, wherein detecting the output by sensing mechanism 128 may be facilitates by placing the entire palm of a finger, on which the device is worn, open on screen 3632.

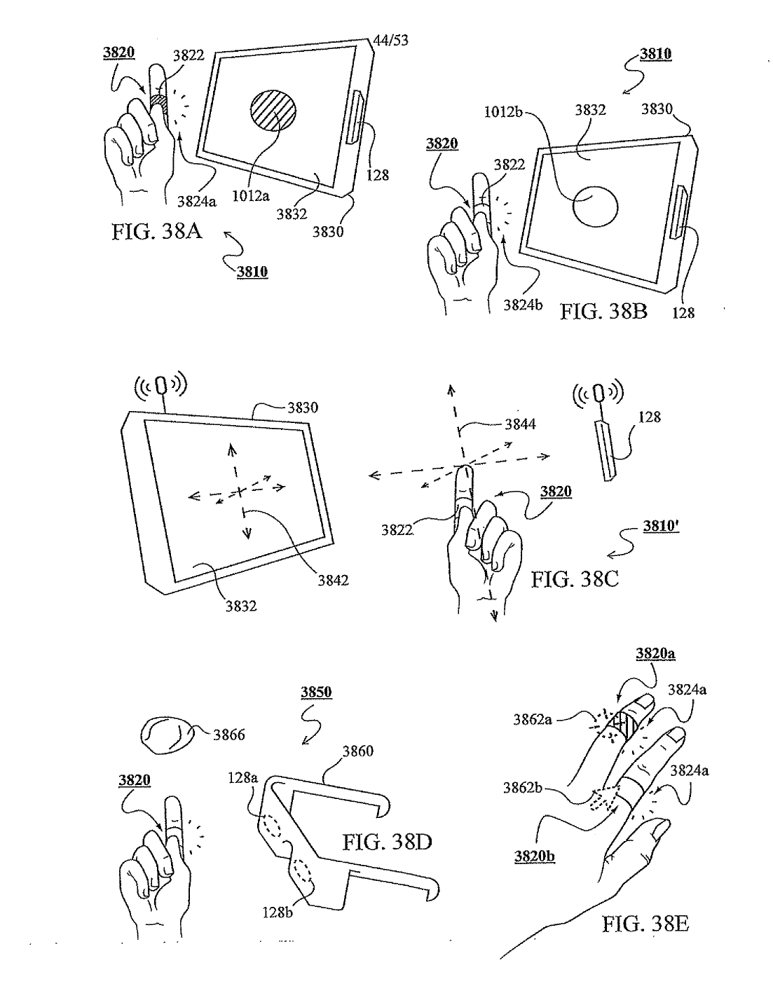

FIGS. 38A and 38B show an embodiment of a system 3810 in which a finger-worn device (shown as an exemplary device 3820) with a light output mechanism 3822 (as an exemplary visual output mechanism) is utilized for interacting with a terminal 3830 (as an exemplary separate device). Terminal 3830 is exemplarily an electronic device having a display 3832 and an optical sensing mechanism 128 such as a camera. Mechanism 128 can sense light and/or detect light properties. In some embodiments, controlling mechanism 3822 is by operating device 3820, specifically by touch. For example, a thumb may touch and/or slide on a touch surface of device 3820 to change the output of mechanism 3822. In FIG. 38A, device 3820 is shown to be operated so that mechanism 3822 outputs light have a property 3824a. In FIG. 38B, device 3820 is shown to be operated so that mechanism 3822 outputs light having a property 3824b. The properties may be colors, intensities of light, or coded visual transmissions (for example by distinct blinking rates). Mechanism 3822 can modulate between different properties. Sensing mechanism 128 of terminal 3830 can detect light properties emitted (i.e. outputted) by mechanism 3822. The terminal can recognize light properties for registering corresponding input. In FIGS. 38A and 38B, detection and recognition of properties 3824a and 3824b respectively prompts a display of a displayed object 1012a (FIG. 38A) and a displayed object 1012b (FIG. 38B), on display 3832. Objects 1012a,b may be further interacted with when they are displayed, such as by hand gestures which may further be detected by mechanism 128 and recognized by terminal 3830. Alternatively, detection and recognition of light properties may prompt other operations of the terminal. For example, a registered input from detected and recognized properties may be “fed” as values for variables of a function.

FIG. 38C shows an embodiment of a system 3810′ similar to system 3810, wherein optical sensing mechanism 128 of terminal 3830 is separate from display 3832 and is located “behind” a finger wearing the device (shown as index finger 102 wearing device 3820) and facing the display, so that the finger is between the sensing mechanism and the display. The sensing mechanism exemplarily communicated wirelessly with the display. Also shown in FIG. 38C are virtual directions 3842 of the display on display 3832. In some embodiments, virtual directions 3842 correspond to motion directions 3844 of finger 102, so that when the finger generally moves in directions 3844, the display of on display 3832 may change according to virtual directions 3844. The motion of the finger (and/or similarly the position of the finger) may be detected by mechanism 128 detecting light from output mechanism 3822 of device 3820. Detecting light from the device may facilitate tracking the movement of finger 102 wearing the device, and/or of the hand of the finger, such as in low lighting conditions.

In some embodiments, device 3820 may include an illumination mechanism 3616 (as described in FIGS. 36A-D as an exemplary light output mechanism, so that light may glow through a finger wearing the device which may facilitate detecting the position and motion of the finger (also “tracking the finger”). Additionally, illuminating the finger facilitates optical detection of the finger and/or of the device, such as when the device is obscured (i.e. not directly in line of sight of sensing mechanism 128) yet the output from mechanism 3616 (i.e. light generally emitted from the surface of the finger) is “carried” to parts of the finger that are not obscured.

FIG. 38D shows an embodiment of a system 3850 in which a finger-worn 3820 is utilized for interaction with a head-up display device 3860 having optical sensing mechanisms 128a,b. Device 3860 may be an “Eyetap” device (see e.g. U.S. Pat. No. 6,172,657 and US patent application 002/0030637) that captures visuals and generates imagery for a “computer-mediated reality” or “augmented-reality”, as known in the art, wherein the user may see through the device, and may additionally see imagery created by the device, together or separately. Alternatively, device 3860 may be a “virtual-reality” device displaying only generated imagery and adapted to include optical sensing mechanisms to optically sense the real environment in front of a user wearing the device. Sensing mechanisms 128 can distinctly detect light output (specifically certain properties of the output, e.g. properties 3824a,b) from device 3820. This may facilitate interaction with generated imagery of device 3860. In some embodiments, detections of light output from device 3820, such as described for FIGS. 38A through 38C, may be registered by device 3860 as a specific input which is differentiated from the rest of the visuals captured by device 3860, so that device 3820 may control specific interactions with device 3860. In FIG. 38E there is shown a representation of a view of a user looking through device 3860. Exemplarily, virtual cursors 3862a,b are generated by a display of devices 3860 and following detected motion of devices 3820a,b, respectively, each worn on a separate finger. Displaying the cursor corresponding to the motion of the devices (and accordingly of the fingers) may be facilitated by tracking light output from device 3820. Similarly to the described for system 3810′ in FIG. 38C, virtual navigation (i.e. cursors movement) may correspond to actual fingers motion, thereby the cursors may be controlled by moving the fingers. Each cursor is displayed correspondingly to the detection of properties 3824a,b, as shown in FIG. 38E, cursor 3862a corresponding to property 3824a (device 3820a), and cursor 3862b corresponding to property 3824b (device 3820b). A cursor may be utilized to point (i.e. gesture) to a real item 3866 (shown as a rock in FIG. 38D) in the real environment, or to point to a displayed object (e.g. object 1012a shown in FIG. 38A) generated by the display, for interactions corresponding to detection of the real item, or corresponding to the displayed object. The “function” of the cursor may also change correspondingly to different properties of light output from device 3820, such as having a “selecting” function (e.g. selecting an object according to a pointing gesture) when a property 3824a (shown in FIG. 38A) is detected (by mechanisms 128a,b) and having a “focusing” function (e.g. auto-focus of lenses of device 3860 according to a pointing gesture) when property 3824a (shown in FIG. 38B) is detected. In some embodiments, change in the output from device 3820 may be for changing between a mode of interacting with the real environment and a mode of interacting with the generated imagery.

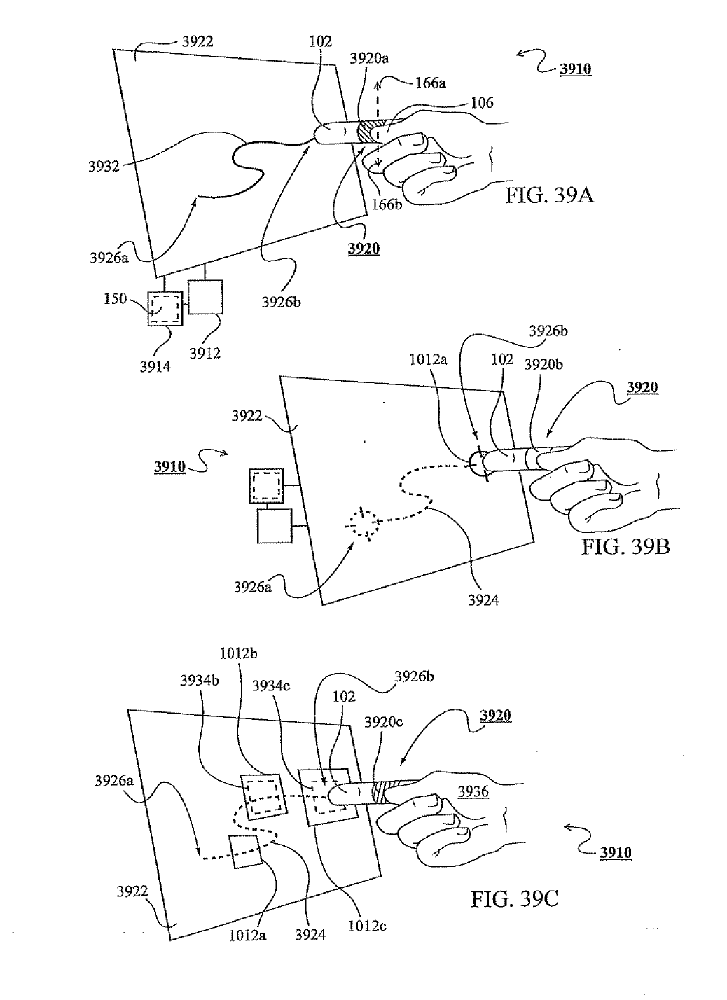

FIGS. 39A through 39C shows embodiments of a system 3910 in which a finger-worn device 3920 is utilized for different types of interactions. In FIGS. 39A through 39C, an index finger 102 is wearing device 3920 and is interacting with a display 3922 either by touch and touch motion or by gestures and gestures motion (shown in the figures finger 102 performing a pointing gesture towards the screen or touching the screen). Touch or gestures, and motion thereof, can be detected by a detection mechanism 3912 (shown in FIG. 39A connected to the display) which can be a visual recognition mechanism or any touch detection mechanism known in the art. Mechanism 3912 is shown coupled with a processing unit 3914 (shown in FIG. 39A connected to the display and to mechanism 3912) for processing detections and interaction operations, such as for registering input from detections and displaying corresponding visual outputs on display 3922. The detection mechanism or the processing unit may have a recognition function 150 for recognizing finger locations, motions and/or gestures, in case the interacting with the display is not by touch. Device 3920 may have one of states 3920a-c at any given time, and may exemplarily be operated by touch, specifically touch motion for changing between states. Additionally or alternatively, a state is sustained by holding touch on the touch surface of the device. Alternatively, states 3920a-c, as described for system 3910, may be “uses” of the device 3920 which remain constant during an operation, such as holding touch on surface 164. Device 3920 includes an indication mechanism for indicating the states.

In each figure, finger 102 performs a motion 3924. The motion may be performed while the finger touches display 3922 or gestures towards the display. The motion starts at a location 3926a and ends at a location 3926b (to which the finger is shown to be pointing at in each figure).

Device 3920 is specifically shown in FIG. 39A as set to state 3920a before motion 3924 is performed. When motion 3924 is performed, while device 3920 is set to state 3920a, the motion corresponds to a “drawing” function, wherein a stroke 3932 is drawn on display 3922 according to the motion. The motion is showed in FIG. 39A as the stroke and in FIGS. 39B and 39C as a dashed line. For example, mechanism 3912 may detect state 3920a for tracing any motion of finger 102 as a drawn stroke. By detecting motion 3924, the path of the motion may be registered and accordingly traced as stroke 3932. In some embodiments, sliding a thumb 106 on a touch surface of device 3920 in direction 166a may be for increasing the thickness of stroke 3932, while sliding the thumb in direction 166b may be for decreasing the thickness. In other embodiments, sliding on a touch surface of device 3920 may be for changing other attributes of the stroke, such as colors.

Device 3920 is specifically shown in FIG. 39B as set to state 3920b before motion 3924 is performed. When motion 3924 is performed, while device 3920 is set to state 3920b, the motion corresponds to a “dragging” function, wherein a displayed object 1012a, which was displayed at location 3926a when the motion (and accordingly the function) started, is “dragged” to location 3926b, along the path of the motion. For example, finger 102 may touch display 3922 where object 1012a is displayed (location 3926a), and perform motion 3924 while still touching the display. By detecting state 3920b of device 3920, a “dragging” function is executed correspondingly to the motion of the finger and correspondingly to an object the finger touches (object 1012a), so that the object is dragged on display 3922 from location 3926a to location 3926b.

Device 3920 is specifically shown in FIG. 39C as set to state 3920e before motion 3924 is performed. When motion 3924 is performed while device 3920 is set to state 3920; the motion corresponds to a “magnifying” function, wherein each of displayed objects 1012b-d, located in the path of motion 3924, is sequentially “magnified” on display 3922, when finger 102 generally points to it. Optionally, the object nearest to the finger, such as object 1012d as shown in FIG. 39C, is magnified the most, while the farthest object, such as object 1012b as shown in FIG. 39C, is magnified the least. Accordingly, while motion 3924 is performed, the extent of magnification for each of objects 1012b-d changes correspondingly to the distance of finger 102 from each. Further optionally, objects 1012b-d may be magnified from their original sizes (shown sizes 3934c,d of objects 1012c,d, respectively) respectively, wherein the original sizes of the objects are their sizes when device 3920 is not set to state 3920c, or when they are not in the range of the “magnifying” function, such as when finger 102 is distant enough from them. For example, the hand of finger 102 may be performing a “pointing” gesture 3936 towards display 3922 and performing motion 3924 while still pointing at the display. When mechanism 3912 detects gesture 3936 and state 3920c, a “magnifying” function is executed where the finger is pointed at the display. Initially, the function applies to location 3926a (before the motion), and during motion 3924, the “magnification” follows the path of the motion to location 3926b. Optionally, during the motion, a thumb touches and holds a touch surface (commonly referred to as “tap and drag” action) of device 3920, to sustain state 3920c of the device. When the “pointing” of finger 102 reaches location 3926b, the thumb may be removed from the touch surface to change the state of device 3920 and accordingly end the “magnifying” function. Alternatively, state 3920c is sustained without holding the touch of the thumb on surface 164 during motion 3924, while sliding the thumb on the surface may influence the “magnifying” function, such as increasing the extent or range of the “magnification” by sliding in one direction and decreasing the extent or range of the “magnification” by sliding in an opposite direction.

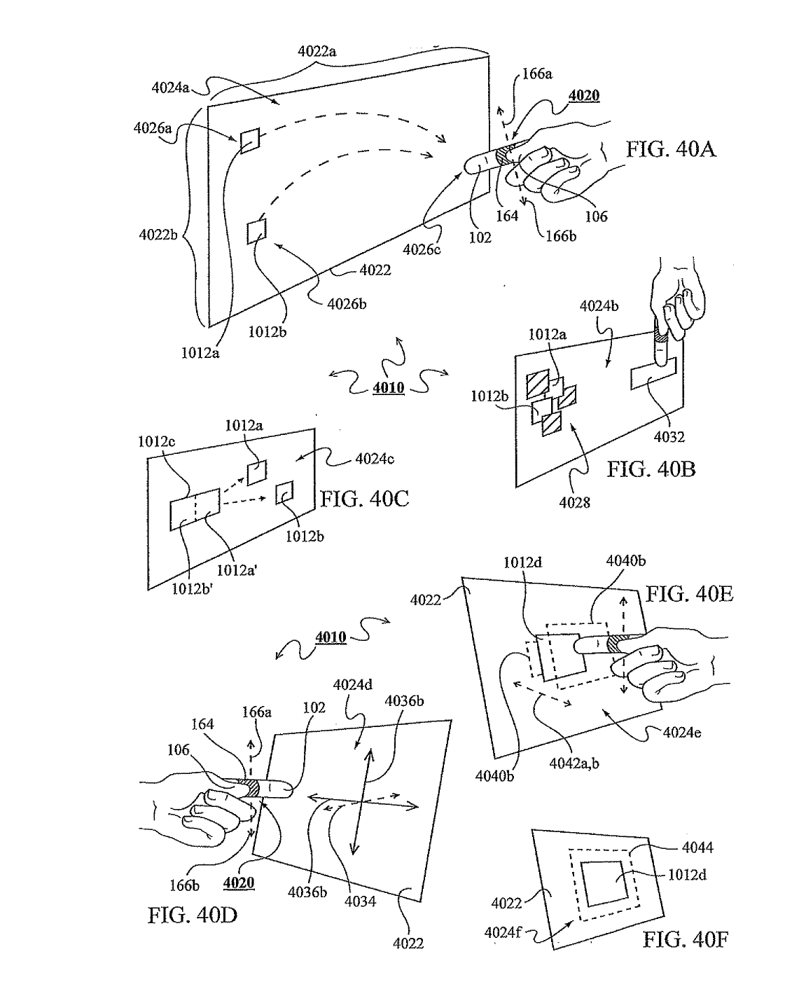

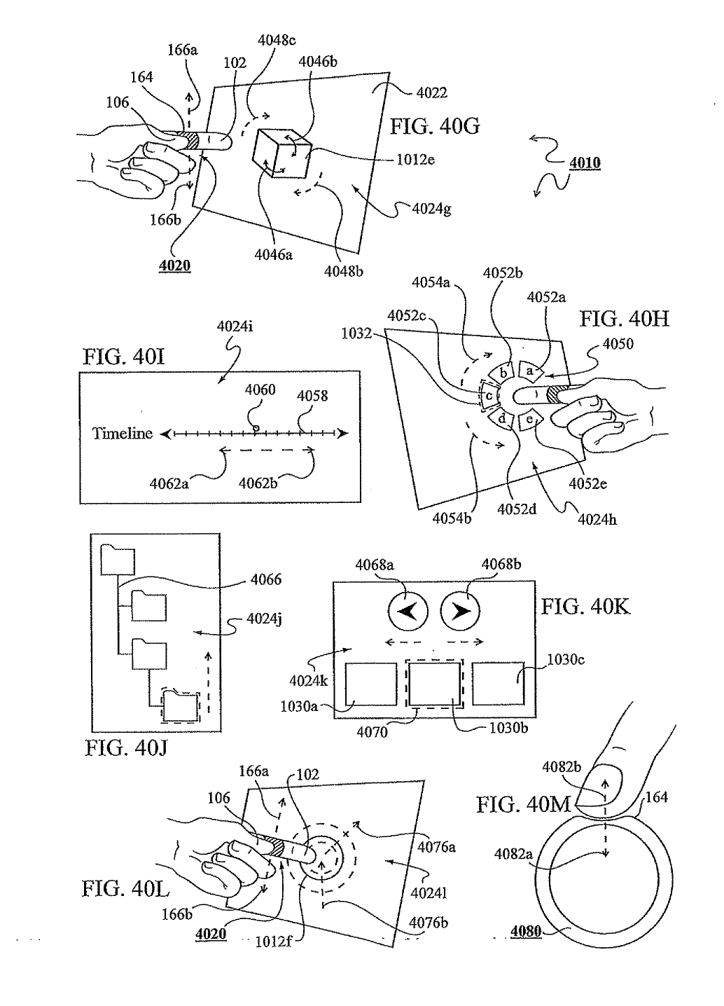

FIGS. 40A through 40F show an embodiment of a system 4010 in which directional information from an exemplary finger-worn device 4020 is utilized for interactions with a display 4022 which is similar to display 3922 and may be connected to a detection mechanism and a processing mechanism as shown in FIG. 39A for display 3922. Directional information may be obtained from indications of use of the device. For example, indications of rotation of a rotatable section of the device may be detected by a detection mechanism (not shown) and processed by a processor for directional information. In FIGS. 40A through 40E, indications of a thumb 106 sliding in sliding direction 166a,b are utilized as directional information in system 4010. In FIGS. 40A through 40F, display 4022 is shown to have physical dimensions 4022a,b.

FIG. 40A specifically shows device 4020 operated for interacting with a virtual environment 4024a displayed on display 4022. The display is shown displaying objects 1012a and 1012b at locations 4026a and 4026b, respectively. In some embodiments, sliding thumb 106 on surface 164 in direction 166a may be for “attracting” the objects from locations 4026a,b towards a location 4026c where a finger 102, which wears device 4020, touches the display, or where the finger gestures towards (on the display). In some embodiments, the objects may have been previously “tagged”, while the “attracting” function described above may be for “recalling” the objects for further interaction. In some embodiments, location 4026c may be a general location on dimensions 4022a,b, directly corresponding to a two dimensional (2D) display of virtual environment 4024a, so that the object is displayed as being attracted on these two dimensions. In some embodiments, the objects may be located “off” the display, such as in case the virtual environment extends beyond the physical dimensions of the display. For example, objects 1012a,b are items in a web-page shown on a web-browser on display 3922, wherein sliding thumb 106 on surface 164 in direction 166a is for scrolling the page towards the objects. Optionally, sliding the thumb in an opposite direction (i.e. direction 166b) is for scrolling the web-page away from the objects.

In other embodiments, objects 1012a,b may have a similar context and may each be “attracted” to a location 4026c correspondingly to their context, such as in case it is desired to extract objects of the same context from a heterogeneous group. In one example, as shown in FIG. 40B for a virtual environment 4024b, a collection 4028 of objects, such as images, may be scattered unorganized on display 3922, wherein each object is associated with certain subjects (also “contexts”), such that each image having specific details appear in it. A subject 4032 may be displayed (as a visual representation, such as text or “icon”) on the display at location 4026c, while finger 102 touches the choice or points to the choice, such as to mark it. Additionally, thumb 106 may slide on surface 164 while the choice is marked, for “attracting” only the objects associated with that choice (objects 1012a,b), so to extract them from the group.

In other embodiments, locations 4026a,b are virtual locations not corresponding, or partially corresponding, to physical dimensions 4022a,b. In one example, similarly to the described for virtual environments 4024d in FIG. 40D, each of locations 4026a,b has three virtual coordinates, two corresponding to physical dimensions 4022a,b and another to a virtual depth 4034. Accordingly, objects 1012a,b may be “located” in a three dimensional (3D) virtual environment, such as a graphic simulation. In such cases, “attracting” the objects may correspond to the physical dimensions of the display (such as of a screen displaying the objects) and to the virtual depth, wherein the objects may be “pulled” to the actual plane on which finger 102 touches or to which finger 102 points, to facilitate interaction with the objects. Optionally, the objects may be located “behind” other displayed objects, such as in a “windows” interface, wherein objects 1012a,b may be partially or completely obscured by “open windows”. In such cases, the “attracting” function may be for bringing the objects to the front of the display. Alternatively, the function may be for browsing through all the “open windows” or all objects, until the desired “window” or object is at the front.

In yet other embodiments, as shown in FIG. 40C for a virtual environment 4024c, objects 1012a,b may be two parts of one object 1012c (shown including objects 1012a″ and 1012b′ in FIG. 40C). The two objects may be separated by sliding thumb 106 in direction 166a, such as to facilitate individual interaction with each. Sliding thumb 106 on surface 164 in direction 166b may be for combining the two objects into object 1012c, such as to facilitate combined interactions. For example, object 1012c may be an image document having multiple layers, such as a shadows layer and a colors layer, each being one of objects 1012a,b. The layers may be separated, such as in case it is desired to edit them separately. The layers may be combined to form the image, such as in case it is desired to edit all of the layers together, or save the entire document.

FIG. 40E specifically shows device 4020 operated for interacting with a virtual environment 4024d displayed on display 4022. The environment is shown have a virtual depth 4034 and dimensions 4036a,b corresponding to physical dimensions 4022a,b (shown in FIG. 40A). In some embodiments, dimensions 4036a,b may be interacted with directly, such as by touching or pointing anywhere along dimensions 4022a,b. Interacting with the virtual depth, such as navigating a cursor on it, may be by sliding thumb 106 on surface 164 in directions 166a,b, similarly to the described above. In some embodiments, virtual depth 4034 is any linear dimension

FIG. 40E specifically shows device 4020 operated for interacting with a virtual environment 4024e displayed on display 4022. The display is shown displaying an object 1012d. In some embodiments, the object may be zoomed in and out according to zooming directions 4042a,b, which correspond to sliding thumb 106 on surface 164 in directions 166a (exemplarily as for zooming in) and in direction 166b (exemplarily as for zooming out). As shown in FIG. 40E, object 1012d may have a larger scale 4040a when zoomed in and a smaller scale 4040b when zoomed out.

In some embodiments, as shown in FIG. 40F for virtual environment 40241, object 4040 may be a “frame” in which a map 4044 is displayed, wherein larger scale 4040a and smaller scale 4040b may be different scales of the map. Accordingly, the scale of the map as displayed inside object 1012d may be changed by the sliding of the thumb as previously described, while object 1012d remains the same.

FIG. 40G specifically shows device 4020 operated for interacting with a 3D object 1012e in a virtual environment 4024g. Object 1012e can be rotated in any of directions 4046a,b by performing motions with finger 102. For example, the finger may touch or point to the object (on display 4022) and slide horizontally (along dimension 4022a) to rotate the object in directions 4046a, while sliding the finger vertically (along dimension 4022b) may be for rotating the object in directions 4046b. In environment 4024g, object 1012e can be rotated in a direction 4048a by sliding thumb 106 in direction 166a and in a direction 4048b by sliding the thumb in direction 166b, while touching or pointing to the object on the display.

FIG. 40H specifically shows device 4020 operated for browsing an exemplary menu 4050 in a virtual environment 4024e. Menu 4050 may be a “pop-up menu” of options 4052a-c that can be browse through by controlling a selection 1032, similarly to the described for interface elements. In environment 4024h, controlling selection 1032 (moving the selection from one option to the other) is by sliding thumb 106 on surface 164 of device 4020. Sliding the thumb in direction 166a may be for moving the selection in direction 4054a, while sliding the thumb in direction 166b may be for moving the selection in direction 4054b. Optionally, removing the thumb from surface 164 may be for selecting the option which selection 1032 is at (shown in FIG. 4011 selection 1032 at option 4052c).

FIG. 40I shows a virtual environment 4024i, which can be interacted with by operating device 4020 in a way similar to that described above for other environments. Environment 4024i includes a timeline 4058 which has a selected instance 4060 as an exemplary selection (e.g. selection 1032). Timeline 4058 may be any track of time of an interface, while selected instance 4060 may be a moment along the timeline that is selected by interacting with the environment. For example, timeline 4058 may be a playback track of a media clip. Alternatively, timeline 4058 may be any series of chronological records, while instance 4060 may be any selected record. For example, timeline 4058 may be a list of dates in a backup-archive of documents. For another example, timeline 4058 may be a sequence of actions performed during an interaction session. Moving instance 4060 in directions 4062a,b, for selecting a moment or a record on timeline 4058, is by sliding thumb 106 on surface 164 of device 4020 in directions 166a,b, respectively. For example, while editing a document, a user may “track-back” to previous actions performed in the document (or previous stages of the editing the document), such as with an “undo” function, by sliding a thumb on a touch surface of a finger-worn device in a certain direction. Additionally, the user may “track-forward”after returning to a previously recorded action, such as with a “redo” function, by sliding the thumb on the surface in an opposite direction.

FIG. 40J shows a virtual environment 4024j which can be interacted with by operating device 4020, similarly to the described above for other environments. Environment 4024j includes a folders tree 4066. Sliding thumb 106 on surface 164 of the device in direction 166a is for moving to a higher level of folders, similar to an “up” function in browsing folders in a “windows” interface.

FIG. 40K shows a virtual environment 4024k which can be interacted with by operating device 4020, similarly to the described above for other environments. Environment 4024k includes a “back” function 4068a and a “forward” function 4068b, such as for browsing through a history of web-pages in a web-browser. Similarly to the described for environment 4024i in FIG. 40I, moving “back” is by sliding thumb 106 on surface 164 of device 4020 in a certain direction, while moving “forward” is by sliding the thumb in an opposite direction. In some embodiments, the “back” and “forward” functions are for controlling a focus 4070 between interface elements 1030a-c (shown in FIG. 40K focus 4070 on element 1030b). Focus 4070 marks an element that is available for interaction at any given moment, or that any further interactions apply to, in a multiple elements environment. For example, in a “windows” interface, focus 4070 is always on the application which is interacted with, while other applications may be open.

In the virtual environments described in FIGS. 40A through 40K, operating device 4020, specifically by sliding thumb 106 on touch surface 164, is preferably contextual to where finger 102 touches on the display or to where finger 102 points to on the display. For example, any function described, which is influenced or controlled by the sliding of thumb 106, is performed on the object or element on which the finger touches or to which the finger points. For a more specific example, “tracking-back” and “tracking-forward” in environment 4024i may be performed correspondingly to sliding of the thumb only when finger 102 touches or points to a displayed object or element which represents timeline 4058. Alternatively, operating the device corresponds to a previously assigned object or element or function. For example, timeline 4058 may be assigned for being controlled by sliding of the thumb, so accordingly sliding the thumb moves selected instance 4060 regardless of the location of finger 102. For another example, separating object 1012c to objects 1012a,b′ in environment 4024c may be performed only when finger 102 touch or points to object 1012c, however, combining objects 1012a,b′ back to object 1012c may be performed regardless of the location of finger 102, because the separated object may have automatically been assigned to the sliding of the thumb when the objects were separated from object 1012e. Optionally, when an object of element or function is assigned to the device it may not be displayed on display 4022. Further alternatively, operating the device may correspond to any object or element of an interface, which is selected at any given time, such as any application which an operated system is focused on, in common graphic operating systems.

FIG. 40L shows a virtual environment 40241 in which device 4020 is operated similarly to the previously described environments, for an alternative to touch-screens “pressure” interactions. In FIG. 40L, display 4022 may specifically be a pressure sensitive touch-screen, wherein touching the display creates an object 1012f correspondingly to the pressure applied on the screen, such as the higher the pressure the larger the object.

Alternatively, display 4022 may lack the pressure sensing feature, wherein sliding thumb 106 on surface 164 of device 4020 may be for determining the side of object 10121 as it is created from touch of finger 102. For example, when finger 102 touches display 4022, a default sized object 10121 is created (i.e. displayed where the finger is touching). While still holding the touch of finger 102, sliding the thumb in direction 166a may be for increasing the size of the object (correspondingly to direction 4076a), while sliding the thumb in direction 166b may be for decreasing the size of the object (correspondingly to direction 4076b). This may be preferable to the aforementioned pressure sensing feature as the size of the object may be controlled in both directions (i.e. for increasing or decreasing), while in pressure sensitive touch-screen, the highest pressure applied on the screen is the final size of the object.

FIG. 40M shows a sixty first embodiment of a finger-worn device of the invention as a device 4080 which has a pressure sensing touch surface 164 which may be operated for some interactions in the environments described in FIGS. 40A through 40K. For such interactions, the amount of pressure applied on surface 164 corresponds to directions 4082a,b (direction 4082a exemplarily being for more pressure and direction 4082b for less), as shown in FIG. 40M, which act as alternatives to sliding directions 166a,b. For example, in environment 4020e, a thumb may press on surface 164 of device 4080, whereas when reaching a certain amount of pressure such as the average amount (between no pressure and the highest amount detectable by the device), a zooming function on object 1012 as shown in FIG. 40E, is initiated, wherein pressing harder is for zooming in and pressing softer is for zooming out. Optionally, to end the zooming function, another finger may touch the object.

In other embodiments, directions 4082a,b (as pressure amounts) are utilized collaboratively with direction 166a,b. For example, in environment 4024g, a thumb may press on surface 164 of device 4080, and slide the thumb in direction 166a,b, to rotate object 1012 as shown in FIG. 400. The higher the pressure applied to the surface (corresponding to direction 4082b) during sliding, the faster the object rotates.

In yet other embodiments, pressure applied on surface 164 of device 4080 is utilized alternatively to a touch sensing feature of a touch-screen. For example, a display 4022 may specifically be a touch-screen that is not pressure sensitive. By touching the screen with finger 102 and by simultaneously applying pressure to surface 164 with a thumb, an input may be registered which corresponds to the location of the finger and to the amount of pressure applied to the surface. For example, in environment 40241, the size of object 1012, as shown in FIG. 40L, may correspond to the amount of pressure applied to surface 164 when a finger wearing device 4080 touches display 4022, alternatively to a finger wearing device 4020.

Similar results may be achieved by other embodiments of a device of the invention, for example, a device 1920. Similarly to the described for FIG. 19B and to how the device may be utilized in for controlling interfaces in FIGS. 19C and 19D, a user may touch display 4022 with a finger wearing device 1920 to create a default sized object. Holding the touch and tilting the rotatable section of device 1920 in one direction may be for increasing the size of the object, while tilting in an opposite direction may be for decreasing the size of the object. Because the rotatable section is “snapped-back” to its un-tilted position when releasing the pressure applied on it, tilting it again may be for further increasing or decreasing the size of the object.

FIGS. 41A and 41B show an embodiment of a system 4110, wherein a device 4120 is utilized with a virtual environment, similar to the virtual environments described above. In system 4110, an exemplary environment is shown displayed on a display 4022 which similarly to the described for display 3922 may be coupled with a detection and processing mechanisms, as shown in FIG. 39A. Device 4120 is shown in FIG. 41C as a sixty second embodiment of a finger-worn device of the invention. Device 4120 includes a display surface 4122 and touch surface 164 that can indicate touch similarly to any previously described touch surface. FIG. 41C shows surface 4122 exemplarily opposite to surface 164. In FIGS. 41A and 41B, device 4120 is worn on a finger 102 and may be operated by a thumb 106. Further shown in FIGS. 41A and 41B is finger 102 touching display 4022 where an object 1012a is displayed, or pointing to where the object is displayed. Object 1012a may correspond to an element 4112, as specifically shown in FIG. 41D, which is an element of an interface of the system. Element 4112 may be any part of an interface, such as a folder of files, a function tool or a menu, while object 1012a may visually represent element 4112. When performing a certain operating with or on device 4120, such as by sliding thumb 106 on surface 164, the operation is indicated to the system and object 1012a may be “transferred” from display 4022 (FIG. 41A) to display surface 4022, as an object 1012b (FIG. 41B). Alternatively the operation does not include the device, such as an operation where finger 102 “double-taps” (presses twice rapidly) on object 1012a or performs a certain gesture towards the object. Object 1012b may be a smaller version of object 1012a, such as a “thumbnail”, or any other representation of object 1012a or of element 4112. For example, object 1012b may be a visually meaningful “icon”, such as a graphic symbol of a music note in case element 4112 is an audio file or an audio playing application. In the same example, object 1012a may be a visual control-desk of the audio playing application or of an application playing the audio file.

In some embodiments, a certain operation may be performed, with or on device 4120 or without device 4120, for assigning element 4112 to device 4120 or to finger 102, such as to be controlled by the device of such as to correspond to actions of finger 102. Optionally, similarly to the described above, object 1012a, which correspond to element 4112, may be “transferred” to surface 4122 as object 1012b, in addition to the assigning. Alternatively or additionally, an object 1012c (FIG. 41B) may be displayed on display 4022 according to the “assigning” operation, such as instead of object 1012b displayed on surface 4122 as a result of the operation.

In one example, element 4112 may be a “deletion” function, while objects 1012a and 1012b may be a large and small tool symbols, respectively, corresponding to the function. Accordingly, when object 1012b is displayed on surface 4122 of device 4120 after a certain operation is performed, any touch or pointing of finger 102, as part of an interaction with display 4022, may execute the “deletion” function, such as deleting any object to which the finger is pointing or on which the finger is touching.

In another example, element 4112 may be the audio volume of system 4110, wherein assigning element 4112 to device 4120, either with or without a visual “transferring” of objects, may facilitate controlling the audio volume of the system with device 4120, such as increasing the volume by sliding thumb 106 on surface 164 in one direction and decreasing the volume by sliding in an opposite direction.

In yet another example, element 4112 may be a media playing application in a system exemplarily utilizing a device 1310 (alternatively to device 4120). The entire application may be assigned to device 1310, or different member of the application may be assigned to different tilted positions of the device, wherein rotating section 112 of the device in a tilted position may be for controlling a specific member assigned to that position. Specifically, similarly to the described for device 1310 in FIGS. 20A-C, rotating the section while it is in a tilted position 414a (shown as un-tilted in FIG. 20A), may be for controlling the volume of the media, while rotating the section while it is in tilted positions 414b and 414c may be for browsing through media files and for controlling the play-back (or “track”), respectively.

In yet another example, element 4112 may be a function in progress, such as a “downloading” function represented by object 1012a which may be a progress-bar of the downloading. When finger 102 touches the bar (object 1012a), as an exemplary assigning operation which does not include device 4120, the bar disappears from display 4022 and object 1012b appears on surface 4122 of device 4120. Object 1012b may be a simpler version of the bar, such as formed in a low resolution with fewer pixels, while during the downloading the simpler version changes (e.g. “fills-up”) on the display of surface 4122. Alternatively, object 1012b may be a different visual representation of the progress-bar, such as a changing brightness of a certain color, in which the more the downloading progresses, the brighter the color displayed on surface 4122. Optionally, when downloading is complete (i.e. the “downloading” function ends), the color may be blinking, as a feedback for the user.

In some embodiments, a certain operation, either with or on device 4120 or without including the device, may be for removing object 1012b from the display of surface 4122, and/or for ending the assignment of element 4112 to device 4120 or to the actions of finger 102. For example, following the example for a “downloading” function, when downloading is complete and a color is blinking on surface 4122, finger 102 may “double-tap” on display 4022 to “open” the downloaded content, such as to display the files that were downloaded by the function on display 4022. Optionally, object 1012b is transferred to display 4022 as object 1012a, similarly to object 1012a being transferred to surface 4122 as object 1012b.

In another example, device 4120 is utilized for a common “cut-paste” function in system 4110, wherein by assigning element 4112 to device 4120 by a certain operation, object 1012a is “cut”, temporarily appearing on surface 4122 as object 1012b. An additional operation may “paste” object 1012a, and accordingly element 4112, at a different location, such as where finger 102 is pointing during the additional operation. More specifically, element 4112 may be a file, such as an image file, while object 1012a may be the image as displayed on display 4022. By touching the display with finger 102 where the image is displayed, and sliding thumb 106 on surface 164, the image (object 1012a) may disappear from display 4022 and an icon (object 1012b) of the file (element 4112) may appear on display surface 4122. Finger 102 may “double-tap” on a different location on the display from where the image was displayed, for the image to reappear there and for the icon to disappear from surface 4122. Alternatively, the icon is still displayed on the surface, while the finger may “double-tap” a second time for displaying a second copy of the image on display 4022.

In some embodiments, locations on the display correspond to locations on a memory unit 4116 of system 4110, so that the “cut-paste” function described above, and similar functions, may be for cutting, pasting, copying, deleting and/or moving element 4112 correspondingly to memory locations. For example, cutting and pasting object 1012a from and to locations on display 4022 may correspond to cutting and pasting element 4112 from and to locations on unit 4116.

In some embodiments, device 4120 may include, in addition to the described above, a memory unit 146, while in accordance with the described above, element 4112 may be copied or moved to unit 146 and from unit 146, and deleted from unit 146. Accordingly, unit 146 may act as a “clipboard” buffer in common interfaces. Optionally, element 4112 may be manipulated while on memory unit 146, such as compressed. Further optionally, element 4112 may be stored on memory unit 146 and copied or moved to another system.

In some embodiments, interface elements or information of interface elements may be controlled by device 4120 separately from system 4110. For example, similarly to the described for a memory unit 146 of device 110e in FIG. 1G, an interface element may be a media file, while device 4120 may include, in addition to memory unit 146, a processor and a media playing application, thus media files can be copied to memory unit 146 by interacting with system 4110, and played by device 4120 communicating with any output apparatus, even when not interacting with system 4110.

In FIGS. 41E and 41F, device 4120 is utilized to display a cursor 4114, as an exemplary object 1012b, on surface 4122, as specifically shown in FIGS. 41E and 41F. This is similar to a mouse cursor changing appearance correspondingly to functions and operations in a common GUIs (as an exemplary virtual environment). Cursor 4114 may change, such as to a different cursor shape, correspondingly to certain operations as described above. For example, element 4112 may be a function tool, such as a “selection” function tool, while object 1012a may be a button activating the tool. When cursor 4114 is displayed on surface 4122 of the device (shown as an arrow symbol) and finger 102 presses on object 1012a on display 4022 (FIG. 41E), cursor 4114 changes to a different cursor (shown a cursor 4114′ as a hand symbol), while object 1012a changes to a “pressed” button (shown as an object 1012d in FIG. 41F). When finger 102 further presses on objects on display 4022, it is for selecting these objects, such as for copying them. Alternatively, cursor 4114 may be displayed on surface 4122 and may change automatically, correspondingly to operations of system 4110 that may not include device 4120 and/or finger 102. For example, cursor 4114 may be a generic arrow cursor (as shown in FIG. 41E), while when a certain process of system 4110, such as compression of a file, is in progress, the shape of the cursor may change from a generic arrow to a common sand-clock cursor or any other “wait” symbol.

FIG. 41G shows a display 4022 displaying object 1012d-f and a menu 4050 (as described for virtual environment 4024h in FIG. 40H), wherein menu 4050 includes objects 1012d-f′ arranged in a series. Similarly to the described above, any number, in any combination, of objects 1012d-f may be “transferred” to display surface 4122 of device 4120. Additionally or alternatively, any number, in any combination, of interface elements which correspond to the objects, may be assigned to device 4120, similarly to element 4112 being assigned to the device as described above. When multiple elements are assigned to the device, selecting one element to correspond to an operation of the device or to an action of finger 102 may be by operating the device. For example, sliding thumb 106 on surface 164 of device 4120 may be for browsing between the elements, and/or for browsing between object 1012d-f as displayed on surface 4122.

FIG. 41H shows a sixty third embodiment of a finger-worn device of the invention as a device 4130, which includes a visual output mechanism 142 and two tracks (tracks 218a,b) on which a rotatable section 112 (shown as a transparent section installed on a stationary section 114) can be rotated, such as by tilting the section on either track. Objects 1012d-f were exemplarily “transferred” from display 4022 to being displayed by mechanism 142, wherein only one object may be displayed by the mechanism at any given time. Accordingly, elements corresponding to the objects may be assigned to the device. By rotating section 112 on track 218a, a user of the device may browse through the elements, while when any element is selected at a given time, its corresponding object is displayed by mechanism 142 at that time (shown object 1012e displayed by mechanism 142, in which case an element corresponding to object 1012f is selected). Optionally, by rotating section 112 on track 218b, other operations may be performed, specifically operations corresponding to a selected element, such as if object 1012d corresponds to a playback track of an audio file (as an exemplary element) and object 1012e corresponds to an audio volume, when object 1012d is displayed by mechanism 142 (by rotating section 112 on track 218a until object 1012d appears), rotating section 112 on track 218b may be for controlling the playback, and when object 1012e is displayed, rotating section 112 on track 218b may be for controlling the volume.

FIG. 41I shows a sixty fourth embodiment of a finger-worn device of the invention as a device 4140 similar to device 4120, in which a touch surface 164 is also a display surface, such as for an implementation of an interactive display mechanism as described for devices 2310 (in FIGS. 23A-23C) and 2710 (specifically in FIG. 27C). In FIG. 41I, surface 164 is shown displaying objects 1012d-f which were exemplarily “transferred” from display 4022. In some embodiments, elements which correspond to the objects were assigned to device 4140 so that by touching surface 164 where an object is displayed (as an exemplary indication location, such as objects 1012d-f acting as locations 154a-c of device 2120 in FIGS. 21B and 21C), the element which corresponds to that object may be utilized. For example, object 1012d may correspond to a “deletion” function and object 1012e may correspond to a file. When a thumb presses on surface 164 specifically where object 1012d is displayed, any action of a finger wearing device 4140, such as a “pointing” gesture towards a displayed object on display 4022, is for deleting. When a thumb presses on surface 164 specifically where object 1012d is displayed, any action of the finger corresponds to the aforementioned file, such as if the finger touches a “trash-can” symbol on display 4022, the file is deleted from a memory unit of device 4140, or such as if the finger touches a folder on display 4022, the file is copied to that folder.

According to the above, “sliding” operations (sliding a finger on surface 164) may be utilized with “transferred” objects, such as in cases where directions between elements assigned correspondingly to the objects, and/or the order with which they were assigned, are relevant to an interface. For example, as specifically shown in FIG. 41J, an “increase brightness” function, a “decrease brightness” function (shown corresponding to a white square and a black square, being objects 1012g and 1012h, respectively) and a stroke function (shown corresponding to a pencil symbol being an object 1012i), were assigned to a device 4140′, which represents a sixty fifth embodiment of the finger-worn device of the invention. Similarly to the described for system 3910 in FIG. 39A, a user may touch and hold the touch on object 10121 and perform a motion with a finger wearing the device, to draw a stroke. After releasing the touch, by touching object 1012g and sliding the touch to object 1012i, the brightness of the stoke increases, while the user may repeat this action to further increase the brightness of the stroke. Similarly, by touching object 1012b and sliding the touch to object 1012i, the brightness of the stroke decreases. Alternatively, surface 164 is displaying only objects 1012g and 1012i. By sliding touch from object 1012g to object 1012i, the brightness of the stroke increases, while by sliding touch from object 1012i to object 1012g (i.e. in an opposite direction), the brightness of the stroke decreases.

In some embodiments, “transferring” of multiple objects between displays and/or assigning multiple elements to a device of the invention may be performed in a certain order so that the objects and/or the elements may be browsed through in that order. For example, objects 1012d-f may be “transferred” to be displayed on a device of the invention in an order of object 1012d, then object 1012e and finally object 1012f, by performing a “transferring” operation first on object 1012d, then on object 1012e and finally on object 1012f. Accordingly, browsing between the objects, and/or their corresponding elements, may be in the same order. Alternatively, the objects are displayed in that order on the device.

Similarly, a group of multiple objects, such as menu 4050 as a group of objects 1012d-f′, may be “transferred” to be displayed on the device, while elements corresponding to the objects in the menu may be assigned to the device. Accordingly, the objects in the group (e.g. menu 4050) are arranged and may be browsed through by their order in the group, so while all the objects in menu 4050, as an example, as displayed on display 4022, in some devices of the invention only one object may be displayed at any given time and any other objects may be displayed by browsing between the objects in the aforementioned order.

FIG. 41K shows a system 4110′ in which each of devices 4120a-e (as a plurality of device 4120) are worn on a different finger, and in which each of objects 1012g4 (shown as a circle with lines, an empty circle and a black circle, respectively) are displayed on each of devices 4120a-c, respectively. Each of the objects exemplarily corresponds to a different color swatch, as exemplary elements. Accordingly, each of the color swatches is assigned to each of the devices, and specifically to the action of touch of each finger on display 4022. In some embodiments, when each finger performs an action as part of an interaction with system 4110′, such as touching display 4022 and performing a certain motion while touching the display, the reaction corresponds to the color swatch with is assigned to the device worn on the finger. For example, as shown in FIG. 41K, when each finger performs a touch motion on display 4022, the path of the motion is detected and traced as a stroke (shown a stroke 4118a for the finger wearing device 4120a, a stroke 4118b for the finger wearing device 4120b and a stroke 4118c for the finger wearing device 4120c), similarly to the described for system 3910 in FIG. 39A.

Distinguishing between different fingers wearing devices (such as between touch of each finger on a touch-screen) may be facilitated by mechanisms described herein, such as an illumination mechanism 3616 as described for a device 3610 and a system 3630 in FIGS. 36A-D, or such as a projection mechanism 3420 as specifically described for a system 3640 in FIG. 36E. In another example, utilizing a transmitter 3512 or a transponder mechanism 3524 with an apparatus 3534, as described for system 3530 in FIGS. 35E and 35F, may achieve similar results (distinguishing between fingers), by detecting which device is worn on a touching finger, from receiving output (field 3520, transmission 3544 or influences on field 3536) from that device.

In some embodiments, the described above for objects and elements may alternatively be for time sequences or a series of stages or instances, wherein specific moments or stages or instances may be assigned, such as described for a virtual environment 4024i in FIG. 40I, wherein, a timeline 4058 may be composed of previously assigned instances (such as specific stages during an interaction session), and wherein a device of the invention may be utilized to browse through previously assigned instances, such as to “go back” to previous stages of an interaction session. In one example, a user may be watching a video clip on a screen and can “double-tap” on a touch surface of a finger-worn device to “anchor” the current frame or scene of the video clip (when the surface was “tapped”), such as to later rewind the clip to that specific frame or scene. In another example, actions performed by a user in an application may be registered in a sequence for an “undo” function, wherein the user may operate a finger-worn device to scroll back to previous stages of the sequence. In a similar example, the user may “tag” certain stages during a work process, to be “recalled” at a later time.

In some embodiments, a display of a finger-worn device is utilized for visual feedback in interactions, in response to occurrences in an interface, or in response to interacting with a system. In one example, a user may be interacting with displayed objects on a touch-screen, wherein some objects are restricted for interaction. Accordingly, touching a restricted object with a finger on which the device is worn may prompt a blinking red display on the device, as an exemplary feedback representing restriction. In another example, a user may be playing a game by interacting with a touch-screen, wherein the finger wearing the device is sliding on the screen and must not cross a certain border (on the display, corresponding to the physical dimensions of the screen). Accordingly, as the finger increasingly approaches the border (moves on the screen towards the border displayed on the screen), a red display blinks faster.

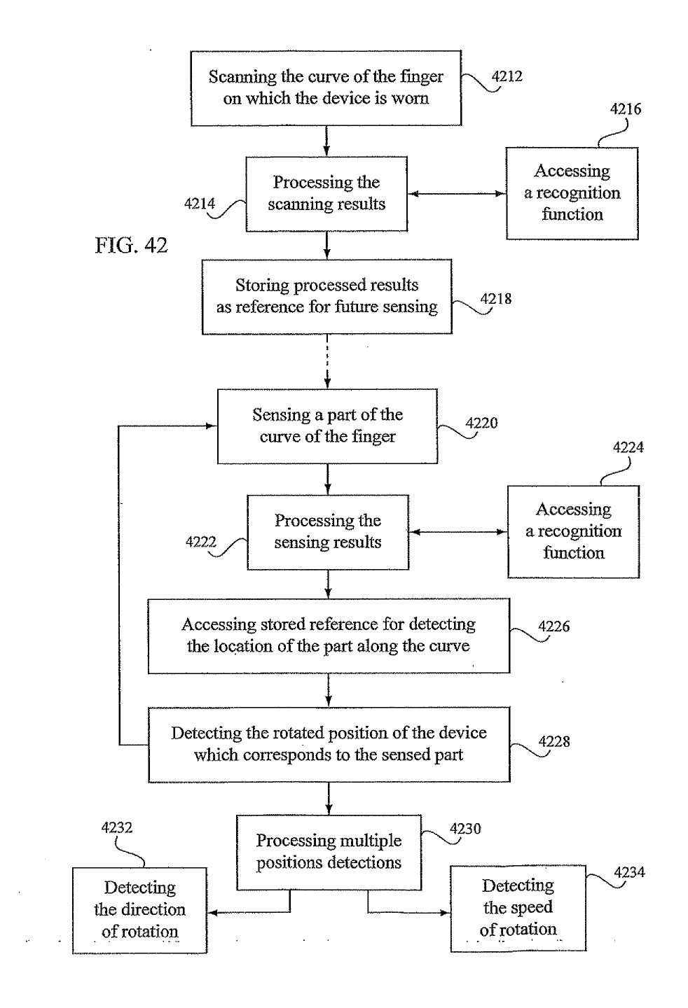

FIG. 42 shows a flowchart of a method for detecting rotated positions of a finger-worn device around a curve of a finger, and for detecting rotation direction and speed. The curve refers to a full or partial circumference at the surface of the finger where the device is worn (see a curve 126 in FIG. 1B). At a step 4212, a sensor (or any sensing mechanism) scans the entire curve of the finger wearing the device. The sensor is generally directed at the surface of the finger. The sensor may be any sensor which can distinguish between different parts along the curve, such as by sensing a pattern along the curve and/or distinct features of each part of the curve. Accordingly, the sensor may be any sensor adapted for fingerprint recognition (as the curve exhibits a pattern of skin crevices similar to fingerprints at the tips of fingers). The sensor can sense a different part of the curve of the finger at each rotated position. Accordingly, different sensed parts of the curve correspond to different rotated positions of the device. Scanning is facilitated by rotating the device around the curve during a sensing operation, so the sensor can sense all parts of the curve in a sequence. This is similar to fingerprint scanning where an opening (here as a sensor) can sense a part of the tip, and where by moving the finger the entire tip can be sensed (see e.g. U.S. Pat. No. 5,195,145). At a step 4214, the results of the scanning in step 4212 are processed. For example, signals from the sensor during the scanning, which correspond to a sequence of different parts of the curve, are sent to a processor. During the processing at step 4214, a recognition function may be accessed at a step 4216. For example, the scanning may be processed in accordance with a recognition algorithm. At a step 4218, processed results from step 4214 are stored as a reference for future sensing. For example, a map of the sequence of each part of the curve (see a map 126b in FIG. 1D), or of the entire pattern of the curve, may be sent to a memory unit for future access. At a step 4220, a part of the curve (which was scanned at step 4212) is sensed. After steps 4412-4418, the device may be operated at any later time, starting from step 4220. For example, after steps 4212-4218 are executed, the device is rotated to a position around the curve of the finger, where correspondingly the sensor of the device is facing a part of the curve, which is sensed at step 4220. At a step 4222, results from the sensing at step 4220 are processed. During the processing at step 4222, a recognition function may be accessed at a step 4224, which may be the same function as in step 4216. At a step 4226, the result from step 4218 (i.e. the stored reference) is accessed, and the location of the part sensed at step 4220 along (or “on”) the curve is detected, such as by recognizing the part out of all the parts, thus obtaining its position in the sequence of parts. The accessing may be performed during the processing of step 4222, such as signals from the sensor (step 4220) are directly compared with the reference. At a step 4228, detection of the rotated position of the device, which corresponds to the location on the curve of the sensed part, is achieved. Because in each rotated position of the device the sensor can sense a different part of the curve, recognizing and/or locating that part from the sequence of parts along the curve facilitates detection of the rotated position.

In some methods, steps 4220-4228 may be executed multiple times so that multiple detections of rotated positions may be processed at a step 4230. By processing multiple positions detections, a detection of the direction of rotation of the device (i.e. directional information or relative motion) is achieved at a step 4232.

In some methods, detection of the speed of rotation may be achieved at a step 4234. For example, the distance between the parts that are sensed during multiple executions of steps 4220-4228, in case the sensing is performed between specific time intervals, may be obtained by locating the parts as described above, while dividing the distance with the time intervals may obtain the speed of the rotation.

In alternative methods, the aforementioned sensor can sense different features or reactions of the finger, such as sensing sub-dermal layers, alternatively to sensing the curve. The features may exhibit a pattern or differences between different parts of the curve, while in the case of reactions, when the finger-worn device is rotated around the finger, different reactions may be sensed for different rotated positions of the finger-worn device, such as different physiological reactions.

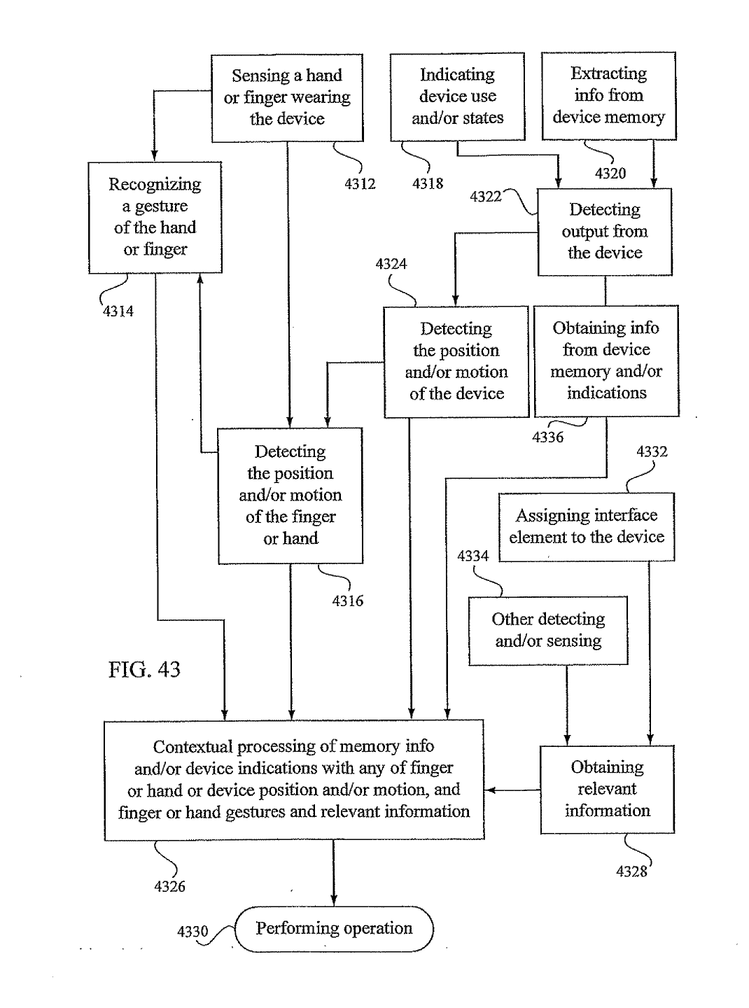

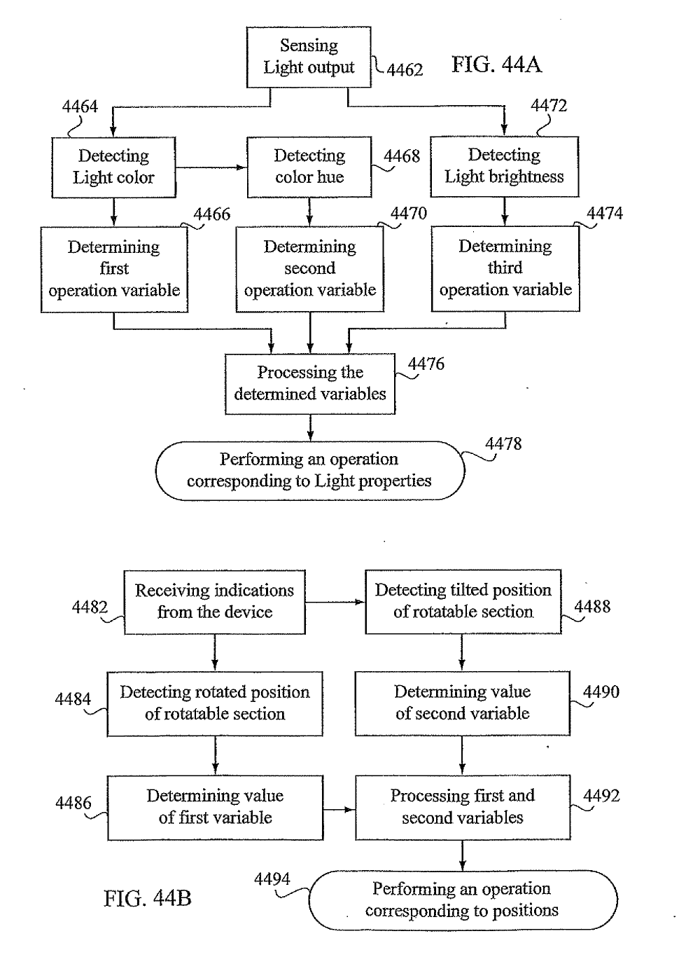

FIG. 43 shows a flowchart of a method for utilizing a finger-worn device in finger or hands interactions. At a step 4312, the hand or finger wearing the device is sensed. Sensing may be any sensing known in the art, such as visual sensing (capturing a visual image of the hand or finger) or electronic sensing (e.g. as described touch and/or proximity sensing for an apparatus 3534 in FIGS. 35D-F).

In some methods, at a step 4314, a hand or finger gesture is recognized (see e.g. U.S. Pat. Nos. 6,256,033, 5,543,591 and Ser. No. 11/232,299 and US Patent application 2006/0066588 A1). In some methods, the gesture is a static gesture, such as a “pointing” gesture or a sign a hand is making, in which case the gesture may be recognized from the sensing of the hand or finger (step 4312). In some methods, the gesture may be a motion gesture, such as making a “scribbling” gesture or a common “double-tap” action (see e.g. U.S. Pat. Nos. 7,305,630 and 5,943,043) in which case detecting the motion of the hand or finger (see step 4316) is required to recognize the gesture (at step 4314). Recognizing the gesture may include obtaining any number of different parameters of the gesture, such as direction (e.g. the pointing direction of a “pointing” gesture) or speed of a motion gesture.

In some methods, at a step 4316, a position and/or motion of the finger or hand is detected from the results of the sensing (step 4312). The position may be, for example, the coordinates of touch on a touchpad or touch-screen. Alternatively, the position may be in any detectable location, such as in a spatial environment that is sensed for interactions. “Motion” may refer to a sequence of positions. The sequence may form a path similarly to how a motion forms a path. Accordingly, any references to motion (also in other methods described herein) may similarly describe a sequence of positions. For example, referring to detection of a motion (such as for step 4316) may also describe detection of a sequence of positions which form a path. For a specific example, detecting a motion of a forger at step 4316 may be described as multiple executions of steps 4312 and 4316, in which multiple positions (in a sequence) are detected.

Detecting a position and/or motion may be facilitated by any number of mechanisms known in the art, such as visually evaluating the position of the finger in case the sensing (step 4312) is visual, or mechanically sensing the motion of the hand in case the sensing (step 4312) is by an accelerometer apparatus (exemplarily held by the hand which is also wearing the finger-worn device). For example, a user may touch a touchpad with a finger at a certain position and slide (i.e. move while touching) on the touchpad horizontally, in which case positions of the finger during the sliding are may be sensed by the touchpad, while the horizontal motion may be detected from processing multiple sensing of positions. For another example, a user may be wearing on a hand, or holding with a hand, a motion detecting apparatus (see e.g. U.S. Pat. No. 7,042,438), so while performing a motion with the hand the motion may be detected at step 4316 (in which case sensing of the hand at step 4312 is directly sensing the motion of the hand).

In other methods, detection of a general position and/or motion of a hand or finger wearing the device may be facilitated by detection of the position and/or motion of the device (see step 4324).

At a step 4322, output from the device is detected. The output may include indications of use and/or states of the device which may be indicated at a step 4318. Alternatively or additionally, the output may include information which may be extracted from a memory (also “memory unit”) of the device at a step 4320. The information and/or indications are obtained at a step 4336 from the detection of the output (step 4322).

In some methods, at a step 4324, a position and/or motion of the device is detected at a step 4324 from detection of output from the device (step 4322). For example, signals (or “transmissions”) from the device are detected for obtaining indications and/or information, and for evaluating (also “measuring”) the distance of the device from a detection mechanism (e.g. a receiver). For another example, visual output from a visual output mechanism of the device may be captured (step 4322) by a camera as an image, while the image may be processed for detecting the position of the device (step 4324), such as the distance of the device from the camera, while the output may also include information and/or indications which can be obtained (step 4336) by processing the image (e.g. recognizing a color outputted from the device as indication of a rotated position of a rotatable section, as described herein). In some methods, as described for step 4316, detecting the position and/or motion of the device (step 4324) may be for detecting the general position and/or motion of the finger or hand wearing the device (see e.g. U.S. Pat. No. 6,757,068). Because the position and motion of the device is generally the same as the position and motion of the finger and the hand (specifically for certain interactions which do not require high precision or high accuracy of position or motion detection), detection of the position and/or motion of the device may facilitate step 4316 (detecting the general position and/or motion of the finger or hand).

In some methods, the device may be operated simultaneously to moving the finger or hand wearing the device, and/or simultaneously to performing a gesture with the finger or hand. Similarly to the described for a system 3910 in FIGS. 39A-C, the finger wearing the device may move along a display in a certain motion, while a thumb may touch or slide on a touch surface of the device. Alternatively, the device may be operated before or after performing the motion and/or gesture. For example, the device may be set to a state before a finger interaction, after which a user may perform finger gestures (while the device is in that state).

At a step 4326, information from the memory of the device and/or indications of use and/or states of the device (which are obtained at step 4336) are processed correspondingly (also “contextually”) to a detected position and/or motion, or plurality thereof, of the hand or finger or device, and/or correspondingly to a recognized hand or finger gesture, or plurality thereof. Additionally or alternatively, the hand or finger or device position and/or motion, and/or the hand or finger recognized gesture, may be processed at step 4326 contextually to information and/or indications obtained (step 4336) from detected device output (step 4322). Accordingly, information and/or indications from the device may be processed contextually to any combination of results from steps 4314, 4316 and 4324, and also results from a step 4328 as will be described. In some methods, contextually may refer to having common variables or corresponding variables in a processing operation (step 4326). For example, the processing at step 4326 may include two variables which are computed together and which one is determined by indications from the device and the other is determined by a recognized gesture of the hand wearing the device. In some methods, contextually may refer to the results of step 4336 setting a context for the processing of the results of any of steps 4314, 4316 and 4324, or vice versa (the results of any of steps 4314, 4316 and 4324 setting a context for the results of step 4336. For example, obtained indications of a state of the device (step 4336) may set a mode (as an exemplary context) for an interface, while any further detections of positions of a finger wearing the device may be processed correspondingly to that mode. In a similar example, a gesture recognized at step 4314 may be registered as input which may be stored until output from the device is detected at step 4322, while upon detection of the output it is also registered as input (such as by obtaining indications from the detected output), and both inputs are processed in the same procedure at step 4326.

At a step 4330, an operation is performed as a result of the processing at step 4326. Accordingly, the operation corresponds to output from the finger-worn device and to any of a hand or finger position and/or motion and/or gesture (and/or a device position and/or motion. In one example, output from the device may be detected (step 4322) once, such as a signal indicating a state of the device is sent and detected, while no output is sent from the device until the state of the device is changed. The state indication may be obtained at step 4336 and processed at a first execution of step 4326 for registering a context for processing gestures. The context may be a commands scheme for interpreting gestures as specific commands, as opposed to other commands schemes (for other states of the device) in which the same gestures may be interpreted as different commands. While the device is in the state detected at step 4322, a user may be performing gestures which are recognized at step 4314. The recognized gestures may be processed at additional executions of step 4326 (each gesture in each execution) correspondingly to the command scheme set by the state of the device. The results of the processing are commands (exemplary operations performed at step 4330) which are determined by both the indication from the device and the gestures. For a specific example, performing a “pointing” gesture while a rotatable section of the device is rotated in a certain direction is for increasing the size of a displayed object (as an exemplary operation performed at step 4330). Performing the same gesture while the section is rotated in an opposite direction is for decreasing the size of a displayed object (as a different operation performed at step 4330). Accordingly, the recognized “pointing” gesture may be processed differently at step 4326, the difference being contexts set by device states (as different results of step 4336).

In some methods, information relevant to the operation (step 4330) or to the contextual processing (step 4326) may be obtained at a step 4328. The information may be of anything relevant to interaction. For example, a user may be operating the finger-worn device while performing gestures, for interacting with a certain interface, while the mode of the interface, such as which application is in “focus” during interaction, is relevant for the interaction, thus information of the mode may be obtained at step 4328.

In some methods, relevant information may be obtained (step 4328) from an assigning of interface elements to the finger-worn device (see the method described with reference to FIG. 45), at a step 4332. Relevant information being information of an interface element generally assigned to the device may be processed contextually at step 4326, similarly to the described above for contextual processing. For example, an interface element may be assigned at step 4332 to a certain state of the device (see a step 4528 in method 4510), in which case obtaining indication of that state (step 4336) from detected device output (step 4322) may prompt a contextual processing (step 4326) in the element assigned to the state may set a context for any further processing of hand or finger positions and/or motions and/or gestures.

In some methods, relevant information may be obtained (step 4328) from any detecting and/or sensing other than described for steps 4312, 4316, 4322 and 4324. The additional detecting and/or sensing are performed at a step 4334. For example, the finger wearing the device may be pointing to a real item (e.g. a real item 3866, FIG. 38D). The item may be captured (i.e. sensed visually at step 4334) for obtaining relevant information (step 4328) about what the finger is pointing at. For another example, a user may be interacting with a system which has a visual recognition mechanism and a receiver. By performing a gesture and operating the finger-worn device, the user may command the system to execute an operation (step 4330) which corresponds to the gesture, as sensed at step 4312 and recognized at step 4314, and also to indications from the device. The operation may also correspond to obtained relevant information (step 4328), such as information of a profile the user is logged into in the system. Alternatively or additionally, the command may correspond to information from other sensing (step 4334) and recognition, such as biometric sensing and recognition in case the identity of the user may be recognized by sensing the facial features (visual biometric identification) of the user. For yet another example, a user may be operating the finger-worn device and simultaneously operating a remote control. The user may set the finger-worn device to a certain state, after which the user performs gestures with a hand on which the finger-worn device is worn, and operates the remote control with another hand, wherein the state of the device (indicated at step 4318 and detected as device output at step 4322) and the gestures and output from the remote control (detected at step 4334) are all relevant for specific interactions. For yet another example, the user may be operating a plurality of finger-worn devices, the output of which (of each device) may be relevant for interaction.

Following the above, the same output from a finger-worn device is shown in the method of FIG. 43 to facilitate detecting the position and/or motion of the device and/or the general position and/or motion of the finger or hand wearing the device, and detecting information and/or indications of use and/or states of the device. For example, when a camera of a system is capturing images (as a sensing operation), the images may be utilized to obtain information and states indications from the device and the position of the finger wearing the device at the time each image is captured. For another example, a user wearing the device on a finger may set the device to output a certain message, while performing a “hello” gesture (e.g. waving a palm back and forth) with the hand of the finger. The certain message may include an identification (ID) code which is extracted from a memory unit of the device (step 4320). In addition to detecting the ID code, the same output from the device (e.g. radio-frequency signals) may facilitate detecting the motion of the device (step 4324) and consequently the general motion of the hand (step 4316), so that the back and forth “hello” gesture may be recognized (step 4314). Upon recognition, the gesture may be processed contextually to the detection of the ID code. Accordingly, the corresponding operation at step 4330 may be a logging-in operation, from interpreting the “hello” gesture as a log-in command, specifically to the personal user-profile of the user, which is accessed by identifying the user from the output of the device. In a similar example, security authorization information in a network, as an exemplary relevant information (step 4328), may additionally be processed (step 4326) for executing the log-in, in case the user may or may not be authorized to log into the profile. For yet another example, similarly to the described for system 3530 in FIGS. 35E and 35F, a device of the invention may be utilized with position detecting apparatuses (e.g. touch and/or proximity detected apparatuses), wherein the apparatuses may detect the position of the finger wearing the device, such as touch coordinates of the finger on a touch surface, by detecting output from the device (specifically shown a field 3520 as output of device 3510a in FIG. 35E and transmissions 3544 as output of device 3510c in FIG. 35F). A processing unit 3542 of an apparatus 3534 may be set to detect the influence of field 3520 (generated by device 3510a) on receiver 3540, specifically the influence of the region of the field that is at the tip of the finger wearing the device, in which case a transmitter 3538 of apparatus 3534 may not be needed. The processing unit may further adapted process detected influences for obtaining information and/or use and states indications from the devices (devices 3510a and 3510c), in addition to detection of the position of the touching finger. In such cases, the devices may be utilized both as input devices in system 3530 and as elements facilitating detection of the position of fingers wearing the devices. For yet another example, it may be desired to detect the general position of a hand wearing the device from a distance, wherein accuracy of the detection is not an important factor. In such cases, detecting an electric field generated by the device, or detecting modulations (also “influences”) of the device on a generated field, may facilitate detecting the general position of the hand, while the detected field or modulations may additionally include information from the device.

For yet another example, as described for visual output from the device, the device may output visuals which include information of states of the device (e.g. light reflections by an interferomeric reflection mechanism 816 as described for device 810 in FIGS. 8A-D), while by the same detection of output (step 4322), states information may be obtained (step 4336) and additionally the position and/or motion of the device (step 4324) may be detected. Note that detection of positions and/or motions from visual (or optical, or light) output is well known in the art (see e.g. U.S. Pat. No. 5,850,201), similarly to other methods and mechanisms of detections of positions and/or motions, such as by electric fields. Further note that any reference to visual output and visual sensing and detecting, and visuals in general, also refers to any interactions involving non-visible light or non-visible wavelengths, such as infrared (IR) communications.

FIG. 44A shows a flowchart of a method for color detection interactions with a finger-worn device. At a step 4462, output of light from the device is sensed. Specifically, the device is operated to output light with specific properties (e.g. properties 3824a,b as described for system 3810 in FIGS. 38A and 38B). At a step 4464, the color of the light is detected. For example, a recognition function may be accessed to recognize colors in light sensed by an optical sensing mechanism. At a step 4466, a first operation variable is determined from detection of the color (step 4464). For example, detection of a certain color may set a certain value for the variable, while detection of a different color may set a different value for the variable. The setting of values may correspond to interface elements assigned to device outputs (see step 4522 in FIG. 45 and steps 4332 and 4328 in FIG. 43). Similarly, at a step 4468, the hue of the color of the light is detected, determining a second operation variable at a step 4470. Accordingly, hues, being exemplary light properties, may be detected for setting different values for the second variable. Further similarly, at a step 4472, brightness of the light sensed at step 4462 is detected, determining a third operation variable at a step 4474. As with hues, different levels of brightness of light, as exemplary light properties, may be detected for setting different values to a variable. In some methods, any or all of steps 4464, 4468 and 4472 may be executed as a single step, such as in case multiple properties (color, hue and/or brightness) may be detected in a single operation (e.g. a recognition function). In some methods, detection of different types of light properties may influence any number of variables. For example, a value of a variable may be determined by detection of a color, while detecting the brightness of the light of that color may change the value of the same variable.

In some methods, other light properties, such as polarization, may be detected for determining or influencing variables, so that by modulating these properties in output of the device, communication is facilitated. Optionally, the properties may be dependent on other factors, such as a time factor in case a modulated property is a blinking rate, or in case a color outputted from the device changes in hue at a certain speed.

At a step 4476, determined operation variables (results from any or all of steps 4466, 4470 and 4474) are processed for a corresponding operation performed at a step 4478. The processing (step 4476) may be of a procedure or function or program which is executed according to the variables from any or all of the first, second and third variables. Accordingly, the resulting operation (step 4478) correspond to output of light from the device, so that modulating the output may be for controlling the resulting operation and/or for executing different operations.

In some methods, different types of light properties may determine or influence different aspects of the resulting operation, such as in case each variable (determined or influenced by detection of a property) is assigned to an aspect of the operation. For example, a detected color determines which function is to be performed as the resulting operation, such as in case detection of a green color is for a first function and detection of a red color is for a second function. Additionally, a detected brightness may determine the extent by which a function is to be performed. Specifically, the first function may be a “drawing” function while the second function may be a function for controlling audio volume. Accordingly, the brighter the detected output, the thicker a stoke that is drawn by the drawing function, while for the second function the brighter the output, the higher the volume is set. Further accordingly, the device may be used (a rotatable section may be rotated) to increase or decrease the brightness of the output to increase or decrease the thickness of a stroke or the audio volume.

FIG. 44B shows a flowchart of a method for utilizing a rotatable and tillable device. At a step 4482, indications from the device are received. The indications may be sensed, for example, by a separate party. At a step 4484, the tilted position of a rotatable section of the device is detected. For example, the section may be set to a tilt angle corresponding to a track of rotation (see tracks 218a-e in FIGS. 17C and 17D). For another example, the section may be tilted on an indication location which indicates the contact with the section (see indication location 154a in FIG. 15B). At a step 4486, a value for a first variable is determined by the detection of the tilted position (result of step 4484). At a step 4488, the rotated position of the rotatable section is detected, while the detection determines a value for a second variable at a step 4490. For example, in accordance with the described for resonance mechanism 1416 in FIGS. 14A and 14B, rotated and tilted positions of the device may be indicated (separately by mechanism 1416) to a separate party 320. In other methods, a value of the same variable is influenced by the detections of rotated and tilted positions. At a step 4492, the first and second variables (or the same variable influenced by both rotated and tilted positions) are processed for an operation to be performed at a step 4494, which corresponds to the tilted and rotated position of the rotatable section of the device.

Following the above, any combination of positions of rotatable sections of devices of the invention, and/or any other states or uses of the devices, may be utilized for different operations. For example, directional information of sliding a finger of a touch surface 164 of a device 2910 (see FIGS. 29A and 29B) may set a value of a first variable of an operation, while an indication location to which the surface is set (from locations 154a-e) may set a value of a second variable of an operation, for performing a specific operation (or different operations for different combinations of directional information and indications from locations 154a-c). For another example, in a method similar to the method in FIG. 44B, an operation which corresponds to a specific alignment of two rotatable section (see e.g. sections 112 and 912 of device 1010 in FIGS. 10A-10C) may be performed by detecting the rotated position of each section.

FIG. 45 shows a flowchart of a method for assigning interface elements to a finger-worn device, such as generally described in FIGS. 41A through 41K. Assigning an element may refer to any sharing of an element, a plurality thereof, or any part of, with the finger-worn device. Assigning may involve any number of finger-worn devices (see e.g. FIG. 41K). At a step 4512, a hand or finger interaction is detected. The hand or finger is preferably wearing the device. The interaction may be any action of the finger or hand as part of an interaction (see e.g. US Patent application 2007/0097151 A1 and 2005/0277470 A1), such as a positioning and/or a motion, and/or a gesture, while the position and/or motion of the finger may be detected at step 4512, and/or the gesture recognized also at step 4512 (described as “detected” for this method). The interaction may be performed on or with a separate party which includes the interface (having the element which is to be assigned), or which is part of a system which includes the interface. Alternatively, the interaction may generally be performed, during which or after which it is sensed by a separate party, or by any number of sensing mechanism. In one example, a user may be interacting with a computer (as an exemplary system having an interface) by operating a keyboard or a remote controller (as an exemplary separate party). The computer may be “running” the interface (e.g. an operating system (OS)) of which elements may be assigned to the device. Accordingly, the finger or hand interaction may be a command typed with the keyboard, or a motion performed with the controller, such as a motion detection controller detecting the motion (as an exemplary interaction). In another example, a user may be interacting with a touch-screen (separate party) by touching it with a finger (finger interaction) which is preferably wearing the finger-worn device. The touch-screen may be connected to a network (system) on which there is an interface with “assignable” elements. Alternatively, the touch-screen may be a mobile device having its own interface. In yet another example, a user may be interacting with a gestures-recognition system (e.g. an electronic apparatus including a display, a camera and a processing unit with a visual recognition function, such as described for a system 3630 in FIG. 36D) by performing a gesture (as an exemplary interaction) with a finger on which the finger-worn device is worn (as an exemplary hand or finger interaction), while the gesture may be detection of the gesture may be facilitated by utilization of the finger-worn device (e.g. utilizing a device 3610a in system 3630 to illuminate the finger). At a step 4514, output from the finger-worn device is detected. For example, a user may rotate a rotatable section of the device, to set the section to a specific rotated position as a state of the device which is indicated (exemplary output) to a separate party (where the output is detected). For another example, a user may press on a button or on a touch surface of the device to prompt an emission of output. For yet another example, information from a memory unit of the device may be processed into signals which are transmitted as device output, such as a code stored on the unit being sent to the interface as an assigning command. At a step 4516, an interface occurrence is influencing an assigning operation. The influence, being a result of the step, may be variables set by the occurrence and utilized for an assigning operation. The occurrence may be prompted by processes or operations of the interface. For example, an interface element may become activated, accessible or may receive the “focus” of the interface, by which the element may automatically be assigned. The occurrence may be from an external influence or source. For example, an incoming video-conference call may be received in the interface, while an “answer” command may be assigned to the device, such as to allow a user to answer the call by operating the device.

Any of steps 4512, 4514 and 4516, or any combination thereof, may be for prompting an assigning of an interface element, or plurality thereof, to the device. For example, just operating the finger-worn device may achieve an assigning of a certain element, such as assigning any element in “focus” (when the device is operated) in the interface to the device. For another example, simultaneously using the device and performing an interaction with a finger wearing the device may achieve the same, or may achieve assigning of a different element than in the previous example. For yet another example, an occurrence in the interface, such as an application being “opened”, and an interaction of a finger, such as “double tapping” on the application icon, may be for assigning the application to the device, such as displaying information of the application on the device (see step 4534).

In some methods, at a step 4518, relevant information is obtained, such as described for previous methods. For example, other input may be received (in the separate party or the system) which may influence the assigning of an element. For a specific example, relevant information may be which displayed object a finger is touching, in case the interaction of the finger (step 4512) is touch on a touch-screen, or which real item (e.g. a real item 3866 in FIG. 38D) the finger is pointing to, in case the interaction of the finger (step 4512) is pointing to a real item, while both the item and the finger may be captured visually and are relevant for the assigning of an interface element. For another specific example, a user-profile which the interface is logged into during the assigning may determine which element is to be assigned when a certain finger interaction is detected (step 4512).

At a step 4520, results from any or all of steps 4512, 4514, 4516 and 4518 are processed. In one example, detected indications of use of the device (step 4514) may be processed for registering corresponding input which prompts an assigning of an element. In another example, detected indications of a state of the device (step 4514), in addition to detected touch position (step 4512) and information about which object is displayed at that position (step 4518), may be processed together (e.g. contextually, as described above) for copying, an interface element which corresponds to the object to a memory unit of the device (see step 4530). In yet another example, an error occurs in the interface (as an exemplary interface occurrence at step 4516), in which case an object representing the error (e.g. an error message) may appear on an interactive display of the device (e.g. an interactive display mechanism 2320) as an exemplary assigning (the error message may automatically be assigned to the device), where a user may operate the interactive display to respond to the message.

The result of, or results of multiple executions of step 4520, is any of the following steps, or any combination thereof, each of which describing an assigning of an interface element to the device, or part of an assigning.

In some methods, an interface element may specifically be assigned to a device output at step 4522, in which a certain output from the device influences (or modulates or controls) the element. For example, a command in the interface (as an exemplary interface element) may be assigned to “green output” from the device, so that when detecting a green color outputted from the device (such as green light from an LED), the command may be executed by the interface upon detection of the output. For another example, a code, as an exemplary interface element being assigned to the device, may be copied from a database first system (which includes the interface) to a memory unit of the device (see step 4530). The code may be a specific blinking rate which can be outputted by a visual output mechanism of the device, while the code may be extracted from the memory unit when interacting with a second system, for the output mechanism of the device to blink at that rate. The second system may recognize the code from the blinking, for executing a corresponding operation.

In some methods, an interface element may specifically be assigned to a finger or hand wearing the device, at a step 4524. The element may specifically be assigned to a hand or finger interaction. For example, an interface element may be a function, while by being assigned to a finger wearing the device the function may be performed upon detection of a position or gesture of the finger. The function may be performed at a “location” in a virtual environment (e.g. inside a files folder) which corresponds to the detected position or gesture of the finger, such as performed on another interface element (e.g. a file) which is displayed where the finger is touching or to where the finger is pointing (as an exemplary gesture). For yet another example, a user may be wearing a first finger-worn device on a first hand and a second finger-worn device on a second hand, while a different interface element may be assigned to each hand, so that motion detection of each hand may correspond to a different assigned element. For yet another example, an interface element may be assigned to both an interaction of the finger (step 4524) and to a state of the device (see step 4528), wherein for controlling the element, the finger must perform the interaction while the device is at that state.

In some methods, an interface element may be assigned specifically to an element of the finger-worn device, at a step 4526. The element of the device may be a section of the device, such as a rotatable section, or a mechanism of the device, such as an interactive display mechanism (see FIGS. 23A-C, FIG. 27C and FIGS. 41I and 41J). For example, the device may include multiple rotatable sections, while a different interface element may be assigned to each section, so that a different element may be controlled by rotation of each section. Optionally, the elements assigned to the section may correspond to each other by operating the sections correspondingly to each other, such as described for a device 1010 in FIGS. 10A-C for alignment of rotated positions and displayed objects. For another example, an interface element may be assigned to a visual output mechanism and a touch surface of the finger-worn device, in which touching the surface where an object (or plurality thereof) representing the element is displayed (see step 4534) may be for controlling the element, such as controlling an audio volume by touching a − symbol and a + symbol, as described for device 2710 in FIG. 27C.

In some methods, an interface element may be assigned specifically to a state or use of the finger-worn device, at a step 4528. The state of the device may be a physical state or a “virtual” state (i.e. mode of the device). For example, an element may be assigned to the setting of a rotatable section to a certain track, as an exemplary state of the device, while another element may be assigned to the setting of the same rotatable section, or another rotatable section, to another track (as described for multiple rotatable sections and multiple tracks of a device 920 in FIG. 9C). This example may also describe a case where interface elements are assigned to device elements (the tracks or the rotatable section). Use of the device (to which an element is assigned) may be any operation performed on the device, such as rotating a rotatable section or sliding on a touch surface. For example, browsing a tool-bar (the browsing or the tool-bar being an exemplary interface element) may be assigned to the rotation of a rotatable section. Specifically, browsing in certain direction (in the order of the tools) may be assigned to a certain rotation direction, while browsing in an opposite direction may be assigned to an opposite rotation direction. The browsing may also be assigned to a state of the device, such as a tilted position of the rotatable section, so that other tilted positions may be assigned other elements. This may also describe a case where an interface element (the tool-bar or the browsing of the tool-bar) is assigned to device element (the rotatable section) and to use of the device (rotating of the section), as a combination of steps 4526 and 4528. For another example, a “drawing” function may be assigned to a touch surface (device element) of the device, while different uses of the surface are assigned different “drawing” options. Specifically, increasing or decreasing the brightness or the color of a drawn stroke may be assigned to sliding on the touch surface, while increasing the thickness of the stroke may be assigned to the amount of pressure applied on the surface (more pressure for increasing the thickness). Alternatively, controlling the thickness may be assigned to sliding on the surface while controlling the brightness or color may be assigned to the amount of pressure on the surface.

In some methods, an interface element, or information related to an interface element, may be copied to a memory unit of the finger-worn device, as an assigning of the element to the device, at a step 4530. For example, a file may be copied to a memory unit of the finger-worn device from a database of the interface (or of a system which includes the interface). For another example, an “undo” function may be assigned to the device, while “undo stages” (a sequence of stages of an interaction session, such as stages of editing of a document) may be automatically be stored on a memory unit of the device. Alternatively, by operating the device during an interaction session, such as in case the “undo” function is also assigned to a state and/or use of the device (step 4528), a user may choose which stages of the interaction to store, for allowing to user to “track-back” specifically to those stages. For a similar example, a user may watch a video clip and “tag” certain frames in the clip (e.g. screenshots) which may be copied to the memory unit, while the interface element assigned to the device may be the video clip and/or the “tagging” function. For yet another example, a common “cut-paste” function may be facilitated by the method described with reference to FIG. 45, in which operating a virtual-reality device (e.g. a head-up display device 3860) to choose an file element, such as by controlling a virtual cursor (FIG. 38E) with a finger, as an exemplary combination of step 4512 (the positioning of the finger) and step 4518 (information about the cursor), the file element may be chosen and copied (also “cut”) to a memory unit of the device (step 4530). Optionally, the cursor may be further controlled for copying (also “pasting”) the file element back to the virtual reality device (see step 4538), as an exemplary re-assigning of the file element (see step 4536).

In some methods, at a step 4532, feedback of the assigning is prompted. The feedback may be generated by the finger-worn device or by a separate party, preferably the party (or a party in the system) which includes the interface. For example, a display of the finger-worn device may be blinking as feedback of the assigning, and/or a change of display may occur on a display with which a user wearing the device is interacting, such as in case an “assigning button” (as a displayed object corresponding to an “assigning” function) changes to a “pressed assigning button”, when an interface element which corresponds to the button is assigned to the device. Optionally, when the element is re-assigned (step 4536) to the interface from the device, the “pressed assigning button” changed to an un-pressed “Assigning button” (see step 4542).

An assigning feedback (step 4532) may be visual or any other type of output, such as tactile (as described for devices 3310 and 3330 in FIGS. 33A, 33B, 33C and 33E) or audible (e.g. a sound cue from a speaker apparatus in the device or from a speaker apparatus in the separate party which includes the interface).

In some methods, an interface element may specifically be assigned to a display of the finger-worn device, at a step 4534. For example, visuals corresponding to the assigned element may be “transferred” to a display of the finger-worn device. For a specific example, a displayed object (displayed on the separate party with which a user wearing the device is interacting with) may represent an interface element, so that when the element is assigned to the device (such as specifically assigning control of the element to a rotatable section of the device), the displayed object may appear on a display of the device (the object exemplarily being specifically assigned to the display), and may optionally “disappear” from being displayed on the separate party, in which case different parts of the elements are differently assigned to the device (the control of the element assigned to the rotatable section of the device and the displayed object assigned to the display of the device). The reverse operation may be performed when the parts of the element are re-assigned to the interface (step 4536), in which case the object may “disappear” from the display of the device and appear on the display of the separate party (while control is generally “returned” to the interface of the separate party). For another example, a cursor may be assigned to the finger-worn device in which a visual representation of the cursor appears (in accordance with step 4534). When the interface goes into a “stand-by” mode (also “sleep” mode), such as automatically after a period of time of not being interacted with, the cursor, as displayed on the device, may change shape, such as to a “half-moon” symbol representing the “sleep” mode. For a similar example of a cursor element, a finger on which the device is worn may point to a “hyperlink” on a display, while when the finger is pointing to the “hyperlink”, the shape of the cursor may change, such as from an arrow symbol to a hand symbol. This may be an example of the cursor, as an interface element, being specifically assigned to the finger wearing the device (step 4524) and to a display of the device (step 4534), in which certain interactions of the finger (such as the pointing to the “hyperlink”) correspond to change in the appearance of the cursor as displayed on the device.

A display of the finger-worn device, when referring to step 4534, may be any visual output which can be implemented in the device, such as an array of pixels (e.g. display pixels 2330), an illumination mechanism (e.g. an illumination mechanism 3616) or a projection mechanism (e.g. a projection mechanism 3420). For example, a projection mechanism of the device may project visuals corresponding to an element assigned to the device.

In some methods, the device may display visuals that represent assigned interface elements by limited, symbolic and/or partial representations of the elements or of original visuals of the elements (e.g. displayed objects corresponding to the elements as displayed on a separate party). For example, a media playing application may be assigned to the device, the original visuals of which are a full control-desk for controlling media playing, while when the application is assigned to the device, the device may display an icon of the application, or a certain part of the control-desk, such as just the playback track. For another example, a paragraph of text may be copied to a memory unit of the device, while before being copied the text may be colored green (automatically by the interface or manually by a user). Accordingly, the device may illuminate (e.g. by an illumination mechanism) a finger wearing the device with a green color after the text is copied. Optionally, other paragraphs may also be copied to the device, each being colored a different color, while operating the device may be for browsing between the paragraphs such that the colors illuminating the finger may change during browsing. A user may select a paragraph by browsing to the paragraph's corresponding color, for further interactions related to that paragraph, such as to paste it in a text document (see step 4538).

In some methods, an interface element, or part of an element (e.g. a representation of the element as a displayed object) may be operable when assigned to a display of the device (step 4534), such as by an interactive display mechanism of the device. For example, a function, as an exemplary interface element, may be assigned to positioning of a hand wearing the device (step 4524) and to an interactive display mechanism of the device (step 4526), wherein a displayed object corresponding to the assigned element (i.e. function) is displayed on a touch surface. A user may activate the function by positioning the hand as part of interaction, and by touching the touch surface of the device specifically where the corresponding object is displayed.

Following the above, an interface element may be re-assigned from the device at a step 4536. Consequently, information of the element (or the element itself) may be copied from a memory unit of the device, at a step 4538, and/or a re-assigning feedback may be prompted at a step 4540 (similarly to the described for step 4532), and/or a change of a display of the device and/or of the interface may be prompted at a step 4542 (similarly to the described for step 4534). For example, when a memory unit of the device is empty, “double-tapping” (step 4512) on a file icon (as an exemplary displayed object representing a file) may prompt a process (step 4520) in which the file is copied to the memory unit (step 4530), while when a file is stored on the memory unit, “double tapping” (another step 4512) on a files folder may prompt a process (step 4520) in which the file is copied from the memory unit (step 4538) to that folder. For another example, a displayed object assigned to a display of the device (as a result of step 4534) may be re-assigned to its original interface when a certain interface occurrence happens (step 4516), such as the element which corresponds to the displayed object becomes inaccessible, thus the display of the device may change (the object may “disappear” from that display) and the interface display may change (the object may appear on the separate party displaying visuals of the interface), as an exemplary step 4542.

All patents and patent applications mentioned in this specification are herein incorporated in their entirety by reference into the specification, to the same extent as if each individual patent or patent application was specifically and individually indicated to be incorporated herein by reference. In addition, citation or identification of any reference in this application shall not be construed as an admission that such reference is available as prior art to the present invention.

While the invention has been described with respect to a limited number of embodiments, it will be appreciated that many variations, modifications and other applications of the invention may be made.

1. A finger-worn user input device which includes a first stationary section (114) adapted to fit on a human hand finger and comprising:
a) a first rotatable section (112) at least partially overlapping the first section and adapted to rotate and tilt relative to the first section; and
b) an indication mechanism (116, 116a, 130, 516, 526, 616, 816, 826, 836, 1316, 1416, 1616, 2116, 2222, 2320, 2720, 3524) for relaying an indication corresponding to a relative position obtained between the first stationary section (114) and the first rotatable section (112).

2. The device of claim 1, wherein the relative position is obtained through an action selected from the group consisting of a relative tilt, a relative rotation and a relative tilt and rotation.

3. The device of claim 1, wherein the indication mechanism is a passive indication mechanism.

4. The device of claim 1, wherein the indication mechanism is an active indication mechanism.

5. The device of claim 1, wherein the indication mechanism includes a sensing mechanism (118, 118a, 118b, 118c, 128, 128′, 134, 136, 1216).

6. The device of claim 1, wherein the first stationary section (114) includes a plurality of tracks (218a, 218b) on which the first rotatable section (112) can rotate.

7. The device of claim 1, wherein the first stationary section (114) is replaced by a second rotatable section (912), wherein the first rotatable section (112) is adapted to rotate and tilt on the second rotatable section (912).

8. The device of claim 7, wherein the second rotatable section (912) includes a plurality of tracks (218a, 218b) on which first rotatable section (112) can rotate.

9. The device of claim 6, wherein the plurality of tracks (218; 218b) further allow first rotatable section (112) to tilt.

10. The device of claim 6, further comprising a third rotatable section (112′) at least partially overlapping first stationary section (114) and adapted to rotate and tilt relative to first stationary section (114).

11. The device of claim 1, further comprising a locking mechanism (1440) for locking the first rotatable section (112) into a given position.

12. The device of claim 11, wherein the given position is selected from the group consisting of a rotated position, a tilted position and a rotated and tilted position.

13. The device of claim 1, wherein the first stationary section (114) includes indication locations (154) for indicating corresponding tilted positions of the first rotatable section (112).

14. The device of claim 6, wherein the first stationary section (114) includes indication locations (154) for indicating corresponding tilted positions of the first rotatable section (112).

15. The device of claim 6, wherein each track (218a, 218b) controls a separate interface element (1030a, 1030b, 1030c) of an interface (1020).

16. The device of claim 8, wherein each track (218a, 218b) controls a separate interface element (1030a, 1030b, 1030c) of an interface (1020).

17. The device of claim 15, wherein interface (1020) is an interface selected from the group of an interface internal to the device and an interface external to the device.

18. The device of claim 15, wherein interface (1020) is an interface selected from the group of an interface internal to the device and an interface external to the device.
